(19) United States
(12) Patent Application Publication
(10) Pub. No.: US 2016/0243646 A1
(43) Pub. Date: Aug. 25, 2016

(54) LASER SYSTEMS AND METHODS FOR LARGE AREA MODIFICATION

(71) Applicant: ELECTRO SCIENTIFIC INDUSTRIES, INC., Portland, OR (US)

(72) Inventors: Jan Kleinert, Wilsonville, OR (US); Fumiyo Yoshino, Portland, OR (US); Corie Neufeld, Portland, OR (US); Jeremy Willey, Tualatin, OR (US); Mehmet Alpay, Portland, OR (US)

(21) Appl. No.: 15/047,279

(22) Filed: Feb. 18, 2016

Related U.S. Application Data
(60) Provisional application No. 62/119,617, filed on Feb. 23, 2015.

(51) Int. Cl. B23K 26/067; B23K 26/364; B23K 26/08; H01S 3/00; B23K 26/00

(52) U.S. Cl. CPC B23K 26/067; H01S 3/005; B23K 26/0069; B23K 26/08; B23K 26/364

(57) ABSTRACT

A laser system (112, 1300) modifies a large area on an article (100) by employing a beamlet generator (1404) to provide a plurality of beamlets (1408) to a beamlet selection device (2350) whose operation is synchronized with movement of a beam steering system (1370) to variably select a number and spatial arrangement of beamlets (1408) to propagate a variable pattern of spot areas (302) to the article (100).

### CROSS REFERENCE TO RELATED APPLICATION

This application is a Non-Provisional application of U.S. Provisional Patent Application No. 62/119,617, which was filed on Feb. 23, 2015, the contents of which are herein incorporated by reference in their entirety for all purposes.

### COPYRIGHT NOTICE

©2016 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This application relates to laser systems and methods for modifying a large area on an article and, in particular, to laser systems and methods that propagate a plurality of beamlets through a beamlet selection device whose operation is synchronized with movement of a beam steering system to variably select the number and spatial arrangement of the beamlets in the interest of processing the article with a variable pattern of spot areas.

### BACKGROUND

Consumer products, such as electronic devices (e.g., mobile phones, portable media players, personal digital assistants, computers, monitors, etc.), have been marked with information for commercial, regulatory, cosmetic, or functional purposes. For example, it is common for electronic devices to be marked with serial numbers, model numbers, copyright information, alphanumerical characters, logos, operating instructions, decorative lines, patterns, and the like. Desirable attributes for a mark include the shape, color, optical density, and any other attribute that may affect the appearance of the mark.

Numerous processes can be used to produce a mark on a product or article depending on, for example, the nature of the article itself, the desired appearance of the mark, the desired durability of the mark, and the like. Marking processes have been developed that use lasers to produce visible marks on metallic articles, polymeric articles, and the like. A conventional marking process is understood to involve directing a beam of laser pulses to impinge upon the article at spot areas, and raster-scanning the beam within an area to be marked. Thus marks formed by conventional marking processes are generally composed of a series of successively-formed, and overlapping, scan lines that are each formed of a series of successively-formed, and overlapping, spot areas. Conventionally, the throughput of such marking processes has been increased simply by increasing the pulse repetition rate (e.g., such that a period between pulses is in a range from 500 ns to 1 μs) and scan speed (e.g., to maintain a desired bite size) while maintaining a constant pulse energy. However, this throughput enhancing process only works up to a point, after which the rapid accumulation of successively-directed laser pulses on the article during the marking process actually creates undesirable defects (e.g., cracks, material warping, modified crystalline structures, pits, etc.) that can physically or chemically damage the article or undesirably change one or more optical characteristics (or visual appearance) of the article. Such rapid accumulation of successively-directed laser pulses onto the article can also degrade the appearance of the mark that is ultimately formed.

One reason to increase throughput is to be able to use lasers to mark large areas because laser marking offers capabilities not available to chemical or mechanical processes. Other methods of increasing throughput to facilitate large area marking have employed use of multiple laser heads in parallel. Electro Scientific Industries, Inc. of Portland, Oreg. has a number of multiple laser-head systems. Unfortunately, each laser head and associated control components add significant cost to the overall laser system.

Thus, it would be desirable to increase the throughput of laser modification processes without significantly increasing the laser system costs to achieve such throughput increases.

### SUMMARY

This summary is provided to introduce a selection of concepts in a simplified form that are further described in the detailed description. This summary is not intended to identify key or essential inventive concepts of the claimed subject matter, nor is it intended for determining the scope of the claimed subject matter.

In some embodiments, a method for laser modification of a large area of an article, comprises: directing a laser beam for propagation along an optical path; propagating the laser beam through a beamlet generator to create a beamlet group of multiple distinct beamlets including three or more beamlets; employing a beamlet selection device to distribute the beamlet group into first and second beamlet sets, wherein the first beamlet set includes a variable first number of beamlets, and wherein the beamlet selection device permits the first beamlet set to propagate along the optical path and prevents the second beamlet set from propagating along the optical path; and coordinating operation of the beamlet selection device with operation of a beam positioning system, wherein the beam positioning system controls relative motion and relative position of a beam axis of the laser beam with respect to the article, and wherein the beamlet selection device changes the variable first number of beamlets in the first beamlet set in coordination with changes made to the relative motion or the relative position of the beam axis with respect to the article to impinge the article with variable spot sets that have numbers of spot areas on the article that correspond to the first number of beamlets.

In some alternative, additional, or cumulative embodiments, a method for laser marking of a large area of an article, comprises: directing a laser beam for propagation along an optical path; propagating the laser beam through a diffractive optical element to create a beamlet group of multiple distinct beamlets including three or more beamlets; employing a mobile aperture to distribute the beamlet group into first and second beamlet sets, wherein the first beamlet set includes a number of beamlets, and wherein the beamlet selection device permits the first beamlet set to propagate along the optical path and prevents the second beamlet set from propagating along the optical path; and coordinating operation of the aperture with operation of a galvanometer mirror positioned along the optical path, wherein the galvanometer mirror affects relative motion and relative position of a beam axis of the laser beam with respect to the article, and wherein movement of the mobile aperture changes the number of beamlets in the first beamlet set in coordination with changes made to the relative motion or the relative position of the beam axis with respect to the article.

In some alternative, additional, or cumulative embodiments, a method for facilitating laser modification of a large area of an article, the large area having a desired modification edge with a predetermined modification edge profile, wherein the desired modification edge has a desired localized edge portion with a localized edge profile, comprises: propagating a laser beam including a beamlet formation of multiple distinct laser beamlets including three or more laser beamlets simultaneously along an optical path having a beam axis that intersects the article, wherein the beamlet formation corresponds to a spot set of spot areas on the article and provides a one-to-one correspondence of the laser beamlets to the spot areas whenever the respective laser beamlets are permitted to propagate to the article, wherein the spot set has a spot set edge profile that is different from the localized edge profile for the desired modification edge; employing a beam positioning system to direct a laser pass of the beam axis in a pass direction relative to desired locations on the article, wherein the pass direction is transverse to the desired localized edge portion of the desired modification edge; employing a beamlet selection device during a first time period during the laser pass to block a first number of laser beamlets to prevent propagation of the first number of laser beamlets along the optical path downstream of the beamlet selection device during the first time period and to permit propagation of unblocked laser beamlets along the optical path downstream of the beamlet selection device during the first time period; employing the beamlet selection device during a second time period during the laser pass to block a second number of laser beamlets to prevent propagation of the second number of laser beamlets along the optical path downstream of the beamlet selection device during the second time period and to permit propagation of unblocked laser beamlets along the optical path downstream of the beamlet selection device during the second time period, wherein the second number is different from the first number; employing the beamlet selection device during a third time period during the laser pass to block a third number of laser beamlets to prevent propagation of the third number of laser beamlets along the optical path downstream of the beamlet selection device during the third time period and to permit propagation of unblocked laser beamlets along the optical path downstream of the beamlet selection device during the third time period, wherein the third number is different from the second number, wherein the first, second, and third numbers affect a propagation edge profile for the laser beam, wherein the propagation edge profile of the laser beam influences a modification edge made by the laser beam; and coordinating operation of the beamlet selection device with operation of the beam positioning system so that the propagation edge profile of the laser beam differs from the spot set edge profile of the laser beam, so that the propagation edge profile of the laser beam resembles the localized edge profile of the desired localized edge portion of the desired modification edge, so the propagation edge profile of the laser beam is synchronized with the location of the desired localized edge portion of the desired modification edge of the large area.

In some alternative, additional, or cumulative embodiments, a laser system for making a large area laser modification of an article, comprises: a laser operable for generating a laser beam for propagation along an optical path; a beamlet generator operable for creating a beamlet group of multiple distinct beamlets including three or more beamlets; a beamlet selection device operable for dividing the beamlet group into first and second beamlet sets, wherein the first beamlet set includes a number of beamlets, and wherein the beamlet selection device is operable to permit the first beamlet set to propagate along the optical path and operable to prevent the second beamlet set from propagating along the optical path; a beam positioning system operable for causing relative motion of a beam axis of the laser beam with respect to the article to change of position of the beam axis with respect to the article; and a controller operable for controlling the relative motion and the relative position of the beam axis with respect to the article and operable for causing the beamlet selection device to change the number of beamlets in the first set in coordination with changes made to the relative motion or the relative position of the beam axis with respect to the article.

In some alternative, additional, or cumulative embodiments, the laser mark, comprises: a major area having major length and major height dimensions and having laser brush strokes of a laser spot set that contains a plurality of laser spots to provide a spot-set length dimension, a spot-set height dimension, a spot-set area, and a spot-set edge having a slope at an angle between 0 and 180 degrees with respect to the spot-set length dimension or the spot-set height dimension; and a plurality of contiguous mirror areas adjacent to the major area that define a mark edge of the mark, wherein the mark edge has a curvilinear profile, wherein the laser brush strokes are continuous from the minor areas to the major area, and wherein some of the brush strokes in the minor areas contain brush stroke segments having fewer laser spots than in the laser spot set to provide the marked edge with a curvilinear edge profile at a brush stroke edge resolution that is higher than the spot-set length dimension or the spot-set height dimension.

In some alternative, additional, or cumulative embodiments, the laser beam is propagated through a beam-shaping device to provide the multiple distinct beamlets, the beam positioning systems employs a fast-steering positioner, and the beamlet selection device is positioned at an optical position along the optical path between the beam-shaping device and the fast-steering positioner.

In some alternative, additional, or cumulative embodiments, the beamlet generator that creates the group of the multiple distinct beamlets is spatially contiguous.

In some alternative, additional, or cumulative embodiments, the beamlet generator creates the group of the multiple distinct beamlets simultaneously.

In some alternative, additional, or cumulative embodiments, the laser beam and the beamlets exhibit the same wavelength.

In some alternative, additional, or cumulative embodiments, the beam-shaping device comprises a diffractive optical element, and the fast-steering positioner comprises a galvanometer mirror.

In some alternative, additional, or cumulative embodiments, the laser beam is propagated through a beam expander positioned along the optical path upstream of the beamlet selection device.

In some alternative, additional, or cumulative embodiments, the beamlet selection device is positioned between a pair of relay lenses along the optical path.

In some alternative, additional, or cumulative embodiments, the beamlet selection device comprises a fundamentally mechanical device.

In some alternative, additional, or cumulative embodiments, the beamlet selection device comprises a mobile aperture.

In some alternative, additional, or cumulative embodiments, the beamlet selection device comprises a MEMS.

In some alternative, additional, or cumulative embodiments, the beamlet selection device comprises a shutter array.

In some alternative, additional, or cumulative embodiments, movement of the beamlet selection device is transverse to the optical path.

In some alternative, additional, or cumulative embodiments, movement of the beamlet selection device is within a plane that is perpendicular to the optical path.

In some alternative, additional, or cumulative embodiments, the beamlet selection device has dimensions sufficient to permit propagation of two or more beamlets.

In some alternative, additional, or cumulative embodiments, the beamlet selection device has unequal height and length dimensions that permit propagation of beamlets.

In some alternative, additional, or cumulative embodiments, movement of the beamlet selection device is transverse to the optical path along a direction parallel to a longer one of the height and length dimension that permits propagation of beamlets.

In some alternative, additional, or cumulative embodiments, the beamlet selection device weighs less than or equal to 100 g.

In some alternative, additional, or cumulative embodiments, the beamlet selection device has a response speed of greater than or equal to 10 mm/s.

In some alternative, additional, or cumulative embodiments, the beamlet selection device has a bandwidth between about 10 kHz and about 100 kHz.

In some alternative, additional, or cumulative embodiments, the beamlet selection device is moveable by a voice coil.

In some alternative, additional, or cumulative embodiments, the beamlet selection device comprises a metallic material.

In some alternative, additional, or cumulative embodiments, the beamlet selection device comprises a non-rectangular shape.

In some alternative, additional, or cumulative embodiments, the spot set has a spot set perimeter that has a non-rectangular shape.

In some alternative, additional, or cumulative embodiments, the spot set has a spot set perimeter that has parallelogram shape.

In some alternative, additional, or cumulative embodiments, the beamlet group includes four or more beamlets.

In some alternative, additional, or cumulative embodiments, the beamlet group includes sixteen or more beamlets.

In some alternative, additional, or cumulative embodiments, the beamlets of the beamlet group produce respective spot areas on the article when the beamlets are permitted to propagate to the article, and the entire spot set of spot areas has a group length or group height dimension greater than or equal to 10 microns.

In some alternative, additional, or cumulative embodiments, the beamlets of the beamlet group produce respective spot areas on the article when the beamlets are permitted to propagate to the article, and a spot separation distance between two neighboring spot areas is in a range of 3 microns to 3 millimeters.

In some alternative, additional, or cumulative embodiments, the beamlets of the beamlet group produce respective spot areas on the article when the beamlets are permitted to propagate to the article, the spot areas have a major spatial axis, and a spot separation distance between two neighboring spot areas is greater than the major spatial axis and less than six times larger than the major spatial axis.

In some alternative, additional, or cumulative embodiments, the beamlets of the beamlet group produce respective spot areas on the article when the beamlets are permitted to propagate to the article, and the beamlets impinge the article within 30 microseconds of each other.

In some alternative, additional, or cumulative embodiments, the beamlets of the beamlet group produce respective spot areas on the article when the beamlets are permitted to propagate to the article, and the beamlets impinge the article substantially simultaneously.

In some alternative, additional, or cumulative embodiments, the beamlet selection device occupies an optical position along the optical path, wherein separation between nearest neighboring beamlets is in a range from 0.1 mm to 10 mm.

In some alternative, additional, or cumulative embodiments, the beamlet selection device occupies an optical position along the optical path, and separation between nearest neighboring beamlets is in a range from 0.5 mm to 5 mm.

In some alternative, additional, or cumulative embodiments, the relative motion between the beam axis and the article is in a range of 10 mm/s to 10 m/s.

In some alternative, additional, or cumulative embodiments, the relative motion between the beam axis and the article is in a range of 75 mm/s to 500 mm/s.

In some alternative, additional, or cumulative embodiments, the beamlet selection device occupies an optical position along the optical path, the beamlets of the beamlet group produce respective spot areas on the article when the beamlets are permitted to propagate to the article, and the spot areas become available to the article through the beamlet selection device at a spot availability rate that is a function of the beamlet separation at the optical position and the speed of relative motion between the article and the beam axis.

In some alternative, additional, or cumulative embodiments, the spot availability rate through the beamlet selection device is in a range of 200 mm/s to 20 m/s.

In some alternative, additional, or cumulative embodiments, the spot availability rate through the beamlet selection device is in a range of 500 mm/s to 10 m/s.

In some alternative, additional, or cumulative embodiments, the beamlet selection device occupies an optical position along the optical path, and the beamlet selection device has a speed that is a function of beamlet separation at the optical position and a spot availability rate at which spot areas of respective beamlets become available to the article through the beamlet selection device.

In some alternative, additional, or cumulative embodiments, the speed of the beamlet selection device is a function of the beamlet separation at the optical position divided by the spot availability rate.

In some alternative, additional, or cumulative embodiments, the beamlet selection device has a speed that is in a range of 100 mm/s to 10 m/s.

In some alternative, additional, or cumulative embodiments, the beamlet selection device has a speed that is in a range of 500 mm/s to 2.5 m/s.

In some alternative, additional, or cumulative embodiments, the beamlet group includes multiple rows and multiple columns of beamlets, the spot set has a perimeter with a shape similar to that of a parallelogram, the relative motion includes a laser pass of the beam axis in a pass direction over a portion of the article, the beamlet selection device blocks multiple beamlets during a first time period during the laser pass, the beamlet selection device blocks fewer beamlets during a second time period than during the first time period, and the beamlet selection device blocks fewer beamlets during a third time period than during the second time period.

In some alternative, additional, or cumulative embodiments, the first time period precedes the second time period; the second time period precedes the third time period; at least a first beamlet is permitted to propagate through the beamlet selection device during the first time period; at least the first beamlet and a second beamlet are permitted to propagate through the beamlet selection device during the second time period; at least the first and second beamlets and a third beamlet are permitted to propagate through the beamlet selection device during the third time period; the first, second, and third beamlets form respective first, second, and third parallel line segments on or within the portion of the article during the laser pass; the first, second, and third beamlets are each in a different row and a different column of the beamlet group; the first, second, and third parallel line segments have respective first, second, and third initiation points that are sequentially addressed; and the first, second, and third initiation points are collinear and form a trailing edge that is perpendicular to the pass direction.

In some alternative, additional, or cumulative embodiments, the third time period precedes the second time period; the second time period precedes the first time period; at least a first beamlet is permitted to propagate through the beamlet selection device during the first time period; at least the first beamlet and a second beamlet are permitted to propagate through the beamlet selection device during the second time period; at least the first and second beamlets and a third beamlet are permitted to propagate through the beamlet selection device during the third time period; the first, second, and third beamlets form respective first, second, and third parallel line segments on or within the portion of the article during the laser pass; the first, second, and third beamlets are each in a different row and a different column of the beamlet group; the first, second, and third parallel line segments have respective first, second, and third termination points that are sequentially addressed; and the first, second, and third termination points are collinear and form a leading edge that is perpendicular to the pass direction.

In some alternative, additional, or cumulative embodiments, the first time period precedes the second time period, wherein the second time period precedes the third time period, wherein at least a first beamlet is permitted to propagate through the beamlet selection device during the first time period, wherein at least the first beamlet and a second beamlet are permitted to propagate through the beamlet selection device during the second time period, wherein at least the first and second beamlets and a third beamlet are permitted to propagate through the beamlet selection device during the third time period, wherein the first, second, and third beamlets form respective first, second, and third parallel line segments on or within the portion of the article during the laser pass, wherein the first, second, and third beamlets are each in a different row and a different column of the beamlet group, wherein the first, second, and third parallel line segments have respective first, second, and third initiation points that are sequentially addressed, and wherein the first, second, and third initiation points form a trailing edge that is curvilinear to the pass direction.

In some alternative, additional, or cumulative embodiments, the trailing edge has a compound curvilinear profile with respect to the pass direction.

In some alternative, additional, or cumulative embodiments, the trailing edge has a concave curvilinear profile with respect to the pass direction.

In some alternative, additional, or cumulative embodiments, the trailing edge has a convex curvilinear profile with respect to the pass direction.

In some alternative, additional, or cumulative embodiments, the leading edge has a compound curvilinear profile with respect to the pass direction.

In some alternative, additional, or cumulative embodiments, the leading edge has a concave curvilinear profile with respect to the pass direction.

In some alternative, additional, or cumulative embodiments, the leading edge has a convex curvilinear profile with respect to the pass direction.

In some alternative, additional, or cumulative embodiments, the parallelogram has a side with a positive slope with respect to the pass direction.

In some alternative, additional, or cumulative embodiments, the parallelogram has a side with a negative slope with respect to the pass direction.

In some alternative, additional, or cumulative embodiments, the laser modification comprises a laser mark.

In some alternative, additional, or cumulative embodiments, the beamlet generator comprises a diffractive optical element, the beamlet selection device comprises a mobile aperture, the beam positioning system comprises a galvanometer mirror to affect the relative motion and relative position of the beam axis with respect to the article, movement of the mobile aperture is coordinated with movement of the galvanometer mirror, and the laser modification comprises a laser mark.

In some alternative, additional, or cumulative embodiments, the laser modification covers a minimum area of 1 mm².

In some alternative, additional, or cumulative embodiments, the laser modification has a minimum dimension of 100 microns.

In some alternative, additional, or cumulative embodiments, the spot set has a minimum area of 10 μm×10 μm at a surface of the article using a spot area of having a maximum dimension of less than or equal to about 1 μm.

In some alternative, additional, or cumulative embodiments, the spot set has a minimum dimension of 10 μm at a surface of the article.

In some alternative, additional, or cumulative embodiments, the laser modification is made beneath a surface of the article without damaging the surface of the article.

In some alternative, additional, or cumulative embodiments, the brush stroke edge resolution is invisible to a naked human eye.

One of many advantages of these embodiments is that the spatial shape of the group of spot areas, including the leading and/or trailing edges of the group, can be modified to provide high edge resolution of selectable shapes, including shapes of the leading and trailing edges of a mark, at high throughput.

Additional aspects and advantages will be apparent from the following detailed description of exemplary embodiments, which proceeds with reference to the accompanying drawings.

### BRIEF DESCRIPTION OF THE DRAWINGS

FIG. 1 schematically illustrates a generic embodiment of an article to be modified according to a laser process, and an apparatus configured to perform a laser process to modify the article.

FIG. 2 illustrates a top plan view of an exemplary mark or other modification capable of being formed on an article using the apparatus described with respect to FIG. 1.

FIGS. 3 to 6 schematically illustrate some embodiments of sets of spot areas that may be generated on an article when laser pulses within a group of laser pulses impinge upon the article during a laser modification process.

FIG. 7 schematically illustrates a laser modification process, such as a marking process, according to some embodiments.

FIG. 8 schematically illustrates a laser modification process, such as a marking process, according to some embodiments.

FIG. 9 schematically illustrates an exemplary arrangement of spot areas generated as a result of the laser modification process, such as a marking process, described with respect to FIGS. 7 and 8.

FIGS. 10 and 11 schematically illustrate exemplary arrangements of spot areas generated as a result of marking or other modification processes according to other embodiments.

FIG. 12 schematically illustrates an exemplary arrangement of spot areas generated as a result of a marking or other laser modification process, within a portion of the mark or other modification shown in FIG. 2, according to some embodiments.

FIG. 13 is simplified and partly schematic perspective view of some components of an exemplary laser micromachining system suitable for laser modification of an article.

FIGS. 14 and 15 schematically illustrate different embodiments of the laser systems shown in FIGS. 1 and 13.

FIGS. 16 and 17 schematically illustrate different embodiments of the beamlet generator shown in FIG. 15.

FIGS. 18 to 21 schematically illustrate a laser modification process, such as a marking process, according to still other embodiments.

FIG. 22 schematically illustrates another embodiment of a set of spot areas that may be generated on an article when laser pulses within a group of laser pulses impinge upon the article during a laser modification process.

FIG. 22A₁ is a plan view of an exemplary line set formed by scanning five iterations of the group of pulses similar to the spot set of FIG. 22 relative to the article.

FIG. 22A₂ is a plan view of an exemplary line set formed by scanning forty iterations of the group of pulses similar to the spot set of FIG. 22 relative to the article.

FIG. 22B is a plan view showing a second line set offset from the line set shown in FIG. 22A₂.

FIG. 22C is a plan view showing a third line set offset from the second line set shown in FIG. 22B.

FIG. 23 schematically illustrates yet another embodiment of a set of spot areas that may be generated on an article when laser pulses within a group of laser pulses impinge upon the article during a laser modification process.

FIG. 23A₁ is a plan view of an exemplary line set formed by scanning five iterations of the group of pulses similar to the spot set of FIG. 23 relative to the article.

FIG. 23A₂ is a plan view of an exemplary line set formed by scanning forty iterations of the group of pulses similar to the spot set of FIG. 23 relative to the article.

FIG. 23B is a plan view showing a second line set offset from the line set shown in FIG. 23A₂.

FIG. 23C is a plan view showing a third line set offset from the second line set shown in FIG. 23B.

FIG. 24 is a plan view of an exemplary modification formed on an article using a group of laser pulses to impinge upon the article with a spot set of spot areas having an arrangement similar to that depicted in FIG. 22.

FIG. 25 is a schematic diagram of an laser system having a variably positionable beam blocker for making large modifications with spot area resolution smaller than the area of the spot set.

FIG. 26 is a schematic diagram of an laser system having a mobile aperture coordinated with beam positioner control for making large modifications with spot area resolution smaller than the area of the spot set.

FIG. 27 is a pictorial illustration of exemplary movement of a mobile aperture with respect to a beamlet group and corresponding spot set to create an exemplary trailing edge profile that is substantially perpendicular to the pass direction of the laser beam axis.

FIG. 27A₁-27A₄ are plan views showing an exemplary progression of an exemplary line set formed by scanning five-iteration sets of the group of beamlet pulses similar to the spot set of FIG. 23 relative to the article, wherein certain beamlets forming the spot set of FIG. 23 are blocked by a mobile aperture.

FIG. 27B is a plan view showing a second line set offset from the line set shown in FIG. 27A₄.

FIG. 27C is a plan view showing a third line set offset from the second line set shown in FIG. 27B.

FIG. 28 is another pictorial illustration of exemplary movement of a mobile aperture with respect to a beamlet group and corresponding spot set to create an exemplary leading edge profile that is substantially perpendicular to the pass direction of the laser beam axis.

FIG. 28A₁-28A₄ are plan views showing an exemplary progression of an exemplary line set formed by scanning five-iteration sets of the group of beamlet pulses similar to the spot set of FIG. 23 relative to the article, wherein certain beamlets forming the spot set of FIG. 23 are blocked by the mobile aperture.

FIG. 28B is a plan view showing a second line set offset from the line set shown in FIG. 28A₄.

FIG. 28C is a plan view showing a third line set offset from the second line set shown in FIG. 28B.

FIGS. 29A and 29B show comparative relative height displacements between exemplary spot sets having four and sixteen rows, respectively.

FIGS. 30A and 30B show comparative marks made by exemplary spot sets a having four and sixteen rows, respectively, along a desired curved perimeter.

FIG. 31 shows an example of how enhanced timing coordination can facilitate better perimeter resolution when employing spots sets having a large number of rows.

FIG. 32 shows comparative marks made by an exemplary spot set having 16 rows along a desired diagonal perimeter using simple and enhanced timing coordination, respectively.

FIG. 33 is a schematic diagram of an laser system having multiple mobile apertures coordinated with beam positioner control for making large modifications with spot area resolution smaller than the area of the spot set.

### DETAILED DESCRIPTION OF EXEMPLARY EMBODIMENTS

Example embodiments are described below with reference to the accompanying drawings. Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of components may be disproportionate and/or exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

Laser modification includes one or more of laser marking, scribing, dicing, slicing, drilling, and singulation. For simplicity, laser modification is presented herein only by way of example to laser marking. Laser marking includes surface marking or internal (subsurface) marking.

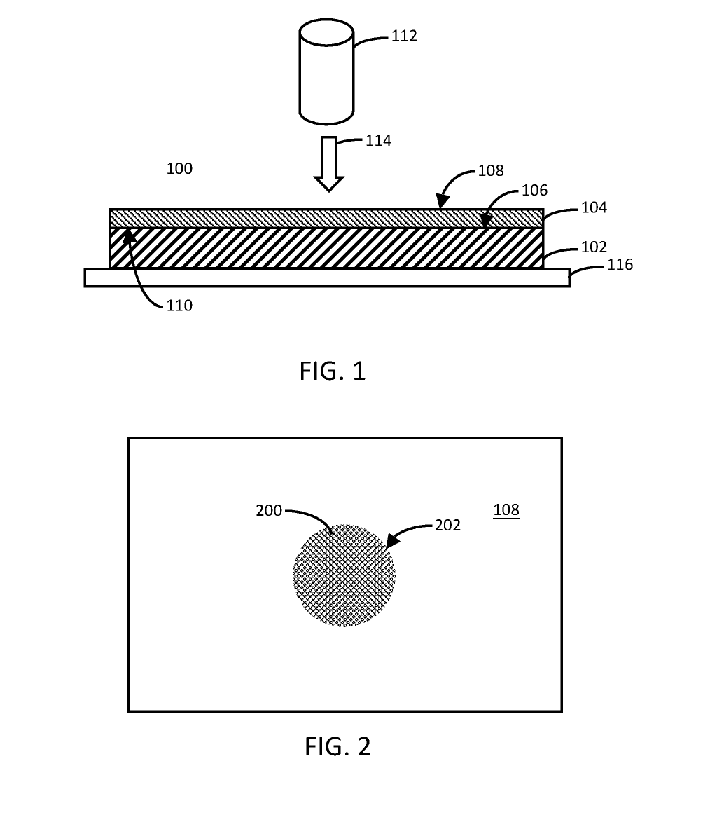

Referring to FIG. 1, an article such as article 100 includes a substrate 102 and a film or layer 104. The substrate 102 and/or layer 104 can be any material that can be changed in response to impingement by laser radiation. For simplicity, the substrate 102 can be formed of a material such as a metal or metal alloy. For example, the substrate 102 can be formed of a metal such as aluminum, titanium, zinc, magnesium, niobium, tantalum, or the like, or an alloy containing one or more of aluminum, titanium, zinc, magnesium, niobium, tantalum, or the like.

For simplicity, the layer 104 can be a material such as a metal oxide. In one embodiment, the layer 104 includes an oxide of one or more metals within the substrate 102, but could include an oxide of a metal not found in the substrate 102. The layer 104 may be formed by any suitable process. For example, the layer 104 can be formed by a physical vapor deposition process, a chemical vapor deposition process, an anodization process (e.g., involving exposure to chromic acid, sulfuric acid, oxalic acid, sulfosalicylic acid, phosphoric acid, borate or tartrate baths, or the like, to a plasma, or the like, or a combination thereof), or the like, or a combination thereof. Generally, a thickness of the layer 104 can be about 50 μm or less. In one embodiment, the layer 104 acts to protect a surface (e.g., surface 106) of the substrate 102 from abrasion, oxidation, or other corrosion. Thus, the layer 104 can also be referred to herein as a “passivation layer” or “passivation film.”

In the illustrated embodiment, the layer 104 adjoins (i.e., directly contacts) the substrate 102. In other embodiments, however, the layer 104 can be adjacent to the substrate 102, but not contact the substrate 102. For example, an intervening layer (e.g., a native oxide layer having a different composition from the layer 104, a different structure from the layer 104, etc.) can be located between the substrate 102 and the layer 104. Although the article 100 has been described as including a metallic substrate 102, alternative substrate materials include ceramics, glasses, and plastics, or combinations thereof. Exemplary substrate materials may be crystalline or noncrystalline. Exemplary substrate materials may be natural or synthetic. For example, laser micromachining systems can make appropriately sized laser modifications, such as marks, on or within semiconductor wafer materials, such as alumina or sapphire. Laser micromachining systems can also make appropriately sized laser modifications, such as marks, on or within glass, strengthened glass, and Corning® Gorilla® Glass. Laser micromachining systems can also make appropriately sized laser modifications, such as marks, on or within polycarbonates, acrylics, or other polymers. Exemplary polymer substrate materials may include, but are not limited to, high-density polyethylene, acrylonitrile butadiene styrene, polypropylene, polyethylene terephthalate, polyvinyl chloride, thermoplastic elastomers, or the like. Furthermore, although the article 100 is illustrated as including the layer 104, it will be appreciated that the layer 104 may be omitted. In some embodiments, the article 100 may be provided as exemplarily described in any of U.S. Pat. No. 8,379,679 (of Haibin Zhang et al.), U.S. Pat. No. 8,389,895 (of Robert Reichenbach et al.), U.S. Pat. No. 8,604,380 (of Jeffrey Howerton et al.), U.S. Pat. No. 8,379,678 (of Haibin Zhang et al.), or U.S. Pat. No. 9,023,461 (of James Brookhyser et al.) or U.S. Patent Application Publication No. 2014-0015170 (of Robert Reichenbach et al.), the contents of each of which are incorporated herein by reference.

Constructed as described above, the article 100 and can be provided as at least a portion of a housing for device such as a personal computer, a laptop computer, a tablet computer, a personal digital assistant, a portable media player, a television, a computer monitor, a telephone, a mobile phone, an electronic book, a remote controller, a pointing device (e.g., a computer mouse), a game controller, a thermostat, a dishwasher, a refrigerator, a microwave, or the like, or may be provided as a button of any other device or product, or may be provided as a sign or badge, or the like. Constructed as described above, the article 100 includes a surface (e.g., a first surface 108 of the layer 104) having one or more optical characteristics, such as a visual appearance. Thus, the optical characteristics or visual appearance of the article 100 at the surface 108 can be characterized as a result of the interaction between characteristics of the substrate 102 (e.g., including material composition, molecular geometry, crystal structure, electronic structure, microstructure, nanostructure, texture of the surface 106, or the like or a combination thereof), characteristics of the layer 104 (e.g., the material composition, thickness, molecular geometry, crystal structure, electronic structure, microstructure, nanostructure, texture of the first surface 108, texture of a second surface 110 opposite the first surface 108, or the like or a combination thereof), characteristics of the interface between surfaces 106 and 110, characteristics of the substrate 102 and/or the layer 104 at or near the interface, or the like, or a combination thereof.

According to some embodiments, the optical characteristics or visual appearance of a portion of the article 100 (also referred to herein as one or more “preliminary optical characteristics” or a “preliminary visual appearance”) can be modified to form a feature, such as a mark (e.g., mark 200, as shown in FIG. 2), on the article 100, having one or more modified optical characteristics or a modified visual appearance which is different from the preliminary optical characteristics or the preliminary visual appearance and may be visible at the surface 108 of the article 100. (“Optical characteristic(s)” and “visual appearance” may be used interchangeably, but it is noted that optical characteristics need not result in a laser mark or laser feature visible to an unaided human eye.) The mark 200 may be formed at the surface 108 of the article 100, below the surface 108 of the article 100 (e.g., between surfaces 108 and 110, at the interface between surfaces 110 and 106, below the surface 106, or the like or a combination thereof), or a combination thereof. The mark 200 can include an edge 202, which generally delineates the location on the article 100 at which the modified optical characteristic meets the preliminary optical characteristic (or the modified visual appearance meets the preliminary visual appearance). Although the mark 200 is illustrated in a single specific form, it will be appreciated that the mark 200 can have any shape, and more than one mark can be provided. In some examples, the mark 200 can be textual, graphic, or the like, or a combination thereof, and may convey information such as the name of a product, the name of a product manufacturer, a trademark, copyright information, design location, assembly location, model number, serial number, license number, an agency approval, standards compliance information, an electronic code, a logo, a certification mark, an advertisement, a user-customizable feature, or the like, or a combination thereof.

In one embodiment, both the preliminary and modified visual appearance can be described using CIE 1976 L*a*b* (also known as CIELAB), which is a color space standard specified by the International Commission on Illumination (French Commission internationale de l'eclairage). CIELAB describes colors visible to the human eye and was created to serve as a device-independent model to be used as a reference. The three coordinates of the CIELAB standard represent: 1) the lightness factor magnitude of the color (L*=0 yields ultimate black and L*=100 indicates diffuse ultimate white, 2) its position between red/magenta and green (a*, negative values indicate green while positive values indicate magenta) and 3) its position between yellow and blue (b*, negative values indicate blue and positive values indicate yellow). Measurements in a format corresponding to the CIELAB standard may be made using a spectrophotometer, such as the COLOREYE® XTH Spectrophotometer, sold by GretagMacbeth®. Similar spectrophotometers are available from X-Rite™.

In one embodiment, the modified visual appearance of the mark 200 may be darker than the preliminary visual appearance of the article 100. For example, the article 100 can have a preliminary visual appearance with a lightness factor magnitude, L*, of about 80, and the mark 200 can have a modified visual appearance with a desired lightness factor magnitude, L*, value of less than 37, less than 36, or less than 35 or less than 34 (or at least substantially equal to 34). In another example embodiment, the article 100 can have a preliminary visual appearance with a lightness factor magnitude, L*, of about 25, and the mark 200 can have a modified visual appearance with a desired lightness factor magnitude, L*, value of less than 20 or less than 15 (or at least substantially equal to 15). It will be appreciated, however, that the mark 200 can have any L*, a* and b* values depending upon the characteristics of the article 100 and the specific process used to form the mark 200. In addition, the modified visual appearance of the mark 200 may be at least substantially uniform across the area of the mark 200, or may vary (e.g., in terms of one or more of L*, a* and b* values).

Moreover, in some embodiments, the modified visual appearance of the mark 200 may vary by less than 10% in any one of the L*, a* and b* values. In some embodiments, the modified visual appearance of the mark 200 may vary by less than 5% in any one of the L*, a* and b* values. In some embodiments, the modified visual appearance of the mark 200 may vary by less than 1% in any one of the L*, a* and b* values.

In some embodiments, the modified visual appearance of the mark 200 may vary by less than 10% in any two of the L*, a* and b* values. In some embodiments, the modified visual appearance of the mark 200 may vary by less than 5% in any two of the L*, a* and b* values. In some embodiments, the modified visual appearance of the mark 200 may vary by less than 1% in any two of the L*, a* and b* values.

In some embodiments, the modified visual appearance of the mark 200 may vary by less than 10% in all three of the L*, a* and b* values. In some embodiments, the modified visual appearance of the mark 200 may vary by less than 5% in all three of the L*, a* and b* values. In some embodiments, the modified visual appearance of the mark 200 may vary by less than 1% in all three of the L*, a* and b* values.

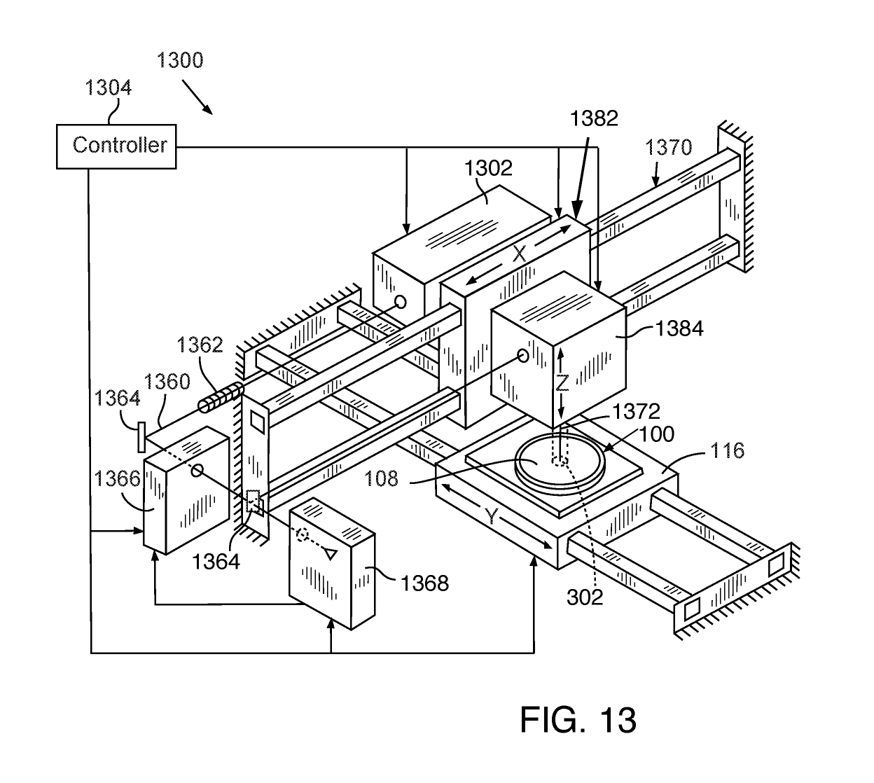

Generally, the mark 200 may be formed by a process that includes sequentially directing groups of pulses of laser light (also referred to herein as “laser pulses”) onto the article 100, wherein laser pulses within the groups are configured to produce a visible mark (e.g., mark 200) on the article 100. As exemplarily shown in FIG. 1, an apparatus for performing the laser modification process, such as the laser marking process, described herein may include a laser system 112 configured to generate and direct the laser pulses toward the article 100 along the direction indicated by arrow 114. In one embodiment, the laser system 112 optionally includes an article support 116, such as a stage or chuck 116, configured to support the article 100 during the laser modification process. In another embodiment, the apparatus may further include one or more motors, actuators, or the like or a combination thereof (not shown), coupled to the article support 116 to move (e.g., rotate or linearly translate) the article 100 relative to a beam axis 1372 (FIG. 13) of the laser system 112 during the laser modification process, such as the laser marking process.

Although not illustrated, the laser system 112 may include one or more laser sources configured to generate the laser pulses, a beam modification system operative to modify (e.g., shape, expand, focus, or the like, or a combination thereof) the laser pulses, a beam steering system (e.g., one or more galvanometer-mirrors, fast-steering mirrors, acousto-optic deflectors, or the like, or a combination thereof) operative to scan the laser pulses along a route (such as a relative beam travel path) on or within the article 100, or the like, or a combination thereof. Laser pulses generated by the laser system 112 may be Gaussian, or the apparatus may optionally include beam-shaping optics configured to reshape the laser pulses as desired.

Characteristics of the laser pulses (e.g., pulse wavelength, pulse duration, average power, peak power, spot fluence, scan rate, pulse repetition rate, spot shape, spot diameter, or the like, or a combination thereof) can be selected to form a mark 200 having a desired appearance. For example, the pulse wavelength can be in the ultraviolet range, visible range, or infrared range of the electromagnetic spectrum (e.g., in a range from 238 nm to 10.6 μm, such as 343 nm, 355 nm, 532 nm, 1030 nm, 1064 nm, or the like), the pulse duration (e.g., based on full width at half-maximum ((FWHM)) can be in a range from 0.1 picosecond (ps) to 1000 nanoseconds (ns) (e.g., in one embodiment, in a range from 0.5 ps to 10 ns and, in another embodiment, in a range from 5 ps to 10 ns), the average power of the laser pulses can be in a range from 0.05 W to 400 W, the scan rate can be in a range from 10 mm/s to 1000 mm/s, the pulse repetition rate can be in a range from 10 kHz to 1 MHz, and the spot diameter (e.g., as measured according to the 1/e² method) can be in a range from 3 μm to 1 mm (e.g., in a range from 5 μm to 350 μm, in a range from 10 μm to 100 μm, or the like). It will be appreciated that any of the aforementioned laser pulse characteristics can be varied in any manner within or outside the ranges discussed above depending on, for example, the material from which the substrate 102 is formed, the material from which the layer 104 is formed, the desired appearance of the mark 200, the particular configuration of the laser system 112 (e.g., which may include a beamlet generator 1401 (FIG. 15) having one or more modulation elements, as discussed in greater detail below), or the like, or a combination thereof. In some embodiments, and depending on factors such as the article 100 to be marked, the desired appearance of the mark 200, etc., laser pulses directed onto the article 100 can have laser pulse characteristics as exemplarily described in any of U.S. Pat. Nos. 8,379,679, 8,389,895, 8,604,380, 8,451,871, 8,379,678, or 9,023,461 or U.S. Patent Application Publication No. 2014-0015170, the contents of each of which are incorporated herein by reference.

As mentioned above, the mark 200 may be formed by a process that includes sequentially directing groups of laser pulses onto the article 100 such that each directed laser pulse impinges upon the article 100 at a corresponding spot area. Generally, the aforementioned laser pulse characteristics are selected such that at least one characteristic (e.g., a chemical composition, molecular geometry, crystal structure, electronic structure, microstructure, nanostructure, or the like, or a combination thereof) of the portion of the article 100 proximate to the spot area is modified or altered in a desired manner. As a result of this modification, the preliminary visual appearance of the article 100 at a location corresponding to the location of the spot area also becomes modified. Thus after multiple groups of laser pulses are directed onto the article 100, the visual appearance of the article 100 can be modified to form the mark 200.

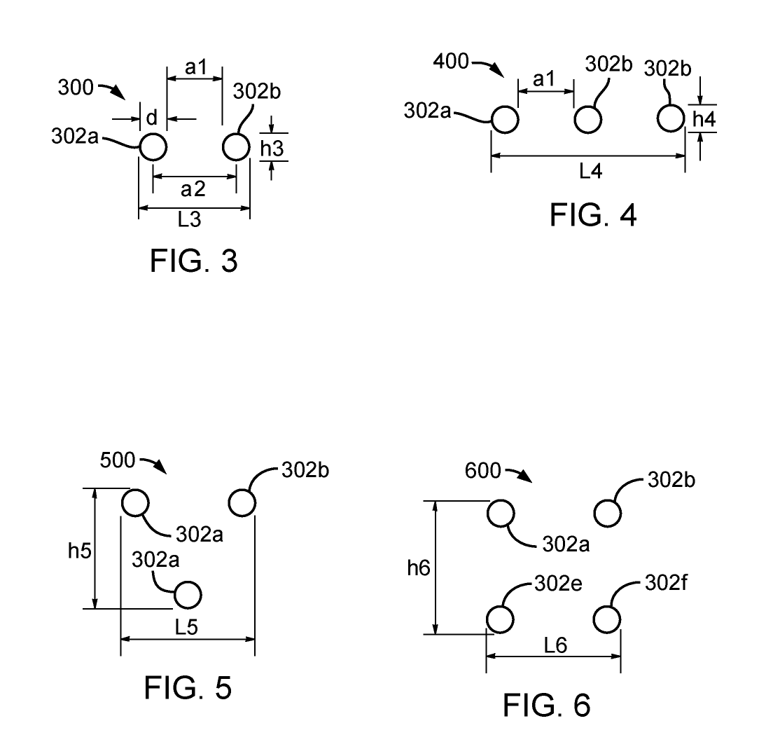

Referring to FIG. 3, a group of laser pulses can include two (or more) laser pulses that impinge upon the article 100 to generate a set of spot areas (also referred to herein as a “spot set”), such as spot set 300, on the article 100. Each of the first spot area 302a and the second spot area 302b have a 1/e² spot diameter (also referred to herein as a “spot width” or “major spatial axis”), d, measured along a common line or axis passing through the centers of spot areas 302a and 302b (also referred to herein as the “spot-to-spot axis”). In addition, the second spot area 302b is spaced apart from the first spot area 302a by a spot separation distance, a1 (between the closest spot edges of the spot areas 302a and 302b). In some embodiments, a1>d. The center-to-center distance between spot areas 302a and 302b within spot set 300 can be referred to the “spot separation pitch,” a2. Although FIG. 3 illustrates the spot areas within spot set 300 as being circular, it will be appreciated that any spot area within the spot set can have any other shape (e.g., elliptical, triangular, etc.).

There is some belief that the aforementioned defects and degradation in mark appearance associated with the conventional throughput-enhancing process are at least partly the result of high thermal loads generated within the article by the rapid accumulation of two or more laser pulses successively directed onto overlapping, or relatively spatially close, spot areas on the article 100. However, this application is not dedicated or bound to this or any other particular theory.

According to some embodiments, the magnitude of the spot separation distance, a1, between neighboring or adjacent spot areas in a spot set such as spot set 300 can be selected to ensure that heat generated within the article 100 due to a laser pulse impinging the article 100 at one spot area (e.g., spot area 302a) is effectively prevented from being transferred to a region of the article 100 where another spot area (e.g., spot area 302b) is formed. Thus the spot separation distance, a1, between spot areas 302 in a spot set can be selected to ensure that, during the process of forming a spot set, different portions of the article 100 at spot areas within the spot set are at least substantially thermally independent of one another. By ensuring that spot areas 302 are located on the article 100 at positions that are relatively spatially distant from each other, marking processes according to some embodiments can be adapted to form a mark having a desirable appearance faster than the conventional marking process, while also overcoming the aforementioned limitations associated with high thermal loads that can undesirably damage the article 100 (e.g., by generating cracks within the layer 104, by inducing at least a partial delamination of the layer 104 from the substrate 102, or the like, or a combination thereof), or that can undesirably change the visual appearance of the article 100, or the like, or a combination thereof. Moreover, other laser modification processes such as trench cutting may similarly benefit.

It will be appreciated that the magnitude of the spot separation distance, a1, may depend upon one or more factors such as the fluence of the laser pulses associated with each spot area, the thermal conductivity of one or more portions of the article 100, the size and shape of each spot area on the article 100, or the like, or a combination thereof. For example, in embodiments where the article 100 is an anodized metallic article (e.g., having a substrate 102 formed of aluminum or an alloy thereof and a layer 104 formed of anodic aluminum oxide), the spot separation distance, a1, between spot areas 302a and 302b may be in a range from 3 μm to 3 mm (e.g., about 5 μm, about 10 μm, or the like, or in a range from 150 μm to 3 mm, in a range from 200 μm to 3 mm, in a range from 300 μm to 3 mm, in a range from 400 μm to 3 mm, in a range from 500 μm to 3 mm, or the like). In some embodiments, the spot separation distance, a1, may be greater than the spot diameter, d, but less than six times larger than the spot diameter, d (i.e., 6d>a1>d). In other embodiments, the spot separation distance, a1, may be less than the spot diameter, d, or greater than six times larger than, the spot diameter, d (i.e., a1>3d, or a1<d).

In one embodiment, the laser pulse generating spot area 302a may impinge upon the article 100 at the same time (simultaneously) as the laser pulse generating spot area 302b. In other embodiments, however, the laser pulse generating spot area 302a may impinge upon the article 100 before or after the laser pulse generating spot area 302b. In such embodiments, the period between generation of the spot areas 302a and 302b can be in a range from 0.1 μs to 30 μs (e.g., in one embodiment, in a range from 1 μs to 25 μs; in another embodiment, in a range from 2 μs to 20 μs, and in another embodiment, in a range from 0.1 μs to 1 μs.). Depending upon factors such as the configuration of the laser system 112, the spot separation distance, a1, and the like, the period between generation of the spot areas 302a and 302b can be less than 0.1 μs or greater than 30 μs.

The laser pulses for delivering spot areas 302a and 302b may be generated by separate lasers (and laser heads) and delivered along separate optical paths and separate optical components, or the laser pulses for delivering spot areas 302a and 302b may be generated by separate lasers and delivered along optical paths that share one or more common optical path segments and/or one or more optical path components. Alternatively, the laser pulses for delivering spot areas 302a and 302b may be generated by the same laser, and the beam may be split or diffracted into simultaneous or sequential distinct beamlets as later described in greater detail.

With reference again to FIG. 3, the spot set 300 can occupy a group or pattern height, h3, and a group or pattern length, L3. The group height is the cumulative height made by the spot areas 302a and 302b. The group length is the total distance achieved or traveled by the spot set 300 including the space between the spot areas 302a and 302b. In the example depicted in FIG. 3, h3 is about equal to d; and, L3 is about equal to a1+2(d).

Although FIG. 3 illustrates a spot set 300 that includes two spot areas (i.e., first spot area 302a and second spot area 302b), it will be appreciated that a group of laser pulses can include more than two laser pulses (e.g., 10 or more laser pulses) that impinge upon the article 100 to generate a set having more than two spot areas (e.g., 10 or more spot areas) spatially arranged relative to each other to form a beneficial otherwise suitable pattern of spot areas. For example, a group of laser pulses can include three (or more) laser pulses that impinge the article 100 to generate a spot set such as spot set 400 having the first spot area 302a, the second spot area 302b, and a third spot area 302c, spatially arranged in a linear pattern as shown in FIG. 4. The spot set 400 can occupy a group or pattern height, h4, and a group or pattern length, L4. The group height is the cumulative height made by the spot areas 302a, 302b, and 302c. The group length is the total distance achieved or traveled by the spot set 400 including the space between the spot areas 302a, 302b, and 302c. In the example depicted in FIG. 4, h4 is about equal to d; and, L4 is about equal to 2(a1)+2(d).

In another example, a group of laser pulses can include three (or more) laser pulses (or beamlets) that impinge the article 100 to generate a spot set such as spot set 500 having the first spot area 302a, the second spot area 302b and a third spot area 302d, spatially arranged in a triangular pattern as shown in FIG. 5. (As later explained, the pattern of spot areas can be created by and alternative beamlet group configuration than that employed to create the spot set pattern presented in FIG. 4.) The spot set 500 can occupy a group or pattern height, h5, and a group or pattern length, L5. The group height is the cumulative height made by the spot areas 302a, 302b, and 302d. The group length is the total distance achieved or traveled by the spot set 500 including the space between the spot areas 302a and 302b.

In yet another example, a group of laser pulses can include four laser pulses that impinge the article 100 to generate a spot set such as spot set 600 having the first spot area 302a, the second spot area 302b, a third spot area 302e, and a fourth spot area 302f spatially arranged in a square or rectangular pattern as shown in FIG. 6. The spot set 600 can occupy a group or pattern height, h6, and a group or pattern length, L6. The group height is the cumulative height made by the spot areas 302a, 302b, 302e, and 302f. The group length is the total distance achieved or traveled by the spot set 600 including the space between the spot areas 302a and 302b (or 302e and 302f).

Within a spot set, the separation distance between one pair of neighboring or adjacent spot areas (e.g., between spot areas 302b and 302c, as shown in FIG. 4, between spot areas 302b and 302d, as shown in FIG. 5, or between spot areas 302b and 302f, as shown in FIG. 6) may be the same or different as the separation distance between any other pair of neighboring or adjacent spot areas (e.g., between spot areas 302a and 302c, as shown in FIG. 4, between spot areas 302a and 302d, as shown in FIG. 5, or between spot areas 302e and 302f, as shown in FIG. 6). It will also be appreciated that in FIGS. 4-6 the relative placement of spot areas 302b with respect to 302a need not be the same as that shown or described with respect to FIG. 3 and as in relation to the additional spot areas 302.

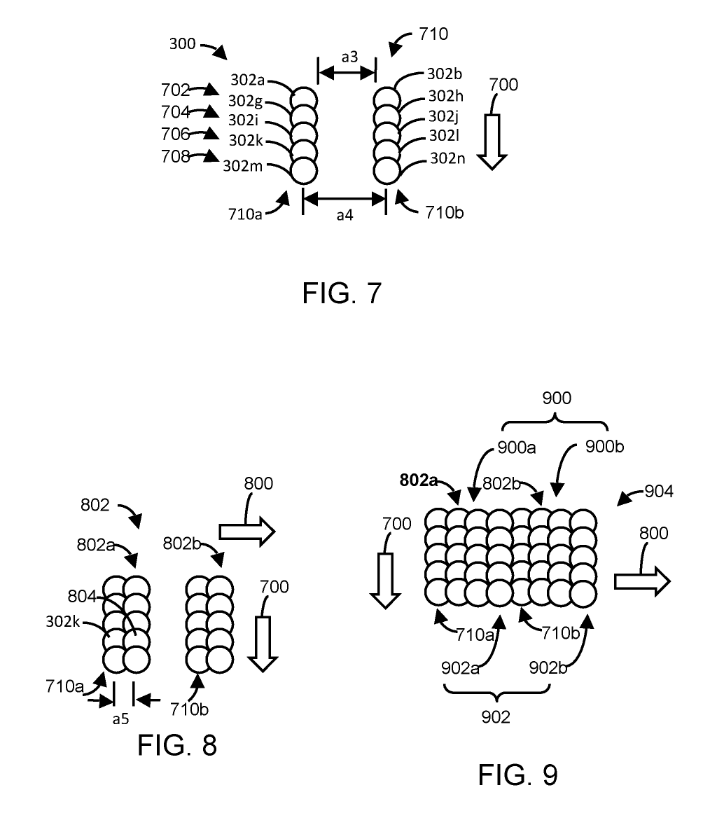

As mentioned above, the mark 200 may be formed by a process that includes sequentially directing groups of laser pulses onto the article 100. For example, and with reference to FIG. 7, after a first group of laser pulses is directed onto the article 100 to generate a first spot set (e.g., the aforementioned spot set 300), the laser system 112 may be actuated and/or the article support 116 may be moved such that additional groups of laser pulses are sequentially directed onto the article 100 to generate additional spot sets offset from one another along the pass or scan direction indicated by arrow 700 (also referred to herein as the “scan direction”). For example, a second group of laser pulses is directed onto the article 100 to generate a second spot set 702 (e.g., which includes spot areas 302g and 302h). Thereafter, a third group of laser pulses is directed onto the article 100 to generate a third spot set 704 (e.g., which includes spot areas 302i and 302j). Fourth and fifth groups of laser pulses are subsequently and sequentially directed onto the article 100 to generate a fourth spot set 706 (e.g., which includes spot areas 302k and 3021) and a fifth spot set 708 (e.g., which includes spot areas 302m and 302n).

In the illustrated embodiment, the spatial arrangement of spot areas in one spot set is the same as the spatial arrangement of spot areas in every other spot set. In other embodiments, however, the spatial arrangement of spot areas in one spot set can be different from the spatial arrangement of spot areas in any other spot set. Further, laser pulse characteristics of laser pulses within one group of laser pulses may be the same as, or different from, laser pulse characteristics of laser pulses within another group of laser pulses. Although the scan direction 700 is illustrated as being perpendicular to the spot-to-spot axis of each of the spot sets 300, 702, 704, 706 and 708, it will be appreciated that the scan direction 700 may extend along a direction that is oblique with respect to (or parallel to) the spot-to-spot axis of any or all of the spot sets. Thus, scan lines (e.g., scan lines 710a and 710b) within a line set (e.g., line set 710) may be separated by a line separation distance, a3, that may be less than or equal to the spot separation distance, a1. The center-to-center distance between a spot area (e.g., spot area 302g) in one scan line 710a and a corresponding spot area (e.g., spot area 302h) in the other scan line 710b within the line set 710 can be referred to the “line set pitch,” a4.

The process of sequentially directing groups of laser pulses along the scan direction 700 may be continued and repeated as desired to form a set 710 of scan lines (also referred to as a “line set”) on the article 100 (e.g., which includes scan lines 710a and 710b). For purposes of discussion, the process of forming one line set will be referred to as a “scanning process” (which may be indicative of a single pass of relative motion between the beam axis 1372 (FIG. 13) and the article 100), and spot areas within a scan line are aligned relative to one another along the scan direction 700. (It will be noted that for convenience, the term “beam axis” may be used to generally and/or collectively represent all of the beam axes of the individual beamlets, as well as be used to denote the beam axis of any particular beamlet.) Generally, laser pulses within different groups of laser pulses may be directed onto the article 100 such that a resultant scan line is formed by spot areas that overlap one another. The degree to which adjacent spot areas overlap (i.e., the “bite size” or “scan pitch”) can be defined as the center-to-center distance between overlapping spot areas in a scan line, measured along the scan direction 700. The bite size may be constant along the scan direction 700, or may vary.

Laser pulse characteristics (e.g., pulse repetition rate, scan rate, or the like or a combination thereof) can be selected such that the period between the generation of successive spatially-formed (or overlapping) spot areas within the same scan line is greater than the aforementioned temporal period between the generation of adjacent or neighboring spot areas within the same spot set. For example, the beamlets forming a spot set can be applied simultaneously or near simultaneously, and the spot sets are applied sequentially (and the spot sets need not be applied in an order to be spatially successive). By ensuring that spot areas generated within the same scan line are relatively temporally distant from each other, marking processes according to some embodiments can be adapted to form a mark having a desirable appearance at a faster rate than marks made by the conventional marking process, while also overcoming the aforementioned limitations associated with high thermal loads that can undesirably damage the article 100 (e.g., by generating cracks within the layer 104, by inducing at least a partial delamination of the layer 104 from the substrate 102, or the like, or a combination thereof), or that can undesirably change the visual appearance of the article 100, or the like, or a combination thereof.

Referring to FIG. 8, after a first line set is formed (e.g., the aforementioned line set 710), the laser system 112 may be actuated and/or the article support 116 may be moved such that additional line sets can be formed to generate additional scan lines offset from previously-formed scan lines along the direction indicated by arrow 800 (also referred to herein as the “fill direction”). As exemplarily shown, the aforementioned scanning process described with respect to FIG. 7 may be repeated to form a second line set such as line set 802, which includes scan lines 802a and 802b. Generally, laser pulses within different groups of laser pulses may be directed onto the article 100 such that a resultant scan line (e.g., scan line 802a) in the second line set 802 overlaps a corresponding scan line (e.g., scan line 710a) in the first line set 710. The degree to which adjacent scan lines overlap (i.e., the “line pitch”) can be defined as the center-to-center distance, a5, between neighboring or adjacent spot areas in adjacent scan lines, measured along the fill direction 800.

In one embodiment, the line pitch may be an integer divisor of the line set pitch a4. The line pitch between a pair of adjacent scan lines may be constant along the scan direction 700, or may vary. Further, the line pitch between pairs of adjacent scan lines may be constant along the fill direction 800, or may vary. In the illustrated embodiment, the spot sets forming the scan lines 802a and 802b of the second line set 802 are the same as spot sets forming the scan lines 710a and 710b of the first line set 710. In other embodiments, however, the spot sets forming the scan lines 802a and 802b of the second line set 802 may be different from the spot sets forming the scan lines 710a and 710b of the first line set 710. Further, the characteristics of the second scanning process (e.g., pulse repetition rate, scan rate, line pitch, bite size, or the like, or a combination thereof) associated with forming the second line set 802 can be selected such that the temporal period between the generation of a spot area (e.g., spot area 804) in the second line set 802 and the generation of a corresponding spot area (e.g., spot area 302k) in the first line set 710a is greater than the aforementioned temporal period between the generation of adjacent or neighboring spot areas within the same spot set. By ensuring that corresponding spot areas generated within neighboring or adjacent scan lines (e.g., scan lines 710a and 802a) are relatively temporally distant from each other, marking processes according to embodiments of the present disclosure can be adapted to form a mark having a desirable appearance faster than the conventional marking process, while also overcoming the aforementioned limitations associated with high thermal loads that can undesirably damage the article 100 (e.g., by generating cracks within the layer 104, by inducing at least a partial delamination of the layer 104 from the substrate 102, or the like, or a combination thereof), or that can undesirably change the visual appearance of the article 100, or the like, or a combination thereof.

Referring to FIG. 9, and after forming the second line set 802, the laser system 112 may be actuated and/or the article support 116 may be moved such that additional scanning processes may be performed to generate additional line sets. As exemplarily shown, the aforementioned processes may be repeated to form a third line set 900 (e.g., which includes scan lines 900a and 900b) and a fourth line set 902 (e.g., which includes scan lines 902a and 902b). In one embodiment, the third line set 900 may be formed before the fourth line set 902. In another embodiment, however, the fourth line set 902 may be formed before the third line set 900. Upon forming the scan lines as exemplarily discussed above, a composite scan line 904 is created, which including scan lines from the first line set 710, the second line set 802, the third line set 900, and the fourth line set 902. Further, a the space between scan lines (e.g., scan lines 710a and 710b) of a line set (e.g., the first line set 710) is occupied with a desired number of offset scan lines (e.g., three scan lines) to form a scan line region.

In embodiments of the marking process exemplarily discussed above with respect to FIGS. 7 to 9, laser pulses are directed to impinge upon the article 100 to generate a composite scan line in which spot areas within the same scan line overlap one another and in which spot areas of adjacent scan lines also overlap one another. In other embodiments, however, laser pulses can be directed to impinge upon the article 100 to generate a composite scan line in which spot areas within the same scan line do not overlap one another, in which spot areas of neighboring or adjacent scan lines do not overlap one another, or a combination thereof.

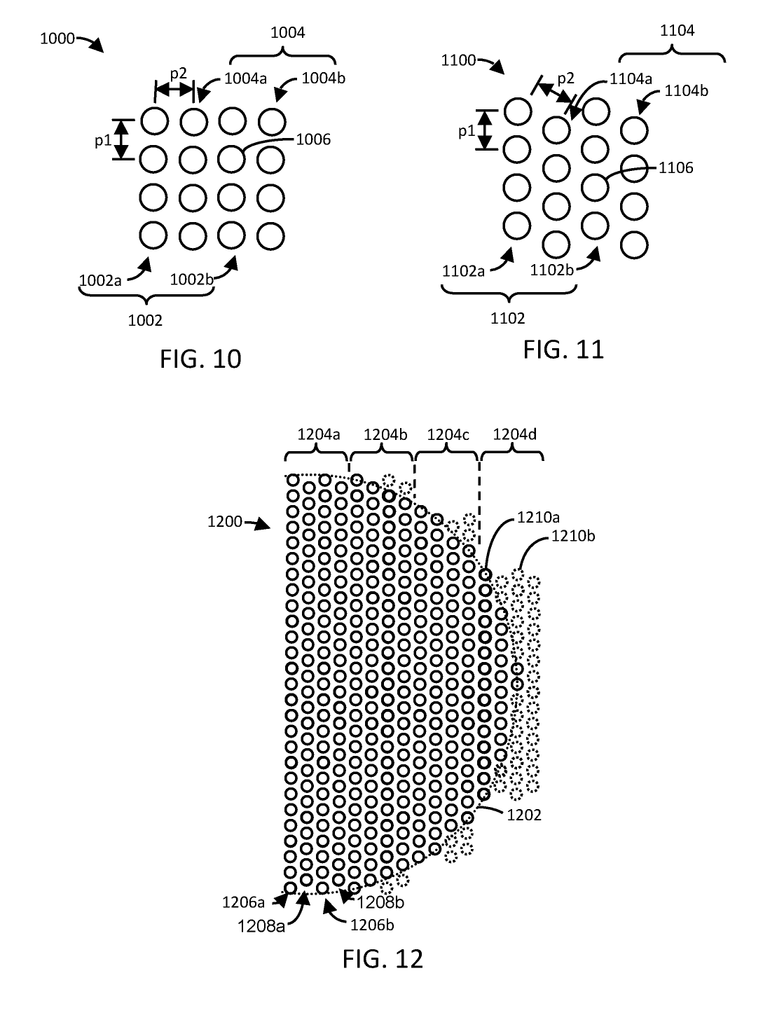

For example, and with reference to FIG. 10, a composite scan line 1000 can be formed by a marking process that includes two scanning processes performed as exemplarily described above. In the illustrated embodiment, however, laser pulse characteristics in each scanning process can be selected to form a line set 1002 (e.g., including scan lines 1002a and 1002b) and a line set 1004 (e.g., including scan lines 1004a and 1004b), in which spot areas within the same scan line do not overlap one another and in which spot areas within different scan lines do not overlap another. As illustrated, the aforementioned scan pitch (identified here as, p1) between neighboring or adjacent spot areas within the same scan line is greater than the aforementioned spot width, d, of the spot areas. In other embodiments, however, the scan pitch, p1, may be equal to the spot width, d. The aforementioned line pitch (identified here as, p2) between spot areas in neighboring or adjacent scan lines is greater than the aforementioned spot width, d, of the spot areas. In other embodiments, however, the line pitch, p2, may be equal to the spot width, d. In the illustrated embodiment, the scan pitch, p1, is constant along the scan direction 700 and is equal to the line pitch, p2, which is constant along the fill direction 800. Moreover, the spot areas within the line sets 1002 and 1004 are aligned relative to one another such that four spot areas can be equally spaced apart from the same spot area (e.g., spot area 1006). In other embodiments, however, the scan pitch, p1, can vary along the scan direction 700, the line pitch, p2, can vary along the fill direction 800, or a combination thereof. In still other embodiments, the scan pitch, p1, can be greater than or less than the line pitch p2.

In another example, and with reference to FIG. 11, a composite scan line 1100 can be formed by a marking process that includes two scanning processes performed as exemplarily described above. In the illustrated embodiment, however, laser pulse characteristics in each scanning process can be selected to form a line set 1102 (e.g., including scan lines 1102a and 1102b) and a line set 1104 (e.g., including scan lines 1104a and 1104b), in which spot areas within the same scan line do not overlap one another and in which spot areas within different scan lines do not overlap another. In the illustrated embodiment, the line pitch between, p2, is measured at an angle between the scan direction 700 and the fill direction 800. In the illustrated embodiment, the scan pitch, p1, is constant along the scan direction 700 and is equal to the line pitch, p2. In the illustrated embodiment, the cosine of the line pitch, p2, (i.e., cos(p2)) is constant along the fill direction 800. Moreover, the spot areas within the line sets 1002 and 1004 are aligned relative to one another such that six spot areas can be equally spaced apart from the same spot area (e.g., spot area 1106). In other embodiments, however, the scan pitch, p1, can vary along the scan direction 700, the cosine of the line pitch, p2, can vary along the fill direction 800, or a combination thereof. In still other embodiments, the scan pitch, p1, can be greater than or less than the line pitch p2.

The above-described process of forming any of the composite scan lines may be repeated as desired to form the mark 200. Thus, the mark 200 can be broadly characterized as a collection of mutually-offset spot areas (e.g., overlapping or spaced apart from one another), in which the center-to-center distance between neighboring or adjacent spot areas within the mark 200, measured along any direction (also referred to herein as the “spot pitch”) is less than the aforementioned spot separation distance, a1. While a visually-desirable mark formed only of overlapping spot areas may be formed at a desirably high throughput, it will nevertheless be appreciated that the throughput of the marking process may be increased further if at least some of the spot areas do not overlap each other, thereby reducing the number of spot areas within the mark.

Generally, the laser system 112 may be configured to direct laser pulses onto the article 100 to generate spot areas within a region of the article 100 where the mark 200 is to be formed. The edge 202 of the mark 200 may be defined by any suitable method. For example, in one embodiment, a mask or stencil (not shown) of the mark 200 may be provided (e.g., within the laser system 112, on the surface 108 of the article 100, or otherwise between the laser system 112 and the article 100. Thus to form the edge 202, the laser system 112 can be configured to direct the laser pulses (e.g., in the manner described above) onto and through the mask. Laser pulses that impinge upon the article 100 generate the aforementioned spot areas and alter the preliminary visual appearance to form the modified visual appearance. However, laser pulses that impinge upon the mask are prevented from generating spot areas and so do not alter the preliminary visual appearance to form the modified visual appearance.

In another embodiment, the edge 202 may be defined without use of the mask or stencil. For example, in one embodiment, the laser system 112 can be controlled to selectively direct laser pulses onto the article 100 so as to generate spot areas only at locations on the article 100 corresponding to the desired location of the mark 200. For example, and with reference to FIG. 12, the laser system 112 can be controlled to selectively direct laser pulses onto the article 100 so as to generate an arrangement 1200 of spot areas (e.g., indicated as solid-lined circles) only at locations on the article 100 at least substantially corresponding to the desired location of the mark 200 (e.g., at locations disposed at one side of an intended mark edge 1202). In one embodiment, the arrangement 1200 of spot areas can be generated by controlling the laser system 112 to form a series of composite scan lines (e.g., composite scan lines 1204a, 1204b, 1204c and 1204d), wherein each composite scan line includes two line sets (e.g., a first line set including scan lines 1206a and 1206b, and a second line set including scan lines 1208a and 1208b). However, the laser system 112 can be controlled to direct the laser pulses only at times during scanning processes when resultant spot areas will be generated at locations on the article 100 at least substantially corresponding to the desired mark location. Thus, the laser system 112 is controllable to direct laser pulses onto the article 100 to generate spot areas (e.g., indicated as solid-lined circles, such as spot area 1210a) within or sufficiently near to the desired mark location and not to direct laser pulses onto the article 100 at locations that would generate spot areas (e.g., indicated as dash-lined circles, such as spot area 1210b) outside the desired mark location.

Although FIG. 12 illustrates the arrangement 1200 of spot areas as being provided in the manner described above with respect to FIG. 11, it will be appreciated that the arrangement 1200 of spot areas be provided in any suitable or desired manner (e.g., as described with respect to FIG. 9 or 10, or any other arrangement). Similarly, although FIG. 12 illustrates each composite scan line 1204a, 1204b, 1204c and 1204d having an arrangement of spot areas as exemplarily described with respect to FIG. 11, it will be appreciated that any composite scan line 1204a, 1204b, 1204c or 1204d can have any arrangement of spot areas as exemplarily described above with respect to FIG. 9 or 10, or any other suitable or desired arrangement. Although FIG. 12 illustrates the arrangement 1200 of spot areas as having at least substantially a 6-fold rotational symmetry, it will be appreciated that the rotational symmetry of the arrangement 1200 can be of any order, n, where n is 2, 3, 4, 5, 6, 7, 8, or the like. Although FIG. 12 illustrates the arrangement 1200 of spot areas as being uniform throughout the area of the mark, it will be appreciated that the arrangement 1200 of spot areas may vary throughout the area of the mark.

Having described exemplarily numerous embodiments of marking processes that may be performed to generate the mark 200 on the article 100, exemplary embodiments of the laser system 112 shown in FIG. 1, capable of performing embodiments of these marking processes, will now be described with reference to FIGS. 13 to 17.

FIG. 13 is simplified and partly schematic perspective view of some components of an exemplary laser micromachining system 1300 suitable for laser modification of an article 100 such as by making the mark 200 with the laser 1302. With reference to FIG. 13, some exemplary laser processing systems operable for marking spots areas 302 on or beneath a surface 108 of the article 100 are the ESI MM5330 micromachining system, the ESI ML5900 micromachining system and the ESI 5970 micromachining system, all manufactured by Electro Scientific Industries, Inc., Portland, Oreg. 97229.

These systems typically employ a solid-state diode-pumped laser, which can be configured to emit wavelengths from about 343 nm (UV) to about 1320 nm (IR) at pulse repetition rates up to 5 MHz. However, these systems may be adapted by the substitution or addition of appropriate laser, laser optics, parts handling equipment, and control software to reliably and repeatably produce the selected spot areas 302 on or within the articles 100 as previously described. (For example, fiber lasers, CO₂ laser, copper vapor lasers, or other types of lasers could be employed.) These modifications permit the laser processing system to direct laser pulses with the appropriate laser parameters to the desired locations on an appropriately positioned and held workpiece, such as article 100, at the desired rate and pitch between laser spots or pulses to create the desired spot area 302 with desired color, contrast, and/or optical density.

In some embodiments, the laser micromachining system 1300 employs a diode-pumped Nd:YVO4 solid-state laser 1302 operating at 1064 nm wavelength, such as a model Rapid manufactured by Lumera Laser GmbH (Coherent), Kaiserslautern, Germany. This laser can be optionally frequency doubled using a solid-state harmonic frequency generator to reduce the wavelength to 532 nm thereby creating visible (green) laser pulses, or tripled to about 355 nm or quadrupled to 266 nm thereby creating ultraviolet (UV) laser pulses. This laser 1302 is rated to produce 6 Watts of continuous power and has a maximum pulse repetition rate of 1000 KHz. This laser 1302 produces laser pulses with duration of about 10 ps in cooperation with controller 1304. However, other lasers exhibiting pulsewidths froml picosecond to 1,000 nanoseconds could be employed.

The laser pulses may be Gaussian or specially shaped or tailored by the laser optics 1362, typically comprising one or more optical components positioned along an optical path 1360, to permit desired characteristics of the spot areas 302. For example, a “top hat” spatial profile may be used which delivers a laser pulse having an even dose of radiation over the entire spot area 302 that impinges the article 100. Specially shaped spatial profiles such as this may be created using diffractive optical elements or other beam-shaping components. A detailed description of modifying the spatial irradiance profile of laser spot areas 302 can be found in U.S. Pat. No. 6,433,301 of Corey Dunsky et al., which is assigned to the assignee of this application, and which is incorporated herein by reference.

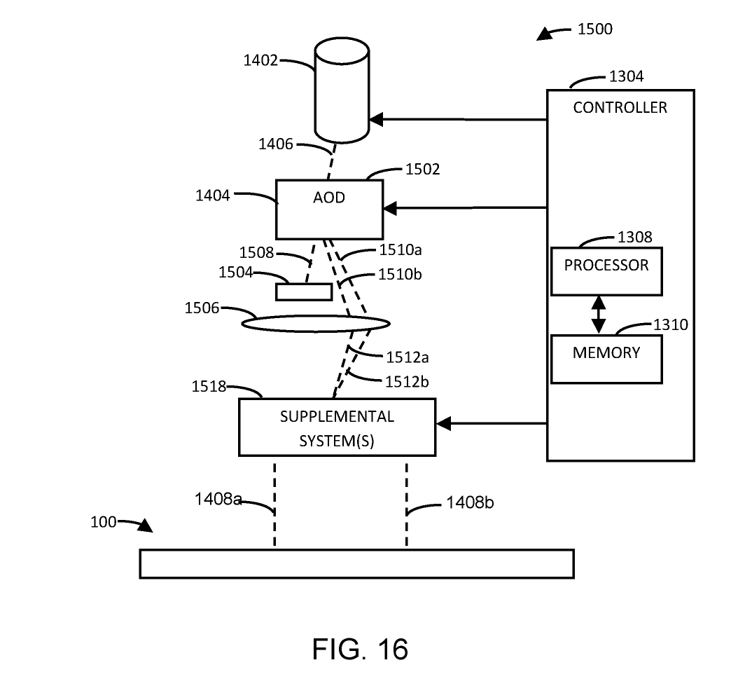

The laser pulses are propagated along an optical path 1360 that may also include a variety of supplemental systems 1518 (FIG. 16), such as fold mirrors 1364, attenuators or pulse pickers (such as acousto-optic or electro-optic devices) 1366, and feedback sensors (such as for energy, timing, or position) 1368.

The laser optics 1362 and other components along the optical path 1360, in cooperation with a laser beam-positioning system 1370 directed by the controller 1304, direct a beam axis 1372 of the laser pulse propagating along the optical path 1360 to form a laser focal spot at a desired elevation with respect to the surface 108 of the article 100 at a laser spot position of the beam axis 1372. The laser beam-positioning system 1370 may include a laser stage 1382 that is operable to move the laser 1302 along an axis of travel, such as the X-axis, and a fast-positioner stage 1384 to move a fast positioner (not shown) along an axis of travel, such as the Z-axis. A typical fast positioner employs a pair of galvanometer-controlled mirrors capable of quickly changing the direction of the beam axis 1372 over a large field on the article 100. Such field is typically smaller than the field of movement provided by the article support 116, as later described. An acousto-optic device or a deformable mirror may also be used as the fast positioner, even though these devices tend to have smaller beam deflection ranges than galvanometer mirrors. Alternatively, an acousto-optic device or a deformable mirror may be used as a high-speed positioning device in addition to galvanometer mirrors.

It will be appreciated that each beamlet may have its own particular beam axis with respect to the article 100 that may be individually positioned or blocked; however, it will be appreciated that the term “beam axis” may be used for convenience to generally and/or collectively represent the beam axes of the individual beamlets. In many embodiments, the beamlets are collectively scanned as a group.

Additionally, the article 100 may be supported by an article support 116 having motion control elements operable to position the article 100 with respect to the beam axis 1372. The article support 116 may be operable to travel along a single axis, such as the Y-axis, or article support 116 may be operable to travel along transverse axes, such as the X- and Y-axes. Alternatively, the article support 116 may be operable to rotate the article 100, such as about a Z-axis (solely, or as well as move the article along the X- and Y-axes).

The controller 1304 can coordinate operation of the laser beam-positioning system 1370 and the article support 116 to provide compound beam-positioning capability, which facilitates the capability to mark spot areas 302 on or within the article 100 while the article 100 can be in continuous relative motion to the beam axis 1372. This capability is not necessary for marking the spot areas 302 on the article, but this capability may be desirable for increased throughput. This capability is described in U.S. Pat. No. 5,751,585 of Donald R. Cutler et al., which is assigned to the assignee of this application, and which is incorporated herein by reference. Additional or alternative methods of beam positioning can be employed. Some additional or alternative methods of beam positioning are described in U.S. Pat. No. 6,706,999 of Spencer Barrett et al. and U.S. Pat. No. 7,019,891 of Jay Johnson, both of which are assigned to the assignee of this application, and which are incorporated herein by reference.

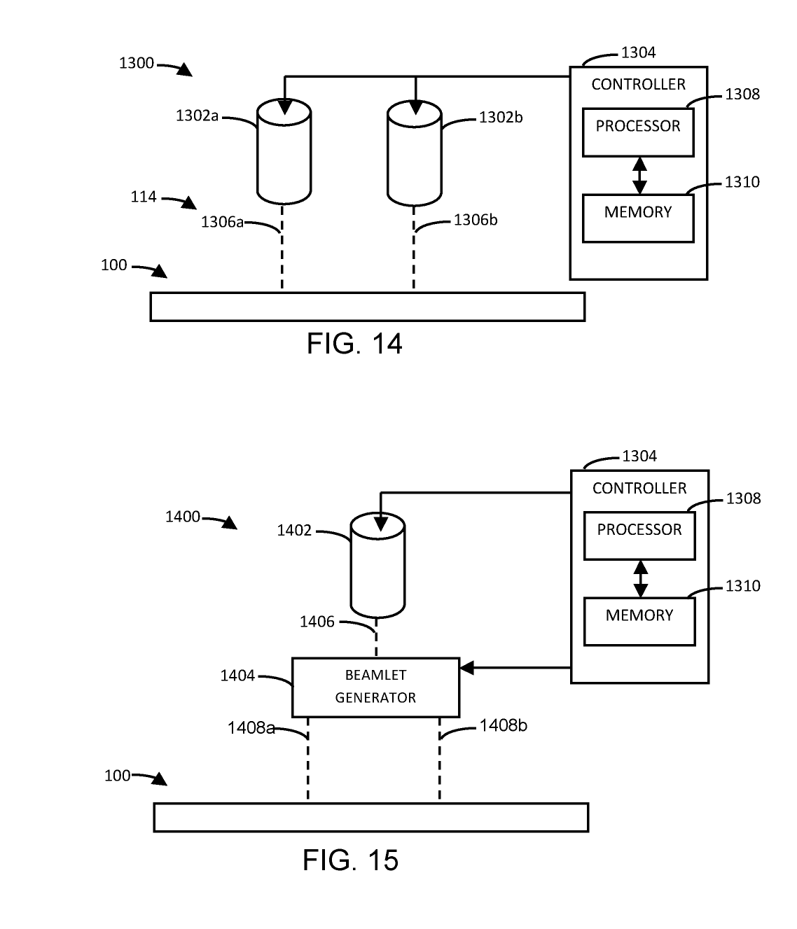

Referring to FIG. 14, the laser system 112 may be provided as a laser system 1300 that includes two laser sources such as first laser source 1300a and second laser source 1300b and a controller 1304. Although not illustrated, the laser system 1300 may further include supplemental systems such as the aforementioned beam modification system, beam steering system, or the like, or a combination thereof.

Generally, the first laser source 1302a is operative to generate a beam (e.g., as indicated by dashed line 1306a) of laser pulses. Similarly, the second laser source 1302b is operative to generate a beam (e.g., as indicated by dashed line 1306b) of laser pulses. Laser pulses within the beam 1306a can be shaped, expanded, focused, scanned, etc., by the aforementioned supplemental systems as desired to be subsequently directed to impinge upon the article 100. Similarly, laser pulses within the beam 1306b can be shaped, expanded, focused, scanned, etc., by the aforementioned supplemental systems as desired to be subsequently directed to impinge upon the article 100. Laser pulses with the beams 1306a and 1306b can be shaped, expanded, focused, scanned, etc., by common supplemental systems or by different sets of supplemental systems. Although the laser system 1300 is illustrated as including only two laser sources, it will be appreciated that the laser system 1300 may include three or more laser sources (or two or more lasers).

The controller 1306 may control the laser sources 1300a and 1300b and any desired supplemental systems to sequentially direct groups of laser pulses onto the article 100 such that in some embodiments at least two laser pulses within a group impinge upon the article 100 (e.g., simultaneously or sequentially) at spot areas as exemplarily discussed above. For example, a laser pulse within beam 1306a may impinge the article 100 to generate a spot area on the article corresponding to spot area 302a shown in FIG. 3. Likewise, a laser pulse within beam 1306b may impinge the article 100 to generate a spot area on the article corresponding to spot area 302b shown in FIG. 3.

As shown, the controller 1304 may include a processor 1308 communicatively coupled to memory 1310. Generally, the processor 1308 can include operating logic (not shown) that defines various control functions, and may be in the form of dedicated hardware, such as a hardwired state machine, a processor executing programming instructions, and/or a different form as would occur to those skilled in the art. Operating logic may include digital circuitry, analog circuitry, software, or a hybrid combination of any of these types. In one embodiment, processor 1308 includes a programmable microcontroller microprocessor, or other processor that can include one or more processing units arranged to execute instructions stored in memory 1310 in accordance with the operating logic. Memory 910 can include one or more types including semiconductor, magnetic, and/or optical varieties, and/or may be of a volatile and/or nonvolatile variety. In one embodiment, memory 1310 stores instructions that can be executed by the operating logic. Alternatively or additionally, memory 1310 may store data that is manipulated by the operating logic. In one arrangement, operating logic and memory are included in a controller/processor form of operating logic that manages and controls operational aspects of any component of the apparatus described with respect to FIG. 1, although in other arrangements they may be separate.

Referring to FIG. 15, the laser system 112 may be provided as laser system 1000 including a laser source 1402, a beamlet generator 1404, and the aforementioned controller 1304. Although not illustrated, the laser system 1400 may further include supplemental systems such as the aforementioned beam modification system, beam steering system, or the like, or a combination thereof.

As with the laser system 1300, the laser source 1402 in the laser system 1400 is operative to generate a beam (e.g., as indicated by dashed line 1406) of laser pulses. The beamlet generator 1404 is configured to receive the beam 1406 of laser pulses and generate corresponding beamlets (e.g., as indicated by dashed lines 1408a and 1408b) of laser pulses. In one embodiment, the beamlets 1408a and 1408b are generated from the beam 1404 by, for example, temporally modulating the beam 1406, by spatially modulating the beam 1406, or the like, or a combination thereof. Such modulation of the beam 1406 can be effected by diffracting at least a portion of the beam 1406, reflecting at least a portion of the beam 1406, refracting at least a portion of the beam 1406, or the like, or a combination thereof. Accordingly, the beamlet generator 1404 may include a temporal modulation element such as a mirror (e.g., a spindle mirror, a micro-electromechanical system (MEMS) mirror, etc.), an acousto-optic deflector (AOD), an electro-optic deflector (EOD), or the like or a combination thereof, or a spatial modulation element such as a diffractive optical element (DOE), a refractive optical element such as a multi-lens array, or the like or a combination thereof. It will be appreciated, however, that the beamlet generator 1404 may include any combination of modulation elements. Modulation elements can also be classified as passive modulation elements (e.g., as with the DOE, diffraction grating, etc.) or as active modulation elements (e.g., as with the spindle mirror, the AOD, the EOD, etc.). Active modulation elements may be driven under the control of the controller 1304 to modulate the beam 1406 whereas passive modulation elements need not be driven by the controller 1304 to effect modulation of the beam 1406.

The beamlets 1408a and 1408b of the laser pulses can be shaped, expanded, focused, scanned, etc., by the aforementioned supplemental systems as desired to be subsequently directed to impinge upon the article 100. The beamlets 1408a and 1408b of the laser pulses can be shaped, expanded, focused, scanned, etc., by the same supplemental systems or by different sets of supplemental systems. Although the beamlet generator 1004 is illustrated as being configured to generate two beamlets 1408a and 1408b, it will be appreciated that the beamlet generator 1404 laser system 1400 may be configured as desired to generate more than two beamlets. (A beamlet generator 1404 will typically be employed to create a beamlet group of three or more beamlets).

Depending on the configuration of the beamlet generator 1404, the controller 1304 may control one or both of the laser source 1402 and the beamlet generator 1404, and any desired supplemental systems, to sequentially direct groups of laser pulses onto the article 100 such that at least two laser pulses within a group impinge upon the article 100 (e.g., simultaneously or sequentially) at spot areas as exemplarily discussed above. For example, a laser pulse with beamlet 1408a may impinge the article 100 to generate a spot area on the article 100 corresponding to spot area 302a shown in FIG. 3. Likewise, a laser pulse with beamlet 1408b may impinge the article 100 to generate a spot area on the article 100 corresponding to spot area 302b shown in FIG. 3.

In embodiments in which the beam 1406 is modulated at the beamlet generator 1404 by a spatial modulation element such as a DOE, the controller 1304 may simply control the laser source 1402 and any desired supplemental systems such that at least two laser pulses within a group impinge upon the article 100 simultaneously (or substantially simultaneously) at spot areas as exemplarily discussed above. In embodiments in which the beam 1406 is modulated at the beamlet generator 1404 by a temporal modulation element, the controller 1304 may control the laser source 1402 and the beamlet generator 1404 in a coordinated manner, along with any desired supplemental systems, such that at least two laser pulses within a group (unless one or both are blocked) impinge upon the article 100 sequentially at spot areas as exemplarily discussed above.

Although the laser system 1400 has been illustrated as including only one laser source 1402 and only one beamlet generator 1404, it will be appreciated that the laser system 1400 may include any number of additional laser sources, any number of additional beamlet generators, or a combination thereof. In such embodiments, the beams of any number of laser sources may be modulated by the same beamlet generator 1404 or by different beamlet generators 1404. Multiple beamlet generators 1404 may be of the same type or of different types or different models. In another embodiment, the beams of any number of laser sources may not be modulated by any beamlet generator 1404.

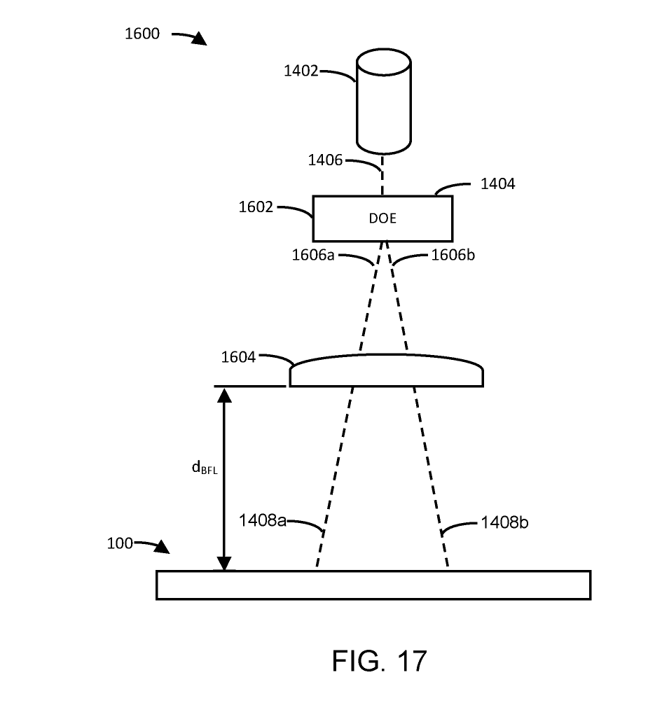

Having exemplarily described the beamlet generator 1404 in connection with the laser system 1400 shown in FIG. 15, some embodiments of the beamlet generator 1404 will now be described with reference to FIGS. 16 to 17.

With reference to FIG. 16, the laser system 1500 includes a beamlet generator 1404 that employs an active modulation element 1502 in cooperation with an optional beam mask 1504, an optional relay lens 1506, and one or more of the aforementioned supplemental systems (generically indicated at box 1518).

In the illustrated embodiment, the modulation element 1502 is provided as an AOD, and the beam mask 1504 is provided to optionally block (if desired) the zero order beam 1508 transmitted through the AOD 1502. It will nevertheless be appreciated that the modulation element 1502 can be provided as a spindle mirror, an EOD, or the like or a combination thereof.

The modulation element 1502 deflects (e.g., diffracts, in the illustrated embodiment, away from the zero order beam 1508) pulses within the beam 1006 at an angle corresponding to characteristics of the signal (e.g., RF frequency, in the illustrated embodiment) applied to the modulation element 1502 (e.g., from a signal source incorporated as part of the modulation element 1502, under control of the controller 1304). By coordinating the signal characteristics applied to the modulation element 1502 with the generation of laser pulses by the laser source 1402 and propagated within the beam 1406, the controller 1304 can selectively direct individual laser pulses within the beam 1406 along one of many deflected beam paths (e.g., along one of two first order deflected beam paths 1510a and 1510b (generically deflected beam paths 1510), in the illustrated embodiment). Although only two deflected beam paths 1510a and 1510b are illustrated, it will be appreciated that any number of deflected beam paths 1510 may be generated depending upon the characteristics of the modulation element 1502, characteristics of the signal applied to the modulation element 1502, the pulse repetition rate of laser pulses within the beam 1406, the average power of laser pulses in the beam 1406 (e.g., which can be in a range from 10 W to 400 W), or the like, or a combination thereof. Laser pulses transmitted along a deflected beam path 1510 can then be processed (e.g., focused by the relay lens 1506), if desired, and propagated further along corresponding paths (e.g., paths 1512a and 1512b), and then be shaped, expanded, focused, scanned, etc., by the aforementioned one or more supplemental systems as desired (e.g., as indicated at box 1518).

Although not illustrated, the beamlet generator 1404 of the laser system 1500 may further employ one or more additional modulation elements such as an additional active modulation element 1502, a passive modulation element 1602 (FIG. 17), or the like, or a combination thereof, configured to further modulate pulses within one or more of the paths 1510a, 1510b, 1512a, 1512b, or the like, or a combination thereof. These further-modulated pulses may then be shaped, expanded, focused, scanned, etc., by the aforementioned one or more supplemental systems as desired (e.g., as indicated at box 1518).

With reference to FIG. 17, the laser system 1600 includes a beamlet generator 1404 that employs a passive modulation element 1602 (e.g., a DOE) in cooperation with an optional focusing lens 1604. The modulation element 1602 splits each pulse within the beam 1406 into a group of pulses that are propagated along one of a corresponding number of diffracted beam paths (e.g., diffracted beam paths 1606a and 1606b). Although only two diffracted beam paths 1606a and 1606b are illustrated, it will be appreciated that any number of diffracted beam paths may be generated depending upon the characteristics of the modulation element 1602, the average power of the pulses in the beam 1406 (e.g., which can be in a range from 10 W to 400 W), or the like, or a combination thereof. Laser pulses transmitted along the diffracted beam paths 1606a and 1606b can then be processed (e.g., shaped, expanded, scanned, etc.) by one or more of the aforementioned supplemental systems (not shown) as desired before or after having been focused by the focusing lens 1604. In the illustrated embodiment, the spot separation distance, a1, between adjacent spot areas on the article 100 can be adjusted by changing the distance, d_{BFL}, between the focusing lens 1604 and the article 100.

Although not illustrated, the beamlet generator 1404 of the laser system 1600 may further employ one or more additional modulation elements such as active modulation element 1502, passive modulation element 1602, or the like, or a combination thereof, configured to further modulate pulses within one or more of the diffracted beam paths (e.g., one or both of diffracted beam paths 1606a, 1602b). These further-modulated pulses may be directed into the focusing lens 1604, focused, and subsequently directed onto the article 100. Additionally, or alternatively, one or more of the additional modulation elements can be provided to further modulate pulses within one or more of the beamlets (e.g., beamlets 1408a and 1408b).

As exemplarily described above, the beamlets (e.g., beamlets 1408a and 1408b) generated by the beamlet generator 1404 are derived from laser pulses within the beam 1406 generated by the laser source 1402. However, one or more characteristics (e.g., average power, peak power, spot shape, spot size, etc.) of a laser pulse within one beamlet may be different from one or more corresponding characteristics of a laser pulse within another beamlet. This difference in laser pulse characteristics can be attributable to the modulation characteristics of the modulation element (e.g., an AOD, an EOD, etc.) within the beamlet generator 1404. As a result of these differences, laser characteristics within one beamlet may modify the preliminary visual appearance of the article 100 at a corresponding spot area in a slightly different manner from laser characteristics within another beamlet.

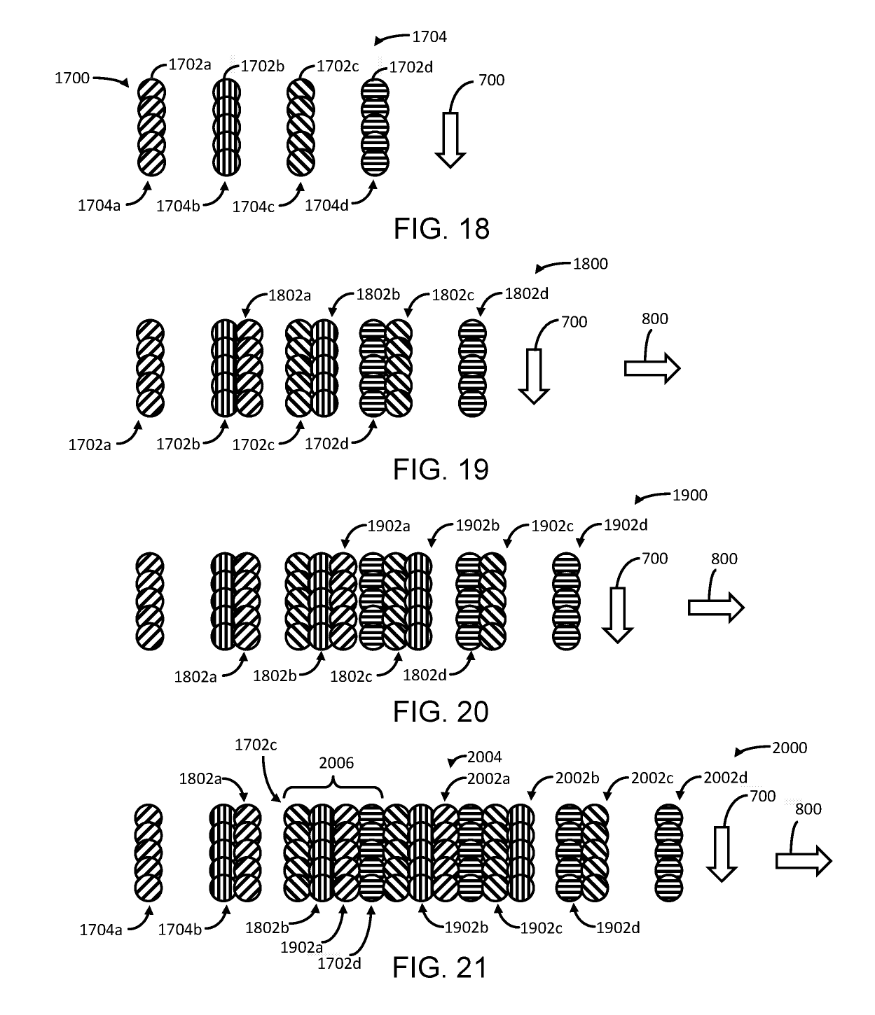

For example, and with reference to FIG. 18, the beamlet generator 1404 can direct four beamlets of a laser pulse onto the article 100, such that the beamlet group of four laser pulse portions impinge upon the article 100 to generate a spot set 1700 including spot areas 1702a, 1702b, 1702c, and 1702d on the article 100. If laser pulse portions within two or more or all of the beamlets have different characteristics, then the modified visual appearance of the article 100 at one spot area (e.g., spot area 1702a) may be different from the modified visual appearance of the article 100 at one or more or all of spot areas 1702b, 1702c, and 1702d.

In some embodiments, each spot area may be sufficiently small enough such that any differences between the modified visual appearances among the spot areas in the spot set 1700 are not significant. For example, each spot area may be sufficiently small enough such that any differences between the modified visual appearances among the spot areas in the spot set 1700 are not distinguishable by a human eye at a distance greater than or equal to 25 mm from the human eye.

Furthermore, the spot width of each spot area may be sufficiently small enough such that, after performing a scanning process to form a line set 1704 (e.g., including a scan line 1704a formed of spot areas 1702a, a scan line 1704b formed of spot areas 1702b, a scan line 1704c formed of spot areas 1702c and a scan line 1704d formed of spot areas 1702d, the differences between the modified visual appearances among the scan lines in the line set 1704 are not significant. For example, each spot area may be sufficiently small enough such that any differences between the modified visual appearances among the scan lines in the line sets 1704 are not distinguishable by a functioning human eye (of average capability) at a distance greater than or equal to 25 mm from the human eye.

However, if the aforementioned scanning process is repeated in the manner described above respect to FIGS. 8 and 9, then the resultant composite scan lines will effectively include a scan line region including only scan lines formed of spot areas 1702a generated by laser pulses from only one beamlet, a scan line region including only scan lines formed of spot areas 1702b generated by laser pulses from only one beamlet, a scan line region including only scan lines formed of spot areas 1702c generated by laser pulses from only one beamlet, and a scan line region including only scan lines formed of spot areas 1702d generated by laser pulses from only one beamlet. Depending on factors such as the differences in modified visual appearance provided by spot areas 1702a, 1702b, 1702c and 1702d, the spot separation distance, a1, between spot areas within a spot set, the scan pitch between spot areas within the mark 200, the line pitch between scan lines within the mark 200, and the like, the differences between the modified visual appearances among the various scan line regions of the composite scan line can be significant.

In one embodiment, the aforementioned differences between the modified visual appearances among the various scan line regions of the composite scan line can be undesirable. Accordingly, and with reference to FIGS. 19 to 21, a marking process according to yet another embodiment can be implemented to eliminate or otherwise reduce the undesirable effects associated with forming a composite scan line having one or more scan line regions including only scan lines formed of spot areas generated by laser pulses within only one beamlet.

With reference to FIG. 19, after a first line set (e.g., the aforementioned line set 1704) is formed, the laser system 112 may be actuated and/or the article support 116 may be moved (e.g., in the manner described above with respect to FIG. 8) to form a second line set 1800 offset from the previously-formed first line set 1704 by an amount greater than or equal to aforementioned the line pitch. In some embodiments, the second line set 1800 is offset from the previously-formed first line set 1704 by an amount at least substantially equal to the aforementioned line set pitch plus one line pitch, as shown in FIG. 19. In some such embodiments, the first column of spot areas 1702a may be blocked by an aperture, as later described.

In one embodiment, the second line set 1800 can include a scan line 1802a formed of the spot areas 1702a, a scan line 1804b formed of the spot areas 1702b, a scan line 1802c formed of the spot areas 1702c and a scan line 1802d formed of the spot areas 1702d. Moreover, the second line set 1800 is offset from the first line set 1704 such that scan lines 1802a, 1802b and 1802c are offset from the scan lines 1704b, 1704c, and 1704d, respectively, by the aforementioned line pitch.

Thereafter, and with reference to FIG. 20, the aforementioned scanning process may be repeated to form a third line set 1900 offset from the second line set 1800 by an amount greater than aforementioned the line pitch (e.g., by an amount at least substantially equal to the aforementioned line set pitch plus one line pitch). As illustrated, the third line set 1900 includes a scan line 1902a formed of the spot areas 1702a, a scan line 1904b formed of the spot areas 1702b, a scan line 1904c formed of the spot areas 1702c and a scan line 1904d formed of the spot areas 1702d. The third line set 1900 is offset from the second line set 1800 such that scan lines 1902a, 1902b and 1902c are offset from the scan lines 1802b, 1802c, and 1802d, respectively, by the aforementioned line pitch.

Subsequently, and with reference to FIG. 21, the scanning process is repeated to form a fourth line set 2000 offset from the third line set 1900 by an amount greater than aforementioned the line pitch (e.g., by an amount at least substantially equal to the aforementioned line set pitch plus one line pitch). As illustrated, the fourth line set 2000 includes a scan line 2002a formed of the spot areas 1702a, a scan line 2004b formed of the spot areas 1702b, a scan line 2004c formed of the spot areas 1702c and a scan line 2004d formed of the spot areas 1702d. The fourth line set 2000 is offset from the third line set 1900 such that scan lines 2002a, 2002b and 2002c are offset from the scan lines 1902b, 1902c, and 1902d, respectively, by the aforementioned line pitch. As further shown in FIG. 20, scan lines 2002a, 2002b and 2002c are offset from the scan line 1702d of the first line set 1704 by the aforementioned line pitch. The process described above may be repeated as desired until the mark is formed as desired. It will be appreciated that the line set pitch may be selected to be a number based on the laser beam and optical characteristics of the laser system and/or the dimension of the mark or the material characteristics of the substrate. The number of line sets employed to fill the mark or modified area between the scan lines may be a whole number dividend of the line set pitch. These line sets may be nonoverlapping and adjacent, or they may be spaced apart. Alternately, the line sets may be overlapping, and the number of line sets employed to fill the mark or modified area between the scan lines need not be a whole number dividend of the line set pitch

In the marking process described above with respect to FIGS. 18 to 21, line sets are repeatedly generated to be offset from previously-formed line sets in the fill direction (e.g., along the direction indicated by arrow 800). As a result, certain scan lines (also referred to as “stray lines”) generated during the marking process may not be included in a composite scan line based on when they were generated during the marking process. For example, stray lines such as scan lines 1704a, 1704b and 1802a will not be included within the composite scan line 2004. Furthermore, if no additional line sets are generated after generating line set 2000, then scan lines 1902d, 2002c and 2002d will also not be included in the composite scan line 2004 and would be stray lines. In embodiments in which the stray lines would modify the preliminary visual appearance of the article 100 in such a manner as to degrade the appearance of the mark 200, the laser system 112 may be controlled to not direct laser pulses onto the article 100 at locations on the article 100 that would generate the stray lines.

Similar to the marking process described above with respect to FIGS. 7 to 9, the marking process described above with respect to FIGS. 18 to 21 produces a composite scan line formed of scan lines from the first line set 1704, the second line set 1800, the third line set 1900 and the fourth line set 2000. According to the illustrated embodiment, however, scan line regions within the composite scan line 2004 include scan lines formed of spot areas 1702a, 1702b, 1702c and 1702d. For example, the composite scan line 2004 includes a scan line region 2006 formed of scan lines 1702c, 1802b, 1902a and 1702d, which are formed of spot areas 1702c, 1702d, 1702a and 1702b, respectively. Although not labeled, the composite scan line 2004 also includes an adjacent scan line region formed of scan lines 1802c, 1902b, 2002a and 1802d, which are formed of spot areas 1702c, 1702d, 1702a and 1702b, respectively. Because each scan line region includes scan lines formed of formed of spot areas generated by laser pulses within different beamlets (e.g., some or all beamlets capable of being generated by the beamlet generator 1404) the deleterious effects of undesirable differences between the modified visual appearances among the various scan line regions of the composite scan line can be eliminated or beneficially reduced.

In some embodiments, straight-edged spot sets, such as spot set 600, can be employed. Straight-edged spot sets can be defined as spots sets having leading and trailing spatial edges that are generally perpendicular with respect to a reference plane. Typically, the spot areas of such spot sets may be arranged in rows and columns, and typically, the leading and trailing edges of such spot sets are perpendicular to a vector of the fill direction (or perpendicular to the primary relative direction of travel of the beam axis 1372 with respect to the article 100).

It will be appreciated that the terms “leading edge” and “trailing edge” may be relative to a scan direction of relative movement between the beam axis 1372 and the article 100. For example, “leading edge” and “trailing edge” may be the outside edges relative to the scan direction, with the trailing edge designating a starting position and the leading edge designating the ending position (or temporary or transient ending position). Although the beam axis 1372 can be scanned in any direction relative to the article, the scan direction will typically discussed in terms of relative travel from left to right unless otherwise specified, for convenience. It will also be appreciated that a spot set, a beamlet group, a scan line (of a row of scan spots such as from one beamlet of the group), a line set (of a scanned beamlet group, forming multiple scan lines), an edge or edge profile of a laser modification can all be discussed in terms of a leading edge and/or a trailing edge.

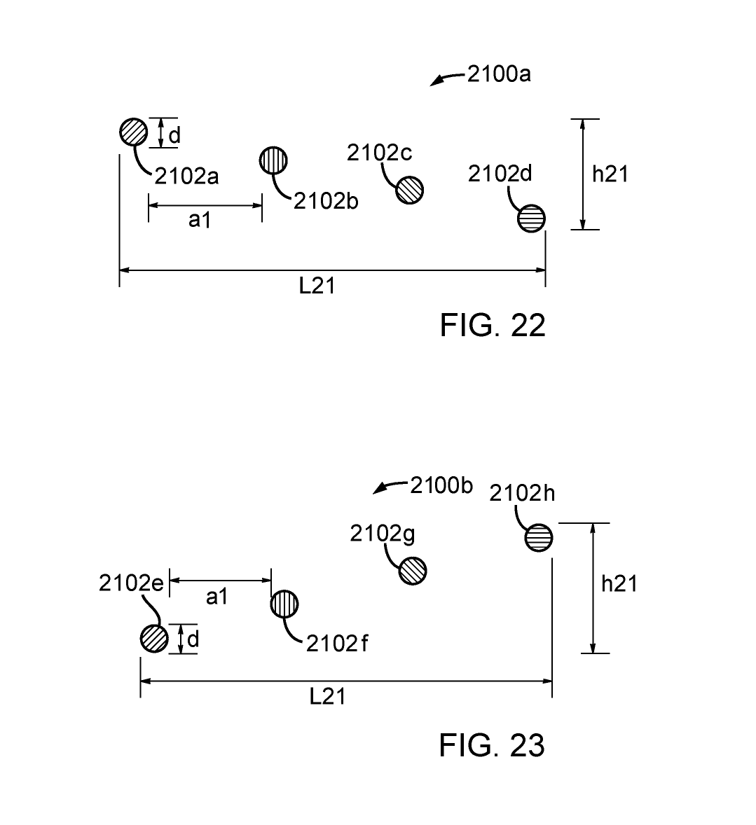

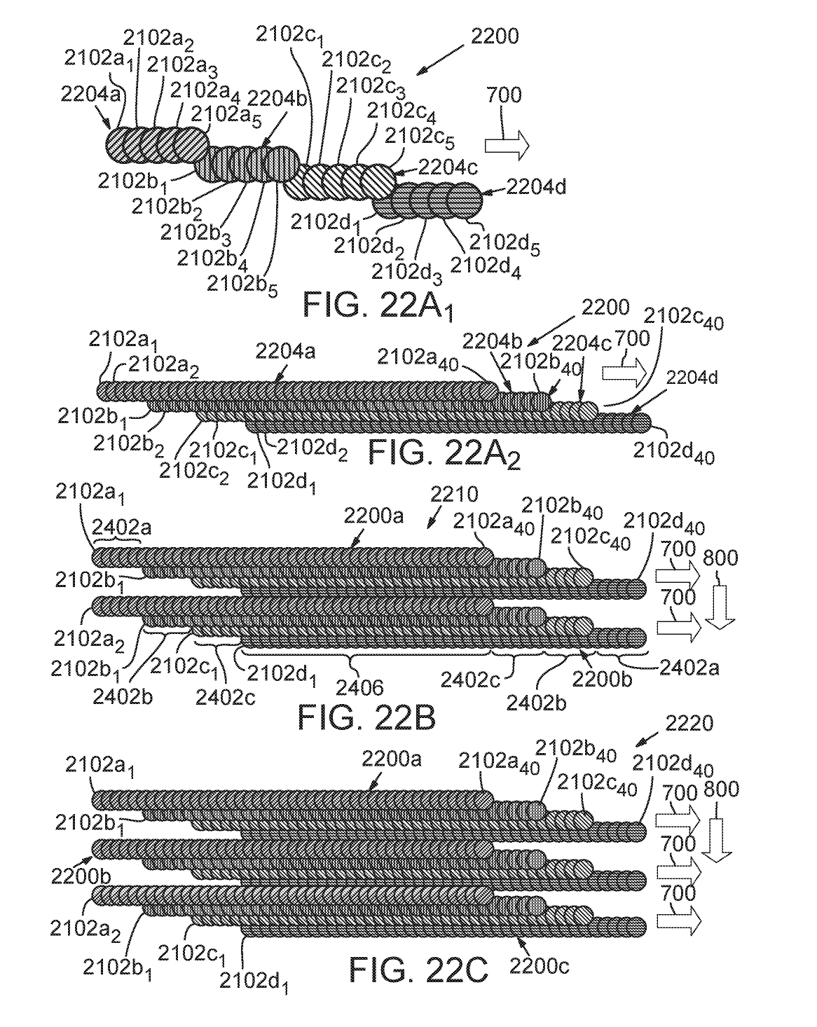

FIG. 22 schematically illustrates another embodiment of a spot set 2100a of spot areas 2102 that may be generated on an article 100 when laser pulses from a group of laser pulses impinge upon the article 100 during a laser modification process. For example, a group of laser pulses can include four laser pulses that impinge the article 100 to generate a spot set such as spot set 2100a having a first spot area 2102a, a second spot area 2102b, a third spot area 2102c, and a fourth spot area 2102d spatially arranged in a substantially diagonal pattern as shown in FIG. 22. The spot set 2100a can occupy a group height or pattern height, h21, and a group length or pattern length, L21. The group height is the cumulative height achieved or traveled by the spot set 2100 (in a single impingement by the spot set 2100), including the space between the spot areas 2102a, 2102b, 2102c, and 2102d. The group length is the total distance achieved or traveled by the spot set 2100 (in a single impingement by the spot set 2100), including the space between the spot areas 2102a, 2102b, 2102c, and 2102d. In the example depicted in FIG. 22, h21 is about equal to 4(d); and, L21 is about equal to 4(a1)+4(d).

In some embodiments, askew-edged spot sets, such as spot sets 500 or 2100a, can be employed. An askew-edged spot set can be defined as any spot set having a leading edge and/or a trailing edge that is non-perpendicular to a reference plane (or having a leading edge and/or a trailing edge that is non-perpendicular to the primary relative scan direction of travel of the beam axis 1372 when the spot set is scanned or brushed relative to the article 100). Moreover, in some embodiments, the group height h and the group length L are each greater than the spot size and have axes that are each perpendicular to each other. So, in some embodiments, an askew-edged spot set can additionally or alternatively be defined as any spot set in which a first spot area at the leading edge and/or the trailing edge has a nearest neighboring spot area that is displaced in both height and length from the first spot area (displaced along both the height and length axes).

FIG. 22A₁ is a plan view of an exemplary line set 2200 formed by scanning five iterations of the group of pulses similar to the spot set 2100a of FIG. 22 relative to the article 100, and FIG. 22A₂ is a plan view of an exemplary line set 2200 formed by scanning forty iterations of the group of pulses similar to the spot set 2100a of FIG. 22 relative to the article 100. With reference to FIG. 22A₁ and FIG. 22A₂, the line set 2200 includes a scan line 2204a formed of spot areas 2102a (e.g., spot areas 2102a₁, 2102a₂, 2102a₃, 2102a₄, and 2102a₅; or spot areas 2102a₁-2102a₄₀), a scan line 2204b formed of spot areas 2102b (e.g., spot areas 2102b₁, 2102b₂, 2102b₃, 2102b₄, and 2102b₅; or spot areas 2102b₁-2102b₄₀), a scan line 2204c formed of spot areas 2102c (e.g., spot areas 2102c₁, 2102c₂, 2102c₃, 2102c₄, and 2102c₅; or spot areas 2102c₁-2102c₄₀), and a scan line 2204d formed of spot areas 2102d (e.g., spot areas 2102d₁, 2102d₂, 2102d₃, 2102d₄, and 2102d₅; or spot areas 2102d₁-2102d₄₀).

FIG. 22B is a plan view showing a laser modification 2210 in which a second line set 2200b offset from the first line set 2200a in the offset direction 800. In the exemplary embodiment shown in FIG. 22B, the second line set is offset from the 2204d by the line set pitch of the scan lines 2204a-2204d, or more generally the second line set 2200b can be indexed from the first line set 2200a by the height of the spot set plus the line set pitch. These line sets 2200a and 2200b can be sequentially formed, or they can be formed substantially simultaneously with a system adapted for duplicative propagation of beamlet groups. FIG. 22C is a plan view showing a laser modification 2220 in which a third line set 2200c offset from the second line set 2200b in the offset direction 800.

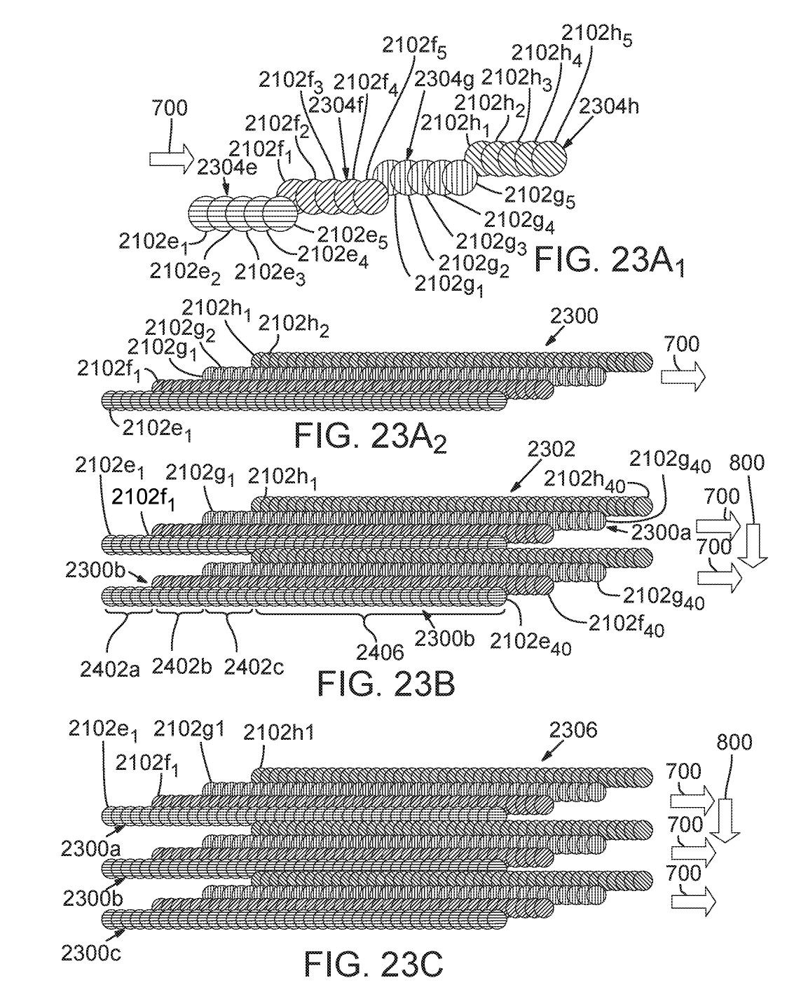

FIG. 23 schematically illustrates another embodiment of a spot set 2100b of spot areas 2102 that may be generated on an article 100 when laser pulses within a group of laser pulses impinge upon the article 100 during a laser modification process. The spot set 2100b has some similar characteristics with the spot set 2100a except that the substantially diagonal pattern exhibits a slope in an opposite direction to that of spot set 2100a. In particular, the group of laser pulses includes four laser pulses that impinge the article 100 to generate the spot set 2100b having a first spot area 2102e, a second spot area 2102f, a third spot area 2102g, and a fourth spot area 2102h spatially arranged in a substantially diagonal pattern as shown in FIG. 23.

FIG. 23A₁ is a plan view of an exemplary line set 2300 formed by scanning five iterations of the group of pulses similar to the spot set 2100b of FIG. 23 relative to the article 100, and FIG. 23A₂ is a plan view of an exemplary line set 2200 formed by scanning forty iterations of the group of pulses similar to the spot set 2100b of FIG. 23 relative to the article 100. With reference to FIG. 23A₁ and FIG. 23A₂, the line set 2300 includes a scan line 2304a formed of spot areas 2102e (e.g., spot areas 2102e₁, 2102e₂, 2102e₃, 2102e₄, and 2102e₅; or spot areas 2102e₁-2102e₄₀), a scan line 2304b formed of spot areas 2102f (e.g., spot areas 2102f₁, 2102f₂, 2102f₃, 2102f₄, and 2102f₅; or spot areas 2102f₁-2102f₄₀), a scan line 2304c formed of spot areas 2102g (e.g., spot areas 2102g₁, 2102g₂, 2102g₃, 2102g₄, and 2102g₅; or spot areas 2102g₁-2102g₄₀, and a scan line 2304h formed of spot areas 2102h (e.g., spot areas 2102h₁, 2102h₂, 2102h₃, 2102h₄, and 2102h₅; or spot areas 2102h₁-2102h₄₀).

FIG. 23B is a plan view showing a laser modification 2302 in which a second line set 2200b offset from the first line set 2200a in the offset direction 800. In the exemplary embodiment shown in FIG. 23B, the second line set 2200b is offset from the scan line 2204d by the line set pitch of the scan lines 2204a-2204d, or more generally the second line set 2200b can be indexed from the first line set 2200a by the height of the spot set plus the line set pitch. These line sets 2200a and 2200b can be sequentially formed, or they can be formed substantially simultaneously with a system adapted for duplicative propagation of beamlet groups. FIG. 23C is a plan view showing a laser modification 2306 in which a third line set 2200c offset from the second line set 2200b in the offset direction 800.

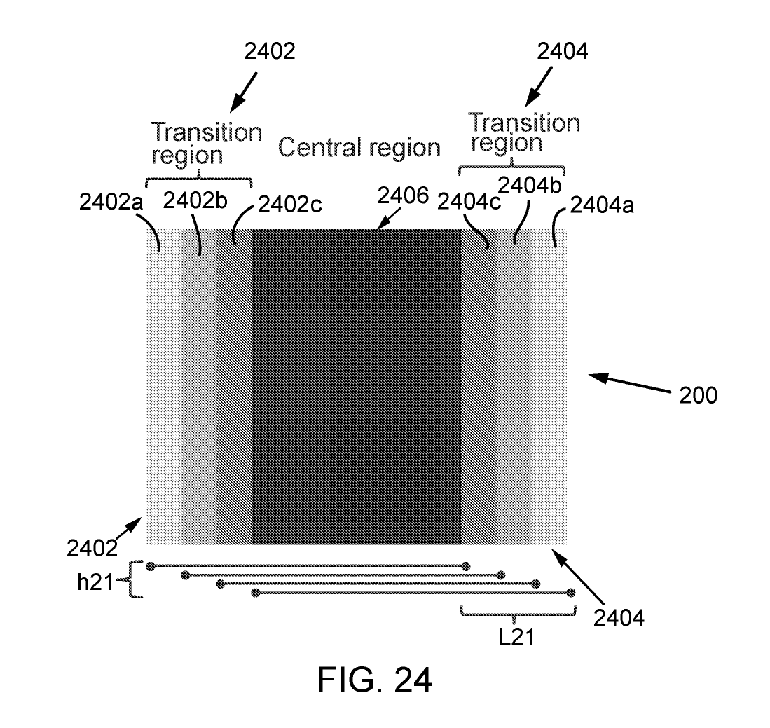

FIG. 24 is a plan view of an exemplary modification or mark 200 formed in a single pass on an article 100 with an askew-edged spot set of laser pulses, such as spot set 2100a of spot areas 2102, having an arrangement similar to that depicted in FIG. 22. With reference to FIGS. 22-24, the single pass of the laser pulses of the spot sets 2100a (or spot sets 2100b) as they are applied as the beam axis 1372 travels across the article 100 creates trailing transition regions 2402 and trailing transition regions 2404 that exhibit lower optical density than a central region 2406 of the mark 200.

As the beam axis 1372 travels from left to right, the spot area 2102a is applied to the trailing transition region 2402a, the spot area 2102b is applied to the trailing transition region 2402b, the spot area 2102c is applied to the trailing transition region 2402c, and the spot area 2102d is applied to the central region 2406. As the beam axis 1372 continues to travel from left to right, the spot area 2102a is applied to the trailing transition region 2402b, the spot area 2102b is applied to the trailing transition region 2402c, the spot area 2102c is applied to the central region 2406, and the spot area 2102d is applied to the central region 2406. As the beam axis 1372 continues to travel from left to right, the spot area 2102a is applied to the trailing transition region 2402c, the spot area 2102b is applied to the central 2406, the spot area 2102c is applied to the central region 2406, and the spot area 2102d is applied to the central region 2406. As the beam axis 1372 continues to travel from left to right, the spot area 2102a is applied to the central region 2406, the spot area 2102b is applied to the central 2406, the spot area 2102c is applied to the central region 2406, and the spot area 2102d is applied to the central region 2406.

As a result, the trailing transition region 2402a is impinged only by the spot area(s) 2102a; the trailing transition region 2402b is impinged only by the spot areas 2102a and 2102b; the trailing transition region 2402c is impinged only by the spot areas 2102a, 2102b, and 2102c; and the central region 2406 is impinged by the spot areas 2102a, 2102b, 2102c, and 2102d. FIG. 24 shows the gradation of optical density of the transition region 2402 due to the askew-edged pattern of the spot set 2100.

Similarly, as the beam axis 1372 continues to travels from left to right, the spot area 2102d is applied to the leading transition region 2404c, the spot area 2102c is applied to the central region 2406, the spot area 2102b is applied to the central region 2406, and the spot area 2102a is applied to the central region 2406. As the beam axis 1372 continues to travels from left to right, the spot area 2102d is applied to the leading transition region 2404b, the spot area 2102c is applied to leading transition region 2404c, the spot area 2102b is applied to the central region 2406, and the spot area 2102a is applied to the central region 2406. As the beam axis 1372 continues to travels from left to right, the spot area 2102d is applied to the leading transition region 2404a, the spot area 2102c is applied to the leading transition region 2404b, the spot area 2102b is applied to the leading transition region 2404c, and the spot area 2102a is applied to the central region 2406.

As a result, the leading transition region 2404a is impinged only by the spot area(s) 2102d; the leading transition region 2404b is impinged only by the spot areas 2102d and 2102c; and the leading transition region 2402c is impinged only by the spot areas 2102d, 2102c, and 2102b. Moreover, even if the line set 2200 were to be indexed one line pitch set between laser beam passes (e.g., in an attempt to apply spot sets 2102a to portions of the unmarked regions that would be between the neighboring line sets 2200a an 2200b), the mark 200 would exhibit disparity between the transition regions 2402 and 2404 and the central region 2406.

It will be appreciated that in order to enhance clarity, the figures at not to scale. In some examples of practical marking for commercial purposes, every surface sees some spots because the spot overlap is much larger than shown in the figures, i.e. the bite size between scanned spot sets is much smaller and the line set pitch between rows in the spot set is much smaller. (For example, in an exemplary process every area of the surface of article 100 in the transition region 2402a may be covered by about 7.5 lines scans of spot area 2102a.) So, the transition regions are due to fewer spots hitting that the transition areas rather than due to a complete absence of beamlet impingement in those areas.

In order to equalize the disparity in optical density, these transition regions 2402 and 2404 would typically need to be processed with one or more supplementary passes of the laser beam axis 1372 using a “touch-up” spot set having smaller dimensions in order to bring the optical density of the transition regions 2402 and 2404 to match the optical density of the central region 2406. In many circumstances, the touch-up process employs a single laser spot that may be applied to cover the transition regions 2402a, 2402b, 2402c, 2404a, 2404b, and 2404c with an appropriate number of extra passes so that the optical density is equal. This touch-up process adds considerable cycle time.

In particular, it will be appreciated that as the askew-edged spot sets become larger (or as the asymmetry between the length and height becomes larger) in a desire to process more area of the article 100 per time, the size of the transition regions 2402 and 2404 become larger. As the transition regions 2402 and 2404 become larger, the touch-up process can become a dominant effect for small patterns and large brush stroke lengths, employing more and more smaller groups of spots or single spots. For a given pattern size that is intended to be marked with large area spot sets, the supplementary touch-up process implies diminishing (or even negative) throughput returns due to the increasing single spot numbers, as more and more time is spent on marking or modifying the transition regions.

Furthermore, it will be appreciated that portions of marks 200 that have dimensions that are smaller than those of the spot set cannot be modified with such spot sets and would be processed or filled in with a smaller spot set or single spot process afterwards (or beforehand). The longer the dimension of the spot set, the more portions of the marks 200 will fall into such category, leading again to adding considerable cycle time and diminishing returns.

In particular, as the number of spots and the “brush size” of the spot set of the diffracted laser beam is increased, the portions of an intended mark 200 (and more particularly relative segments of beam axis movement, such as raster line movement) that are shorter than the length of the spot set may also increase. These undersized portions of the mark 200, as well as the transition regions 2402 and 2404, would also be processed or filled in with a smaller spot set or single spot process afterwards (or beforehand) to achieve the higher (better) resolution offered by the spot sets having smaller dimensions.

So, similarly, as the size of the spot sets is increased to modify more area per time to make large area laser modification commercially viable, the increase in spot set size may lead to diminishing (or even negative) throughput returns, as more and more time is spent on the supplemental processing the undersized portions of the mark or other feature that are shorter than the length of the spot set. It is also noted that as the spot sets are increased in size, the height as well as the length of the spot set may induce supplemental processing, increasing cycle time.

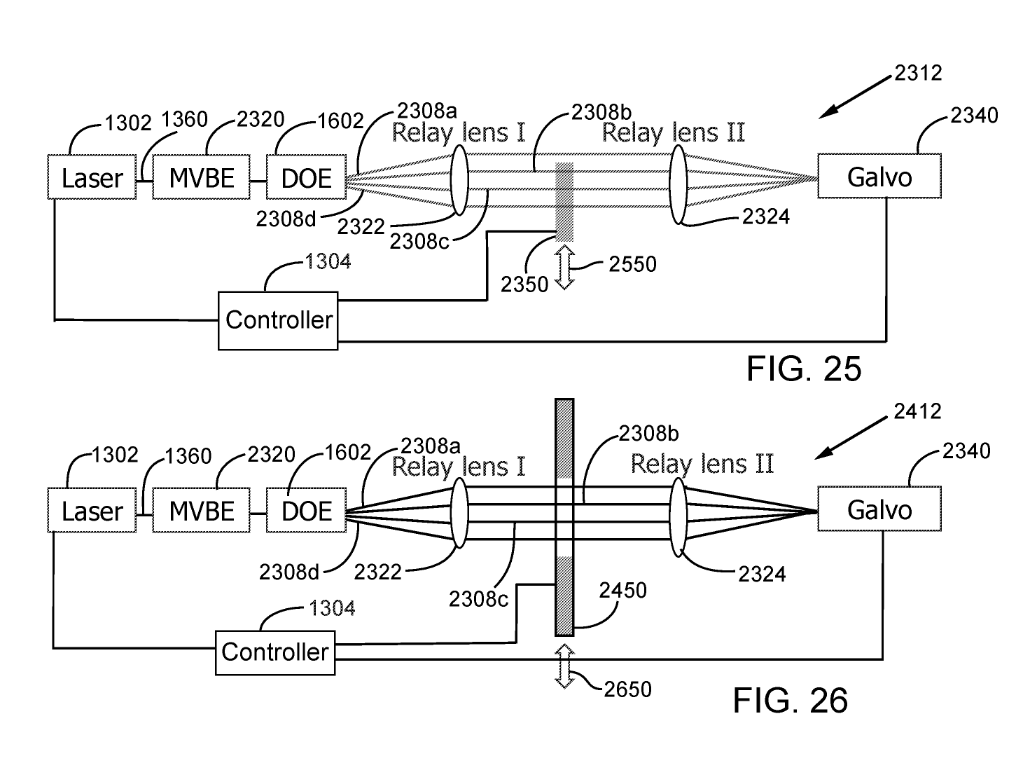

FIG. 25 is a schematic diagram of a laser system 2312 employed for making large modifications, such as marking large marks 200, on an article 100. The laser system 2312 includes a laser 1302 that emits a beam 1306 of laser pulses along an optical path 1360. The beam 1306 propagates along the optical path 1360 and through a variable beam expander 2320 (such as a manual variable beam expander or a variable zoom beam expander) and a beamlet generator 1404, such as a beam-shaping element (such as the diffractive optic element 1602), which diffracts the beam 1406 into a number of laser beamlets 2308, such as beamlets 2308a, 2308b, 2308c, and 2308d. The diffracted beam propagates through relay lenses 2322 and 2324 and onto a galvanometer mirror 2340 or other fast beam steering device. Optional components of supplemental systems 1518 then direct the beamlets 2308 to the article 100 to process the article 100, such as by laser modification to make a feature, such as a laser mark 200. It will be appreciated that the beamlets 2308 may be used to form any desirable size and shape of spot set, such as any spot set previously discussed, using an appropriate selection of the beam expander 1602, beamlet generator 1404, relay lenses 2322 and 2324, and supplemental systems 1518.

A beamlet selection device can be positioned to block one or more of the beamlets 2308. The beamlet selection device can be a fundamentally mechanical device, such as a variably positionable beam dump or beam blocker 2350, a MEMS, or a shutter array. The variably positionable beam blocker 2350 can be made of any suitable material, and preferably a material that absorbs laser radiation without adverse consequences. In some embodiments, the variably positionable beam blocker 2350 is absorbent to multiple laser wavelengths and preferably a wide range of laser wavelengths. The variably positionable beam blocker 2350 can have any suitable shape. It can be rectangular, square, triangular, hexagonal, octagonal, circular, elliptical, or oval. The variably positionable beam blocker 2350 can have an odd or even number of sides of the same or different lengths; it can have sides or segments having straight edges or simple or compound curves; or it can have a combination of straight edges and curves.

In some embodiments, the variably positionable beam blocker 2350 can be positioned between the relay lenses 2322 and 2324, and preferably at the focal plane (or more precisely, at the back of the focal plane) of the relay lens 2322. In some embodiments, the variably positionable beam blocker 2350 can be positioned to be equidistant between the relay lenses 2322 and 2324. In some embodiments, the variably positionable beam blocker 2350 is positioned at a distance of about 300 mm from each of the relay lenses 2322 and 2324, where both 2322 and 2324 are 300-mm focal length lenses. In some embodiments, the variably positionable beam blocker 2350 is positioned at a distance of about 100 to 500 mm from either or both of the relay lenses 2322 and 2324.

It will be appreciated that the variably positionable beam blocker 2350 can be maintained in a single position throughout one or more laser scan passes, such as for a mode change between multiple spots and a single spot. For example, the variably positionable beam blocker 2350 may be moved when the laser is not firing and the galvanometer mirror(s) 2340 are not moving. Such embodiments would not need movement of the variably positionable beam blocker 2350 to be synchronized or coordinated with the movement of the galvanometer mirror(s) 2340. However, the variably positionable beam blocker 2350 can also be moved “on-the-fly” while the laser 1302 is turned on (or firing) and the galvanometer mirror(s) 2340 are moving.

The variably positionable beam blocker 2350 can be moved by a voice coil or an air cylinder (e.g. MX08-30 by SMC Pneumatics of Yorba Linda, Calif.) under direct or indirect control of the controller 1304. Regardless of the specific control relationships, the movement of the variably positionable beam blocker 2350 can be coordinated and/or synchronized with the position control of the galvanometer mirror(s) 2340 (or other fast positioner(s)).

In some embodiments, the variably positionable beam blocker 2350 can be moved in a blocker movement direction 2550 within a blocker movement plane that is traverse (especially perpendicular) to the segment of the beam path 1360 between the relay lenses 2322 and 2324. For example, the variably positionable beam blocker 2350 can be moved in the height direction (within the blocker movement plane) with respect to the spot set of beamlets 2308. Alternatively, the variably positionable beam blocker 2350 can be moved in the length direction (within the blocker movement plane) with respect to the spot set of beamlets 2308. Alternatively, the variably positionable beam blocker 2350 can be moved in both height and length directions (within the blocker movement plane) with respect to the spot set of beamlets 2308. In some embodiments, the variably positionable beam blocker 2350 can be moved in a single direction (within the blocker movement plane) with respect to the length dimension of the spot set of beamlets 2308 during a pass of the laser beam. In some embodiments, the variably positionable beam blocker 2350 can be moved in both directions (within the blocker movement plane) with respect to the length dimension of the spot set of beamlets 2308 during a pass of the laser beam.

In some embodiments, the variably positionable beam blocker 2350 can be moved in a single direction (within the blocker movement plane) with respect to the height dimension of the spot set of beamlets 2308 during a pass of the laser beam. In some embodiments, the variably positionable beam blocker 2350 can be moved in both directions (within the aperture movement plane) with respect to the height dimension of the spot set of beamlets 2308 during a pass of the laser beam. It will be appreciated that the variably positionable beam blocker 2350 can be kept stationary with respect to the spot set.

In operation, the variably positionable beam blocker 2350 is set to block one or more beamlets 2308 of a spot set. Because movement of the variably positionable beam blocker 2350 is relatively slow, most or all of the passes of the laser beam relative to the article 100 are performed with the variably positionable beam blocker 2350 in a single position, having a single contingent or group shape of beamlets 2308 permitted to propagate with respect to the paths of the beamlets 2308 before the position of the variably positionable beam blocker 2350 is changed to alter the contingent of beamlets 2308 permitted to propagate to the article 100.

The ability to change the shape of the spot set, by selectively passing selected beamlets 2308 in the beamlet group (or beamlet formation or beamlet configuration) permitted to propagate, enables a single laser system to perform both the large area laser modification as well as the supplemental touch-up process with smaller spot set contingents and/or single spots. Nevertheless, dealing with the transition regions and undersized dimension portions utilize extra laser passes and cycle time.

FIG. 26 is a schematic diagram of a laser system 2412 employed for making large modifications, such as marking large marks 200, on an article 100. The laser system 2412 can include many of the same components as those employed in the laser system 2312. However, the laser system 2412 employs a beamlet selection device in the form of a mobile or variably positionable aperture 2450, such as a mobile slit aperture. In some embodiments, the mobile aperture 2450 can be positioned between the relay lenses 2322 and 2324, and preferably equidistant between the relay lenses 2322 and 2324. In some embodiments, the mobile aperture 2450 is positioned at the focal plane (or more precisely, at the back focal plane) of the relay lens 2322 or at other positions and distances previously discussed, such as at a distance of 300 mm from each of the relay lenses 2322 and 2324, where both lenses have a focal length of 300 mm, or at a distance of about 100 to 500 mm from either or both of the relay lenses 2322 and 2324.

The mobile aperture 2450 may have dimensions greater than or equal to the length and height dimensions of the spot set. Alternatively, the mobile aperture 2450 may have a length dimension LA and/or a height dimension hA that is smaller than the respective dimension of the spot set. In some embodiments, the height dimension of the mobile aperture 2450 may have a height sufficient to pass fewer rows of beamlets 2308 of than the number of rows contained by the spot set (unless the spot set contains only one row of beamlets). For example, the height dimension of the mobile aperture 2450 may have a height sufficient to pass only a single row of beamlets 2308 of the spot set. For convenience, such a mobile aperture 2450 can be referred to as a linear mobile aperture 2450. In some embodiments, the length dimension of the mobile aperture 2450 may have a length sufficient to pass fewer columns of beamlets 2308 than the number of columns contained by the spot set (unless the spot set contains only one column of beamlets). For example, the length dimension of the mobile aperture 2450 may have a length sufficient to pass only a single column of beamlets 2308 of the spot set.

In some embodiments, one of the length dimension or the height dimension of the mobile aperture 2450 is adapted to pass the beam waist of one beamlet. In some embodiments, one of the length dimension or the height dimension of the mobile aperture 2450 is adapted to pass the beam waist of one beamlet or up to the beam waist of one beamlet plus or minus 5 microns. In some embodiments, one of the length dimension or the height dimension of the mobile aperture 2450 is adapted to pass the beam waist of one beamlet or up to the beam waist of one beamlet plus or minus 1 micron. In some embodiments, one of the length dimension or the height dimension of the mobile aperture 2450 is adapted to pass the beam waist of one beamlet or up to the beam waist of one beamlet plus or minus 0.5 micron. In some embodiments, one of the length dimension or the height dimension of the mobile aperture 2450 is adapted to pass the beam waist of one beamlet or up to the beam waist of one beamlet plus or minus 0.1 micron.

The mobile aperture 2450 can be moved by a voice coil or a piezo-electric transducer under direct or indirect control of the controller 1304 and/or under direct or indirect control of a galvo (or fast positioner) subcontroller (not shown) that controls operation of one or more galvanometer mirrors 2340. Regardless of the specific control relationships, the movement of the mobile aperture 2450 can be coordinated and/or synchronized with the position control of the galvanometer mirror(s) 2340 (or other fast positioner(s)).

For example in one embodiment, a linear n-beamlet system is employed wherein the focal length ratio of the relay lens 2324 to the scan lens is ‘flr’, so the horizontal spot-to-spot separation at the mobile aperture plane is dₘₐ and the individual spot size of each beamlet at the aperture is SS. The driver (e.g. a voice coil) of the mobile aperture 2450 is capable of providing an acceleration a_{A}, while the galvanometer mirror 2340 provides an effective acceleration of a_{G}. For convenience in some embodiments, a_{A}/flr>a_{G}. If this circumstance is not the case, some embodiments simply limit a_{G} to a_{A}/flr.

So, in some embodiments, to mark (or laser modify) a line of length l₀, which is much longer than 2*(n−1)/flr, without the transition regions at its edges at a scanning speed v₀, one can define t_{acc-G}=v₀/a_{G} and t_{acc-A}=v₀ flr/a_{G}, which are the respective time intervals necessary to accelerate to speeds v₀ for the galvanometer scanner and v₀*flr for the mobile aperture. Without loss of generality, one can further assume for convenience that the line is marked along the axis of one galvanometer mirror 2340 only, i.e. the second galvanometer mirror 2340 can be ignored for simplicity. For convenience, one can also further assume that the start of the line is at galvanometer mirror position x₀ for a beamlet 1 of n (for convenience, beamlet 2308a to beamlet 2308n) and the end of the line is at galvanometer mirror position x₁+SS/flr for beamlet n of n.

Accordingly, in some embodiments, the controller 1304 of the laser system 2312 positions the edge of the mobile aperture 2450 a distance sᵢₙᵢ=0.5*(v₀*flr)²/a_{A}−SS from the centroid of the beamlet 2308a, such that all beamlets 2308 are blocked with a mobile aperture velocity of 0 at time t₀. The galvanometer mirror 2340 can be positioned a distance 0.5 v₀/a_{G} from x₀ with a velocity of 0 at time t₀, such that the distance to x₁ is larger than the distance between x₀ and x₁. At time t₀, the controller 1304 sends a command to the galvanometer mirror 2340 to accelerate at a_{G} for a time t_{acc-G} towards position x₀. At time to +t_{acc-G}−t_{acc-A}, the controller 1304 sends a command to the driver of the mobile aperture 2450 to accelerate at a_{A} for a time period t_{acc-A}. At time to +t_{acc-G}, the edge of the mobile aperture 2450 is located one spot size SS past the centroid of the beamlet 2308a and is moving at a velocity v₀*flr towards the beamlet 2308b. The galvanometer mirror 2340 is at position x₀ and is moving towards x₁ with a velocity of v₀. The controller 1304 sends a signal to gate ON the laser pulses of the laser 1302 at this point, and the marking process starts.

At the time to +t_{acc-G}+dₘₐ/(v₀*flr), the edge of the mobile aperture 2450 has passed the beamlet 2308b so that beamlet 2308b can start marking at position x₀. The mobile aperture 2450 continues to move at velocity v₀*flr toward beamlet n until at time to +t_{acc-G}+(n−1) dₘₐ/(v₀*flr) the control unit sends a command to the driver of the mobile aperture 2450 to accelerate at −a_{A} for t_{acc-A}, i.e. until the edge of the mobile aperture 2450 comes to rest at a distance 0.5*(v₀*flr)²/a_{A}+SS+(n−1) dₘₐ from the centroid of the beamlet 2308a such that all the beamlets 2308 pass through the mobile aperture 2450 and the centroid of the beamlet 2308n is at a distance of 0.5*(v₀*flr)²/a_{A}−SS from the edge of the mobile aperture 2450.

When the galvanometer mirror 2340 is at distance t_{acc-A}*v₀ from x₁, the controller 1304 sends a command to the driver of the mobile aperture 2450 to accelerate at −a_{A} for t_{acc-A} such that when the galvanometer mirror 2340 is located at x1, the edge of the mobile aperture 2450 is located one SS from beamlet 2308n and at a velocity of −v₀. After a time n dₘₐ/(v₀*flr), the mobile aperture 2450 is blocking all n beamlets 2308, and the marked line is completed. At this point, the controller 1304 gates OFF the laser pulses of the laser 1302 (the laser 1302 may be on with the laser pulses being blocked by an AOM, for example) and brings galvanometer mirror 2340 and the mobile aperture 2450 into position for the next line.

In some embodiments, the mobile aperture 2450 can be moved in an aperture movement direction 2650 within an aperture movement plane that is traverse (especially, perpendicular) to the segment of the beam path 1360 between the relay lenses 2322 and 2324. For example, the mobile aperture 2450 can be moved in the height direction (within the aperture movement plane) with respect to the spot set of beamlets 2308. Alternatively, the mobile aperture 2450 can be moved in the length direction (within the aperture movement plane) with respect to the spot set of beamlets 2308. Alternatively, the mobile aperture 2450 can be moved in both height and length directions (within the aperture movement plane) with respect to the spot set of beamlets 2308. In some embodiments, the mobile aperture 2450 can be moved in a single direction (within the aperture movement plane) with respect to the length dimension of the spot set of beamlets 2308 during a pass of the laser beam. In some embodiments, the mobile aperture 2450 can be moved in both directions (within the aperture movement plane) with respect to the length dimension of the spot set of beamlets 2308 during a pass of the laser beam. For example, if the spot set has a relatively diagonal profile, such as the spot sets 2100a and 2100b of FIGS. 22 and 23 respectively, the mobile aperture 2450 may be aligned with respect to the slope of the spot set and moved (within the aperture movement plane) diagonally with respect length and height dimensions of the spot set (especially if the mobile aperture has a relatively linear dimension suitable for passing only a row or column of beamlets of the spot set).

In some embodiments, the mobile aperture 2450 can be moved in a single direction (within the aperture movement plane) with respect to the height dimension of the spot set of beamlets 2308 during a pass of the laser beam. In some embodiments, the mobile aperture 2450 can be moved in both directions (within the aperture movement plane) with respect to the height dimension of the spot set of beamlets 2308 during a pass of the laser beam. It will be appreciated that the ability to keep the mobile aperture 2450 stationary with respect to the spot set or any contingent subset of the spot set can be combined with any of these examples. The ability to keep the mobile aperture 2450 stationary with respect to the spot set or any contingent subset of the spot set can be employed to accomplish touch-up passes of the laser beam as previously discussed with respect to FIG. 25.

In some embodiments, multiple mobile apertures 2450 may be simultaneously employed. The mobile apertures 2450 may be employed in the same plane, and they may be adjoining or spaced apart. Alternatively, the mobile apertures 2450 may be employed in separate planes with the mobile apertures 2450 adjoining or spaced apart. (If multiple mobile apertures 2450 are positioned in separate planes, then the aperture frames may be formed to have very thin thicknesses so that the mobile apertures 2450 will have approximately the same focal position with respect to the optical path.) In some embodiments, a separate linear mobile aperture 2450 can be employed for each row and/or column of the spot set.

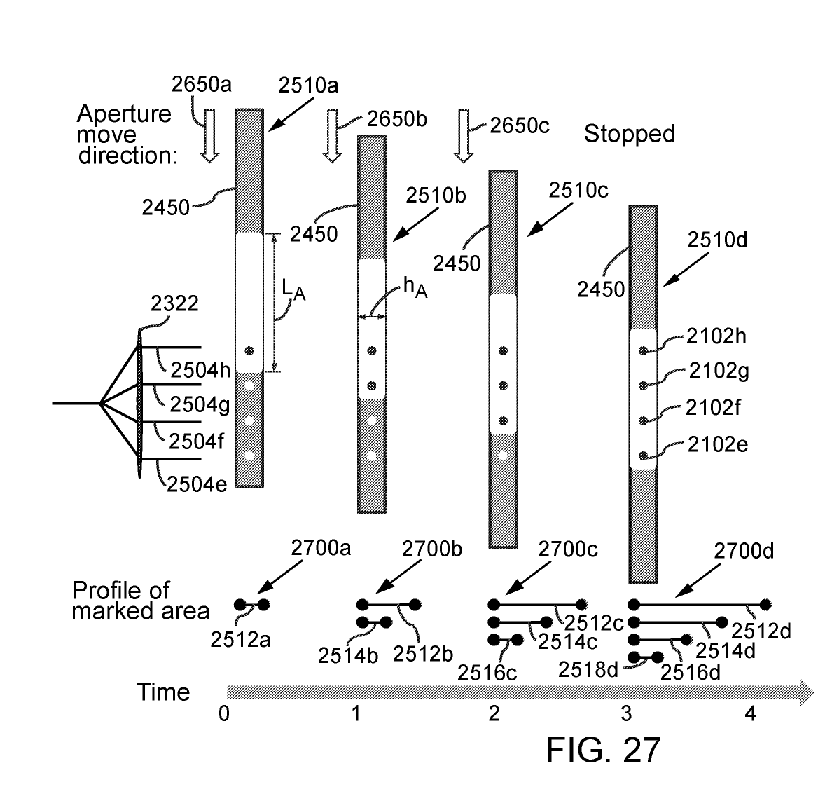

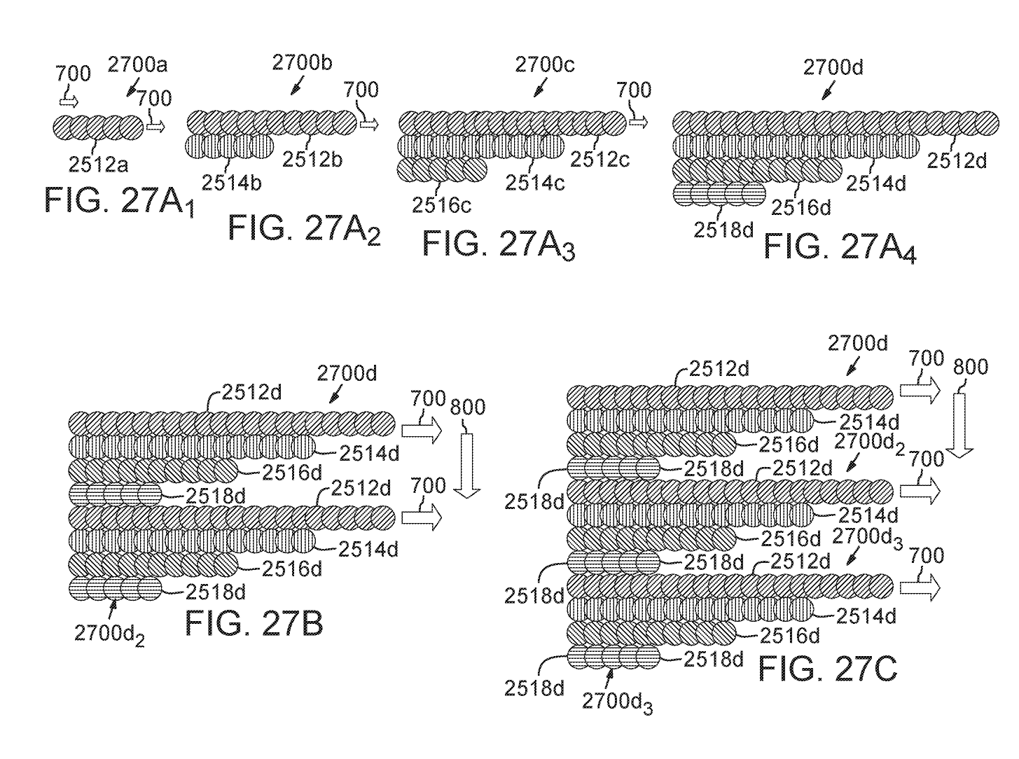

FIG. 27 is a pictorial illustration of exemplary movement of an exemplary single mobile aperture 2450 with respect to a beamlet group and corresponding spot set, such as the spot set 2100b of FIG. 23, to create an exemplary desired modification edge with a predetermined modification edge profile that is substantially perpendicular to the pass direction 700 of the laser beam axis 1372.

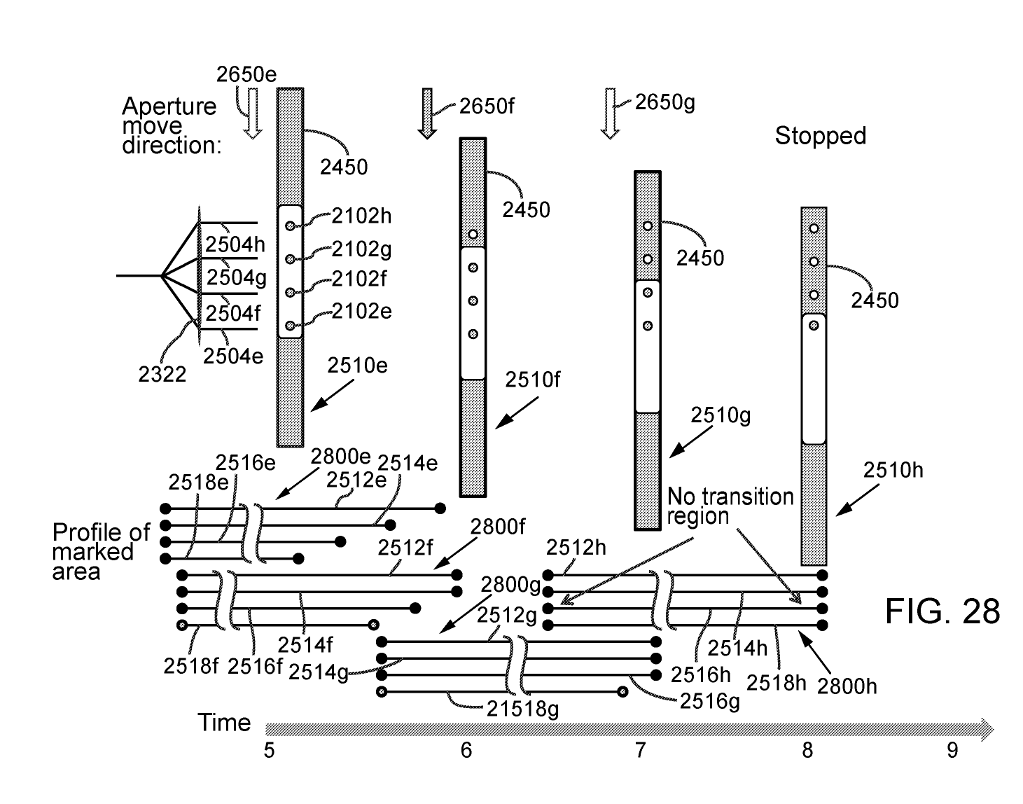

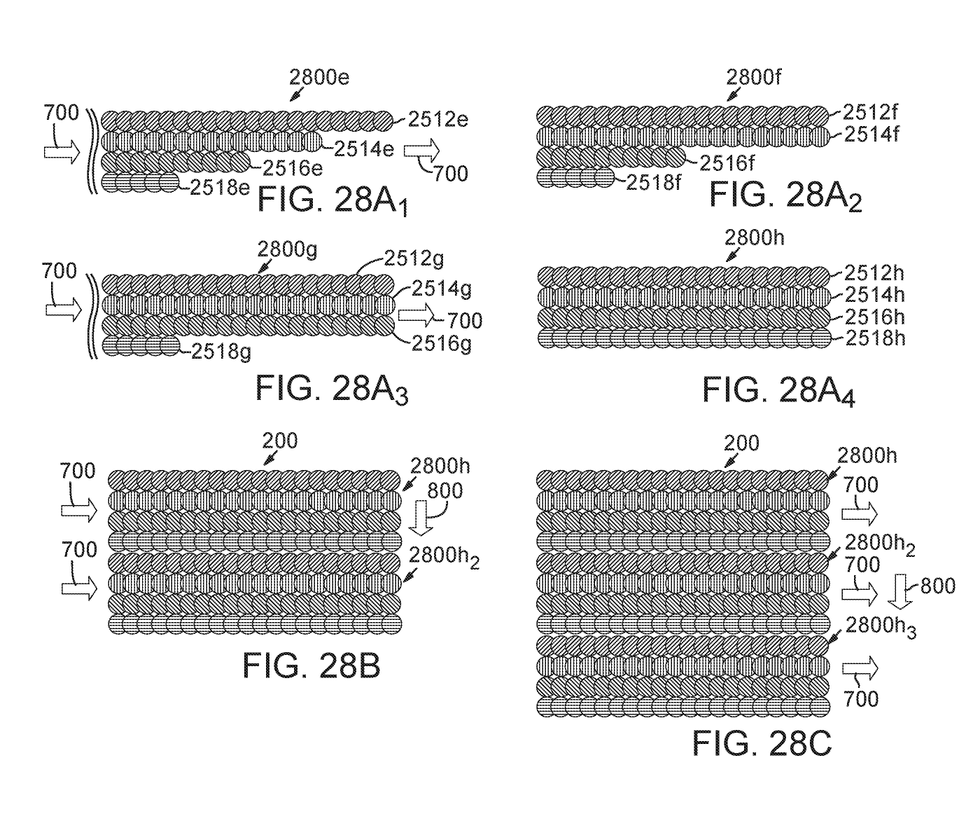

FIGS. 27 and 28 are pictorial illustrations of exemplary movement of a single mobile aperture 2450 with respect to a spot set, such as the spot set 2100b of FIG. 23. With reference to the example depicted in FIG. 27, the mobile aperture 2450 has dimensions sufficient to permit propagation of all four beamlets 2504e, 2504f, 2504g, and 2504h (generically or collectively, beamlets 2504) that can result in the spot set 2100b of respective spot areas 2102e, 2102f, 2102g, and 2102h of FIG. 23.

For convenience, the movement of the mobile aperture 2450 is depicted in at exemplary temporally and spatially separate aperture movement positions 2510a, 2510b, 2510c, and 2510d (generically or collectively, aperture positions 2510). Each of the aperture positions 2510 allows propagation of a different number of beamlets 2504. In the example shown in FIG. 27, the movement of the mobile aperture 2450 is shown to be in an aperture movement plane, which is transverse to the path of the beamlets 2504, wherein the aperture movement direction 2650 (of the major axis of the mobile aperture) is aligned with respect to the slope of the spot set 2100b (or aligned with the slope of the leading edge or trailing edge of the spot set 2100b).

The movement of the mobile aperture 2450 may be of a continuous nature or a stepped nature. The movement of the mobile aperture 2450 may be coordinated or synchronized with control or movement of the fast positioner, such as the galvanometer mirror(s) 2340, as directly or indirectly controlled by the controller 1304 or one or more subcontrollers. The controller 1304 or one or more subcontrollers also coordinate the position of the beam axis 1372 and the timing of the laser pulse. If the movement of the mobile aperture 2450 is stepped, the movement may be timed to occur between laser pulses. It is noted that pulsing of the laser 1302 may be subject to the position of the beam axis 1372, or that the position of the beam axis 1372 may be subject to the pulsing of the laser 1302, or both.

FIG. 27A₁-27A₄ are plan views showing an exemplary trailing edge progression of an exemplary line set 2700d formed by four scanned impingement sets of five-iteration sets of the group of beamlet pulses similar to the spot set 2100b of FIG. 23 relative to the article 100, wherein certain beamlets forming the spot set 2100b are blocked by the mobile aperture 2450. In particular, FIG. 27A₁ is a plan view showing an exemplary line set 2700a formed by a first scanned impingement set of five iterations of the group of pulses similar to the spot set 2100b, wherein beamlets 2504e, 2504f, and 2504g are blocked by the mobile aperture 2450. FIG. 27A₂ is a plan view showing an exemplary line set 2700b formed by first and second scanned impingement sets of five iterations of the group of pulses similar to the spot set 2100b, wherein beamlets 2504e and 2504f are blocked by the mobile aperture 2450 during the second impingement set. FIG. 27A₃ is a plan view showing an exemplary line set 2700c formed by first, second, and third scanned impingement sets of five iterations of the group of pulses similar to the spot set 2100b, wherein beamlets 2504e are blocked by the mobile aperture 2450 during the third impingement set. FIG. 27A₄ is a plan view showing an exemplary line set 2700d formed by first, second, third, and fourth scanned impingement sets of five iterations of the group of pulses similar to the spot set 2100b, wherein none of beamlets are blocked by the mobile aperture 2450 during the fourth impingement set. FIG. 27B is a plan view showing a second line set 2700d2 offset from the line set 2700d shown in FIG. 27A₄. FIG. 27C is a plan view showing a third line set 2700d3 offset from the second line set shown in FIG. 27B.

With reference again to FIGS. 27, 27A₁₋₄, 27B, and 27C the mobile aperture 2450 may be controlled at time 0 to be at the aperture position 2510a, which blocks the beamlets 2504g, 2504f, and 2504e of the laser output from propagating along the optical path 1360 (such that spots areas 2102g, 2102f, and 2102e are not formed on the article 100) and allows the beamlet 2504h of the laser output to propagate along the optical path 1360. (The beamlets 2504e, 2504f, 2504g, and 2504h may be provided from a continuous laser beam or a pulsed laser beam having a laser output of one of more laser pulses.) As shown in FIG. 27, from time 0 to time 1, the beamlet 2504h is permitted to impinge the article 100 (for an exemplary five iterations of beamlet pulses) to provide a laser modification or mark 2700a, such as the scan line 2304h formed of spot areas 2102h (e.g., spot areas 2102h₁, 2102h₂, 2102h₃, 2102h₄, and 2102h₅), represented by a scribe segment 2512a.

The mobile aperture 2450 may be controlled to continuously move during the period from time 0 to time 1 to permit gradually increasing amount of beamlet 2504g to propagate through the mobile aperture 2450 until the full amount of beamlet 2504g is unblocked at the aperture position 2510b. Alternatively, the mobile aperture 2450 may be controlled to step at time 1 to be at the aperture position 2510b, which blocks the beamlets 2504f and 2504e from propagating along the optical path 1360 (such that spots areas 2102f and 2102e are not formed on the article 100) and allows the beamlets 2504h and 2504g to propagate along the optical path 1360. In the exemplary embodiment shown if FIG. 27, the mobile aperture 2450 is moving in an aperture movement direction 2650 (2650a, 2650b, and 2650c), which is diagonally from right to left and top to bottom with respect to the spot set 2100b (when impacting the trailing edge when the scan direction 700 is from left to right). Thus, when impacting the trailing edge, the aperture movement direction 2650 will have a vector component that is opposite the vector of the scan direction 700.

From time 1 to time 2, the two beamlets 2504h and 2504g are permitted to impinge the article 100 to provide a laser modification or mark 2700b represented by scribe segment 2512b and scribe segment 2514b. The scribe segment 2512b in mark 2700b is longer than the scribe segment 2512a of mark 2700a because of the relative movement of the beam axis 1372 with respect to the article 100 and the extra period of time that the beamlet 2504h was permitted to impinge the article 100. Also, the scribe segment 2512b is longer than the scribe segment 2514b because the mobile aperture 2450 blocked the beamlet 2504g during the first time period from time 0 to time 1 and because the spot set 2100b has a diagonal profile. Moreover, the scribe segments 2512b and 2514b have axially aligned trailing edges because the mobile aperture 2450 blocked the beamlet 2504g during the first time period from time 0 to time 1 despite the diagonal profile of the spot set 2100b.

At time 2, the mobile aperture 2450 may be controlled to be at the aperture position 2510c, which blocks the beamlet 2504e from propagating along the optical path 1360 (such that spots areas 2102e are not formed on the article 100) and allows the beamlets 2504h, 2504g, and 2504f to propagate along the optical path 1360. From time 2 to time 3, the three beamlets 2504h, 2504g, and 2504f are permitted to impinge the article 100 to provide a laser modification or mark 2700c represented by scribe segments 2512c, 2514c, and 2516c. The scribe segment 2512c in mark 2700c is longer than the scribe segment 2512b of mark 2700b because of the relative movement of the beam axis 1372 with respect to the article 100 and the extra period of time that the beamlet 2504h was permitted to impinge the article 100. Similarly, the scribe segment 2514c in mark 2700c is longer than the scribe segment 2514b of mark 2700b because of the relative movement of the beam axis 1372 with respect to the article 100 and the extra period of time that the beamlet 2504g was permitted to impinge the article 100.

Also, the scribe segment 2512c is longer than the scribe segment 2514c because the mobile aperture 2450 blocked the beamlet 2504g during the first time period from time 0 to time 1 and because the spot set 2100b has a diagonal profile. Similarly, the scribe segment 2514c is longer than the scribe segment 2516c because the mobile aperture 2450 blocked the beamlet 2504f during the first time period from time 0 to time 1 and during the second time period from time 1 to time 2 and because the spot set 2100b has a diagonal profile. Moreover, the scribe segments 2512c, 2514c, and 2516c have axially aligned trailing edges despite the diagonal profile of the spot set 2100b because the mobile aperture 2450 blocked the beamlet 2504g during the first time period from time 0 to time 1 and blocked the beamlet 2504f during the first time period from time 0 to time 1 and during the second time period from time 2 to time 3.

At time 3, the mobile aperture 2450 may be controlled to be at a fully open aperture position 2510d, which allows the beamlets 2504h, 2504g, 2504f, and 2504e to propagate along the optical path 1360. From time 3 to time 4, the four beamlets 2504h, 2504g, 2504f, and 2504e are permitted to impinge the article 100 to provide a laser modification or mark 2700d represented by scribe segments 2512d, 2514d, 2516d, and 2518d. The scribe segment 2512d in mark 2700d is longer than the scribe segment 2512c of mark 2700c because of the relative movement of the beam axis 1372 with respect to the article 100 and the extra period of time that the beamlet 2504h was permitted to impinge the article 100. Similarly, the scribe segment 2514d in mark 2700d is longer than the scribe segment 2514c of mark 2700c because of the relative movement of the beam axis 1372 with respect to the article 100 and the extra period of time that the beamlet 2504g was permitted to impinge the article 100. Similarly, the scribe segment 2516d in mark 2700d is longer than the scribe segment 2516c of mark 2700c because of the relative movement of the beam axis 1372 with respect to the article 100 and the extra period of time that the beamlet 2504f was permitted to impinge the article 100.

Also, the scribe segment 2512d is longer than the scribe segment 2514d because the mobile aperture 2450 blocked the beamlet 2504g during the first time period from time 0 to time 1 and because the spot set 2100b has a diagonal profile. Similarly, the scribe segment 2514c is longer than the scribe segment 2516c because the mobile aperture 2450 blocked the beamlet 2504g during the first time period from time 0 to time 1 and during the second time period from time 1 to time 2 and because the spot set 2100b has a diagonal profile. Similarly, the scribe segment 2516c is longer than the scribe segment 2518c because the mobile aperture 2450 blocked the beamlet 2504e during the first time period from time 0 to time 1, during the second time period from time 1 to time 2, and during the third time period from time 2 to time 3 and because the spot set 2100b has a diagonal profile.

Moreover, the scribe segments 2512d, 2514d, 2516d, and 2518d have axially aligned trailing edges despite the diagonal profile of the spot set 2100b because the mobile aperture 2450 blocked the beamlet 2504g during the first time period from time 0 to time 1, blocked the beamlet 2504f during the first time period from time 0 to time 1 and during the second time period from time 2 to time 3, and blocked the beamlet 2504e during the first time period from time 0 to time 1, during the second time period from time 2 to time 3, and during the third time period from time 3 to time 4. Thus, the transition regions 2404 can be eliminated from the trailing edges. It will also be appreciated that the scribe segments 2512d, 2514d, 2516d, and 2518d can be extended through the central region 2406.

In some embodiments, the axially aligned trailing edges can be achieved by employing time intervals between times 0, 1, 2, 3, and 4 to be respectively relatively equal. It will be appreciated that the relative rate of movement of the mobile aperture 2450 (in the same direction or in opposite directions) in coordination with selective beam positioning control can be used to change the shape of the trailing edge and provide a variety of selectable trailing edge shapes that are not axially aligned. In particular, selectively changing the relative rate of movement of the mobile aperture 2450 with respect to the spot set can be employed to provide high-resolution edge features of selectable shapes on-the-fly, as will be described later in detail.

It will be appreciated that the scribe segments 2512a, 2512b, 2512c, 2512d, 2512e, 2512f, 2512g, and 2512h (generically or collectively scribe segments 2512), scribe segments 2514b, 2514c, 2514d, 2514e, 2514f, 2514g, and 2514h (generically or collectively scribe segments 2514), scribe segments 2516c, 2516d, 2516e, 2516f, 2516g, and 2516h (generically or collectively scribe segments 2516), and scribe segments 2518d, 2518e, 2518f, 2518g, and 2518h (generically or collectively scribe segments 2518) are shown to be discrete segments to aid understanding. However, a skilled person will appreciate that the scribe segments are each made up of spot areas that be sequentially delivered and/or overlapping. Moreover, the spot areas of two or more of the segments may be overlapping. Accordingly, the area of the laser modification or mark 200 may be completely filled or may contain unmodified portions that may be visible or invisible to a naked human eye.

In some embodiments, the separation between the centroids of beamlets 2504 at the plane of the mobile aperture 2450 with respect to the relay lenses 2322 and 2324, such as equidistant between the relay lenses 2322 and 2324, is in a range from 0.1 mm to 10 mm. In some embodiments, the separation between beamlets 2504 at the plane of the mobile aperture 2450 is in a range from 0.5 mm to 5 mm. In some embodiments, the separation between beamlets 2504 at the plane of the mobile aperture 2450 is in a range from 0.5 mm to 5 mm. In some embodiments, the separation between beamlets 2504 at the plane of the mobile aperture 2450 is in a range from 1 mm to 2.5 mm. In some embodiments, the separation between beamlets 2504 at the plane of the mobile aperture 2450 is in a range from 1.5 mm to 2 mm.

In many embodiments, the mobile aperture 2450 is at or near the focal plane of the first relay lens 2322, where the beamlets come to a focus and hence have the greatest relative separation (measured as centroid separation over the size of the beam at the beam waist). The second relay lens 2324 can be positioned its focal length away from the focal point of the beamlets to re-collimate the beam. The second relay lens to first relay lens focal length ratio gives the magnification of the beams (they act like a two lens beam expander). The diffractive optic element introduces a separation angle between the different beamlets. The input beam has a divergence that depends on its beam size (diameter or spatial major axis). The ratio of separation angle and divergence angle gives the separation of the centroids in units of spot diameter. For many embodiments, it may be desirable to select the spot area and separation between spots. The ratio is given by the DOE design (separation angle) and input beam diameter (divergence). To determine the absolute spot area and separation, the ratio between the spot size in the focal plane of the first relay lens and the desired work surface spot size can be utilized. This ratio provides the ratio desired between the second relay lens and the scan lens. So, in the simplest case, one can design the DOE's introduced separation angle such that it is a match to the scan lens intended for use. Then, by using a 1:1 relay lens ratio, the aperture will be equidistant to the two relay lenses. However, the mobile aperture can be at different distances from the two relay lenses.

In some embodiments, the speed of relative motion between the article 100 and the beam axis 1372 is in a range of 10 mm/s to 10 m/s. In some embodiments, the speed of relative motion between the article 100 and the beam axis 1372 is in a range of 25 mm/s to 5 m/s. In some embodiments, the speed of relative motion between the article 100 and the beam axis 1372 is in a range of 50 mm/s to 1 m/s. In some embodiments, the speed of relative motion between the article 100 and the beam axis 1372 is in a range of 75 mm/s to 500 mm/s. In some embodiments, the speed of relative motion between the article 100 and the beam axis 1372 is in a range of 100 mm/s to 250 mm/s.

In some embodiments, the spot separation distance, a1, between spot areas at the surface 108 of the article 100 may be as previously described. Alternatively, in some embodiments, the spot separation distance, a1, between the spot areas 2102 may be in a range from 2.5 μm to 2.5 mm. In some embodiments, the spot separation distance, a1, between the spot areas 2102 may be in a range from 25 μm to 1 mm. In some embodiments, the spot separation distance, a1, between the spot areas 2102 may be in a range from 100 μm to 500 μm.

In some embodiments, it is desirable to have the spot areas 2102 become available to the work surface at a spot availability rate, through the mobile aperture 2450, that is a function of the beamlet separation at the plane of the mobile aperture and the speed of relative motion between the article 100 and the beam axis 1372. In some embodiments, the spot availability rate can be determined by dividing the beamlet separation by the speed of relative motion between the article 100 and the beam axis 1372. In some embodiments, the spots areas 2102 become available to the work surface at a spot availability rate in a range of 200 mm/s to 20 m/s. In some embodiments, the spots areas 2102 become available to the work surface at a spot availability rate in a range of 500 mm/s to 10 m/s. In some embodiments, the spots areas 2102 become available to the work surface at a spot availability rate in a range of 1 m/s to 5 m/s.

In some embodiments, the mobile aperture 2450 can be moved at an aperture speed that is a function of the spot availability rate and the beamlet separation at the plane of the mobile aperture 2450. In some embodiments, the aperture speed can be determined by dividing the beamlet separation at the plane of the mobile aperture 2450 by the spot availability rate. In some embodiments, the aperture speed is in a range from 100 mm/s to 10 m/s. In some embodiments, the aperture speed is in a range from 250 mm/s to 5 m/s. In some embodiments, the aperture speed is in a range from 500 mm/s to 2.5 m/s. In some embodiments, the aperture speed is in a range from 750 mm/s to 1 m/s. In some embodiments, the aperture speed is comparable to the speed of movement of a galvanometer mirror 2340.

In one example, the separation of the beamlets 2504 at the plane of the mobile aperture 2450 can be about 1.75 mm; the speed of relative motion between the article 100 and the beam axis 1372 can be about 125 mm/s; and the spot separation, a1, at the surface 108 of the article 100 can be about 250 μm. Accordingly, the aperture speed can be greater than or equal to about 875 mm/s to enable a straight edge (FIG. 27, time 0 to 3) with no transition region (as shown in FIG. 24).

FIG. 28 is another pictorial illustration of exemplary movement of the mobile aperture 2450 with respect to a beamlet group and corresponding spot set, such as the spot set 2100b of FIG. 23, to create an exemplary desired leading edge with a modification edge profile that is substantially perpendicular to the pass direction 700 of the laser beam axis 1372.

FIG. 28A₁-28A₄ are plan views showing an exemplary leading edge progression of an exemplary line set 2800h formed by multiple scanned impingement sets of five-iteration sets of the group of beamlet pulses similar to the spot set 2100b of FIG. 23 relative to the article 100, wherein certain beamlets forming the spot set 2100b are blocked by the mobile aperture 2450. In particular, FIG. 28A₁ is a plan view showing an exemplary line set 2800e including a fifth scanned impingement set of five iterations of the group of pulses similar to the spot set 2100b, wherein beamlets 2504e, 2504f, 2504g, and 2504h are unblocked by the mobile aperture 2450. The exemplary line set 2800e may exhibit the same leading edge as that of the line set 2700d. FIG. 28A₂ is a plan view showing an exemplary line set 2800f including fifth and sixth scanned impingement sets of five iterations of the group of pulses similar to the spot set 2100b, wherein beamlet 2504h is blocked by the mobile aperture 2450 during the sixth impingement set. FIG. 28A₃ is a plan view showing an exemplary line set 2800g including fifth, sixth, and seventh scanned impingement sets of five iterations of the group of pulses similar to the spot set 2100b, wherein beamlets 2504h and 2504g are blocked by the mobile aperture 2450 during the seventh impingement set. FIG. 28A₄ is a plan view showing an exemplary line set 2800h including fifth, sixth, seventh, and eighth scanned impingement sets of five iterations of the group of pulses similar to the spot set 2100b, wherein beamlets 2504h, 2504g, and 2504f are blocked by the mobile aperture 2450 during the eighth impingement set. FIG. 28B is a plan view showing a second line set 2800h2 offset from the line set 2800h shown in FIG. 28A₄. FIG. 28C is a plan view showing a third line set 2800h3 offset from the second line set shown in FIG. 28B.

With reference to FIGS. 28, 28A₁-28A₄, 28B, and 28C, the movement of the mobile aperture 2450 depicted in FIG. 27 is continued and is depicted at exemplary temporally and spatially separate aperture positions 2510e, 2510f, 2510g, and 2510h (also generically or collectively, aperture positions 2510). Each of these aperture positions 2510 allows propagation of a different number of beamlets 2504.

At time 5, the mobile aperture 2450 is also shown at a fully open aperture position 2510e, which allows the beamlets 2504e, 2504f, 2504g, and 2504h to propagate along the optical path 1360. From time 4 to time 5, the four beamlets 2504e, 2504f, 2504g, and 2504h are permitted to impinge the article 100 to provide a line set 2800e represented by scribe segments 2512e, 2514e, 2516e, and 2518e. These scribe segments 2512e, 2514e, 2516e, and 2518e have the same relationships with respect to each other as the relationships of the scribe segments 2512d, 2514d, 2516d, and 2518d have to each other, with the earlier initiated scribe segments being progressively longer than the later initiated scribe segments due to the diagonal profile of the spot set 2100b and the sequential unblocking of the beamlets 2504g, 2504f, and 2504e. Similarly, the scribe segments 2512e, 2514e, and 2516e have the same relationships with respect to 2512d, 2514d, and 2516d as previously described with respect to the aperture movement position 2510d. Moreover, the scribe segments 2512e, 2514e, 2516e, and 2518e have axially aligned trailing edges despite the diagonal profile of the spot set 2100b because of the blocking activity of the mobile aperture 2450 as previously described with respect to the aperture movement position 2510d.

The time interval between the aperture movement positions 2510d and 2510e (between time 4 to time 5) may be different from the time intervals between the other sequential aperture positions 2510. At position 2510d (by time 4), the trailing edge of the line set 2700d has already been set, so the time interval between times 4 and 5 does not affect the trailing edge. The time interval between the fully open aperture movement positions 2510d and 2510e (between times 4 and 5) can be adjusted in consideration of the total length of line set 2800h, the length of the pass of the beam axis 1372 across the article 100, and/or the length of the intended mark 200. Similarly, the internal segment length between the fully open aperture movement positions 2510d and 2510e (between times 4 and 5) can be adjusted in consideration of the total length of line set 2800h, the length of the pass of the beam axis 1372 across the article 100, and/or the length of the intended mark 200.

The time interval between the fully open aperture movement positions 2510d and 2510e (between times 4 and 5) can be longer than the time interval between sequential partially open aperture movement positions 2510 (or other sequential times). Alternatively, the time interval between the fully open aperture movement positions 2510d and 2510e (between times 4 and 5) can be shorter than the time interval between sequential partially open aperture movement positions 2510 (or other sequential times).

The internal segment length between the fully open aperture movement positions 2510d and 2510e (between times 4 and 5) can be longer than the internal segment lengths between sequential partially open aperture movement positions 2510 (or other sequential times). Alternatively, the internal segment length between the aperture movement positions 2510d and 2510e (between times 4 and 5) can be shorter than the internal segment lengths between sequential partially open aperture movement positions 2510 (or other sequential times).

At time 6, the mobile aperture 2450 may be controlled to be at the partially open aperture position 2510f, which blocks the beamlet 2504h from propagating along the optical path 1360 and allows the beamlets 2504g, 2504f, and 2504e to propagate along the optical path 1360. From time 6 to time 7, the three beamlets 2504g, 2504f, and 2504e are permitted to impinge the article 100 to provide a line set 2800f represented by scribe segments 2512f, 2514f, and 2516f, and 2518f. The blocking of the beamlet 2504h permits the leading edge of the segment 2512f to be stopped even though the spot set 2100b has a diagonal profile leading with the spot area 2102h. Thus, the scribe segment 2512f in the line set 2800f has a length that is about equal to the length of the scribe segment 2512e of the line set 2800e despite the relative movement of the beam axis 1372 with respect to the article 100.

At time 7, the mobile aperture 2450 may be controlled to be at the partially open aperture position 2510g, which blocks the beamlets 2504g and 2504h from propagating along the optical path 1360 and allows the beamlets 2504f and 2504e to propagate along the optical path 1360. From time 7 to time 8, the two beamlets 2504f and 2504e are permitted to impinge the article 100 to provide a line set 2800g represented by scribe segments 2512g, 2514g, and 2516g, and 2518g. The blocking of the beamlets 2504h and 2504g permit the leading edge of the segments 2512g and 2514g to be stopped even though the spot set 2100b has a diagonal profile leading with the spot area 2102h. Thus, the scribe segments 2512g and 2514g in the line set 2800g have lengths that are about equal to the length of the scribe segment 2512e of line set 2800e despite the relative movement of the beam axis 1372 with respect to the article 100.

At time 8, the mobile aperture 2450 may be controlled to be at the partially open aperture position 2510h, which blocks the beamlets 2504h, 2504g, and 2504f from propagating along the optical path 1360 and allows the beamlet 2504e to propagate along the optical path 1360. From time 8 to time 9, the beamlet 2504e is permitted to impinge the article 100 to provide a line set 2800h represented by scribe segments 2512h, 2514h, and 2516h, and 2518h. The blocking of the beamlets 2504h, 2504g, 2504f permit the leading edge of the segments 2512h, 2514h, and 2516h to be stopped even though the spot set 2100b has a diagonal profile leading with the spot area 2102h. Thus, the scribe segments 2512h, 2514h, and 2516h in the line set 2800h have lengths that are about equal to the length of the scribe segment 2512e of the line set 2800e despite the relative movement of the beam axis 1372 with respect to the article 100. Moreover, the scribe segments 2512h, 2514h, 2516h, and 2518h have axially aligned leading edges despite the diagonal profile of the spot set 2100b because of the blocking activity of the mobile aperture 2450 as previously described with respect to the aperture movement position 2510h.

In some embodiments, the axially aligned leading edges can be achieved by employing time intervals between times 5, 6, 7, 8, and 9 to be respectively relatively equal. It will be appreciated that the relative rate of movement of the mobile aperture 2450 (in the same direction or in opposite directions) in coordination with selective beam positioning control can be used to change the shape of the leading edge and provide a variety of selectable leading edge shapes that are not axially aligned. Moreover, the ability to change the original shape of the beamlet group and corresponding spot set 2100a during the relative motion of a laser pass, by selectively passing selected beamlets 2504 of the beamlet group permitted to propagate, enables the laser system 1300 to provide real-time changes to the propagation edge profile of the laser beam impinging the article 100.

In some embodiments, continuous movement of the mobile aperture 2450 can be employed (rather than stepping to the mobile aperture 2450 to distinct positions). Alternative shapes of leading and trailing edges can be created by varying the position, speed, and/or direction of the movement of the mobile aperture 2450. Regardless of stepped movement or continuous movement, the leading and trailing edge sharpness can be additionally improved, if desirable, by employing one or more touch up passes with smaller spot sets (having fewer and/or closer spots), such spot sets 300, 400, or 500, or with a single spot. In such circumstances, the number of touch up passes is greatly reduced compared to those that would be needed in processes without use of a mobile aperture. Thus, the leading and trailing edges of large marks 200 can have desired resolution at a fraction of the processing time.

The laser power applied to the mobile aperture 2450 can be fairly limited because the laser beam can be gated off, such as by an AOM or the laser itself, whenever no spots are needed. A mode change such as shown in FIG. 25, can be employed for extended touch up passes with a single spot. Thus, a thin lightweight mobile aperture 2450 can be used, increasing its response time and decreasing its cost. The mobile aperture technique can facilitate the use of spot sets with larger number of spot areas, such as eight or more, without the need to spend more and more time fixing even greater transition regions.

One will appreciate that as askewed spot sets become longer, they also become taller due to the ‘vertical pitch’ of the brush. With spot sets of fewer spots, such as four or fewer spot areas, the brush height can easily meet or exceed desired resolution for a typical marking pattern. However, in some embodiments, for spot sets having much larger spot numbers, such as 16 or greater, the brush height can produce a visible effect (visible to an unaided human eye) that exceeds the desired resolution.

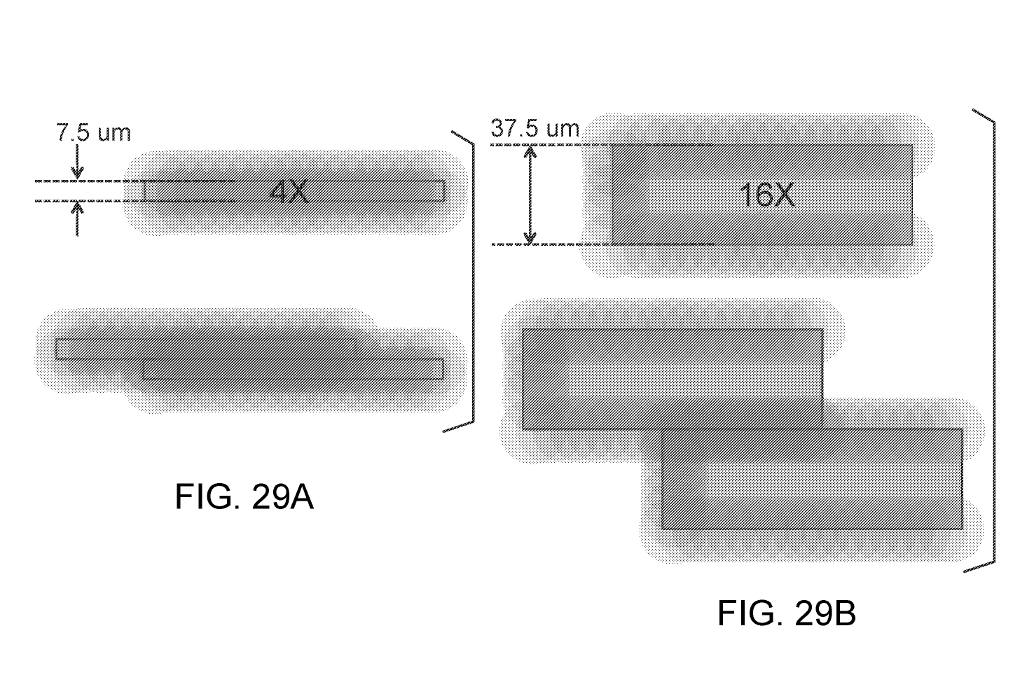

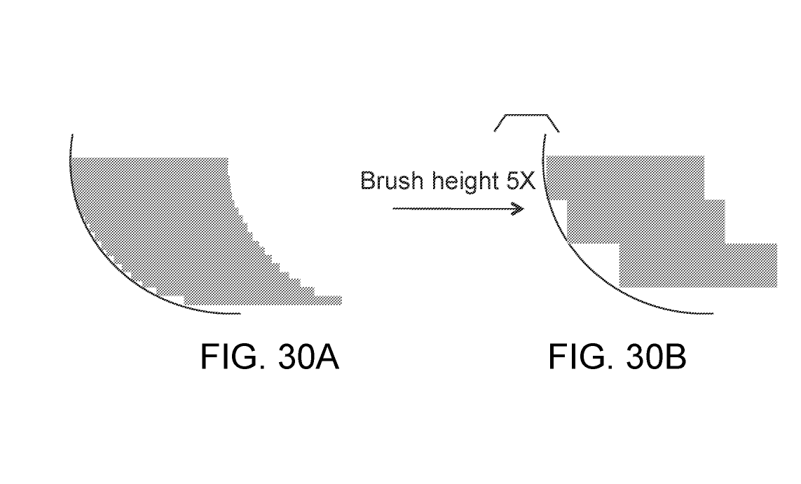

FIGS. 29A and 29B (collectively FIG. 29) show comparative relative height displacements between exemplary spot sets a having four and sixteen rows, respectively; and FIGS. 30A and 30B show comparative marks made by exemplary spot sets having four and sixteen rows, respectively, along a desired curved perimeter. FIGS. 29 and 30 illustrate the impact of a larger brush stroke.

In particular, FIGS. 29A and 29B shows 2.5-μm centroid position difference perpendicular to the galvo motion between neighboring spots areas, yielding an effective interior brush stroke height of 7.5 μm for a four row brush stroke and an effective interior brush stroke height of 37.5 μm for a 16 row brush stroke. So, for many embodiments, modification by one beamlet can be relatively wide, but the step size remains as A*(n−1), where A centroid position difference perpendicular to the galvo motion between neighboring spots areas, and where n equals the number of beamlets. Thus, as the number of rows increase, the step size increases and the resolution for matching a given curve becomes more difficult. This difficulty is the same for a brush stroke with a rectangular end and an askew (sloped-edge) brush stroke employed to have an effective rectangular end.

This curve-matching difficulty is exhibited in FIGS. 30A and 30B, which show results of an effective rectangular brush stroke employing a Δ of 2.5 μm and a D (the horizontal spot-to-spot separation) of about 250 μm at a generic v (the work surface scan speed of the galvo scanner). These values are for explanatory purposes only. The 7.5 μm-resolution of the curve (made with a 4-row brush stroke) in FIG. 30A is much better and may be invisible to a naked human eye than the 37.5 μm-resolution of the curve (made with a 16-row brush stroke) in FIG. 30B, which may be resolvable to a naked human eye.

As previously described, a slope-edged brush stroke (having an askew-edged spot set) with a mobile aperture 2450 can be employed to provide better resolution. With proper constant aperture motion, a straight edge (a modification edge profile that is substantially perpendicular to the pass direction 700 of the laser beam axis 1372) can be achieved, and the transition regions shown in FIG. 24 can be avoided. Accordingly, the timing considerations for a straight edge, such as shown in FIG. 27, can be exemplarily and generically explained with respect to an example of a spot set that includes four spots such as in the spot set 2100a shown in FIG. 22. The spot turn off/on times for achieving a straight edge (where rows a=b=c=0) are the trivial: t₁=0, t₂=D/v, t₃=2D/v, and t₄=3D/v, where D is the horizontal spot-to-spot separation and v is the work surface scan speed of the galvo scanner. The off/on times t₁ through t₄ are equally spaced in this case, resulting in a constant velocity for the mobile aperture 2450.

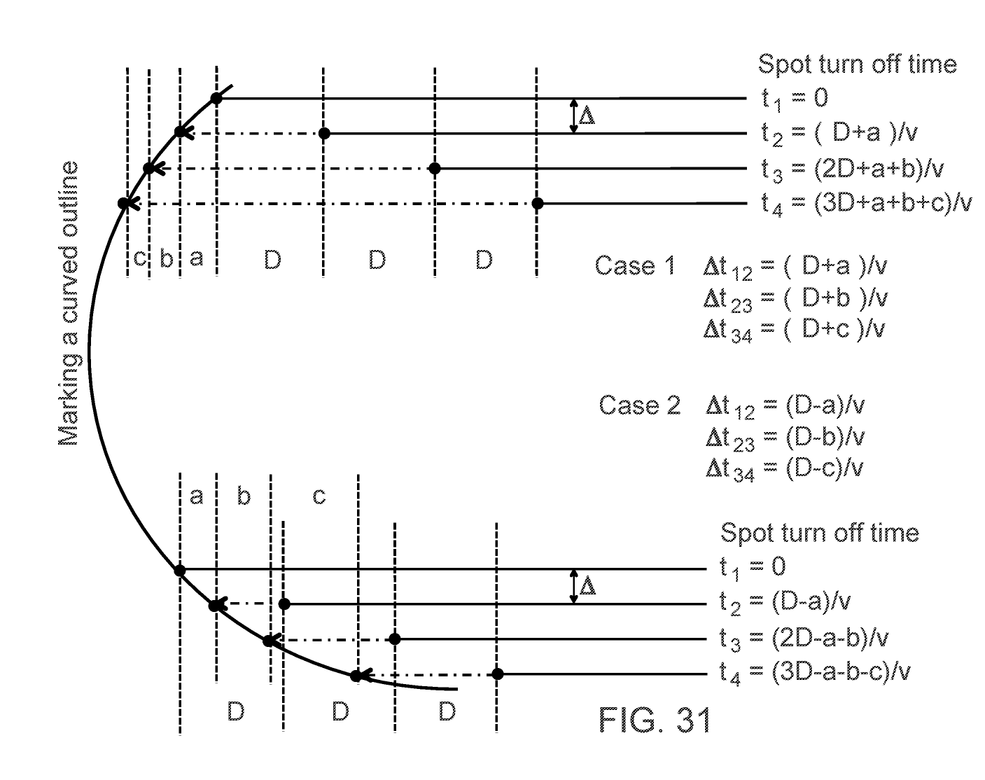

Using the timing considerations for straight edge formation with an askew-edged brush stroke, one can then demonstrate how modulation of the speed of the mobile aperture 2450 can be employed to achieve single spot edge resolution for non-straight (curved or sloped) edges, especially slowly varying edges. FIG. 31 shows an example of how enhanced timing coordination can facilitate better perimeter resolution when employing askew-edged spots sets having a large number of rows. In particular, FIG. 31 provides timing considerations with respect to a generic example of a spot set that includes four spots such as in the spot set 2100a shown in FIG. 22. It will be appreciated, however, that the speed modulation of the mobile aperture 2450 can be employed to facilitate the use of spot sets having much larger brush heights h.

In Case 1, in which the edge of the marking outline curves away from the slope of the askew edge of the spot set 2100a (where the rows a, b, and/or c are not straight edged (i.e., not axially aligned) and not equal to zero), the spot turn off time is: t₁=0, t₂=(D+a)/v, t₃=(2D+a+b)/v, and t₄=(3D+a+b+c)/v. Accordingly, a velocity modulation for the mobile aperture 2450 can be utilized by the varying times: Δ t₁₂=(t₂−t₁)=(D+a)/v, Δ t₂₃=(t₃−t₂)=(D+b)/v, Δ t₃₄=(t₄−t₃)=(D+c)/v, etc.

In Case 2, in which the edge of the marking outline curves toward the slope of the askew edge of the spot set 2100a (where the rows a, b, and/or c are not straight edged (i.e., not axially aligned) and not equal to zero, the spot turn off time is: t₁=0, t₂=(D−a)/v, t₃=(2D−a−b)/v, and t₄=(3D−a−b−c)/v. Accordingly, a velocity modulation for the mobile aperture 2450 can be utilized by the varying times: Δ t₁₂=(t₂−t₁)=(D−a)/v, Δ t₂₃=(t₃−t₂)=(D−b)/v, A t₃₄=(t₄−t₃)=(D−c)/v, etc.

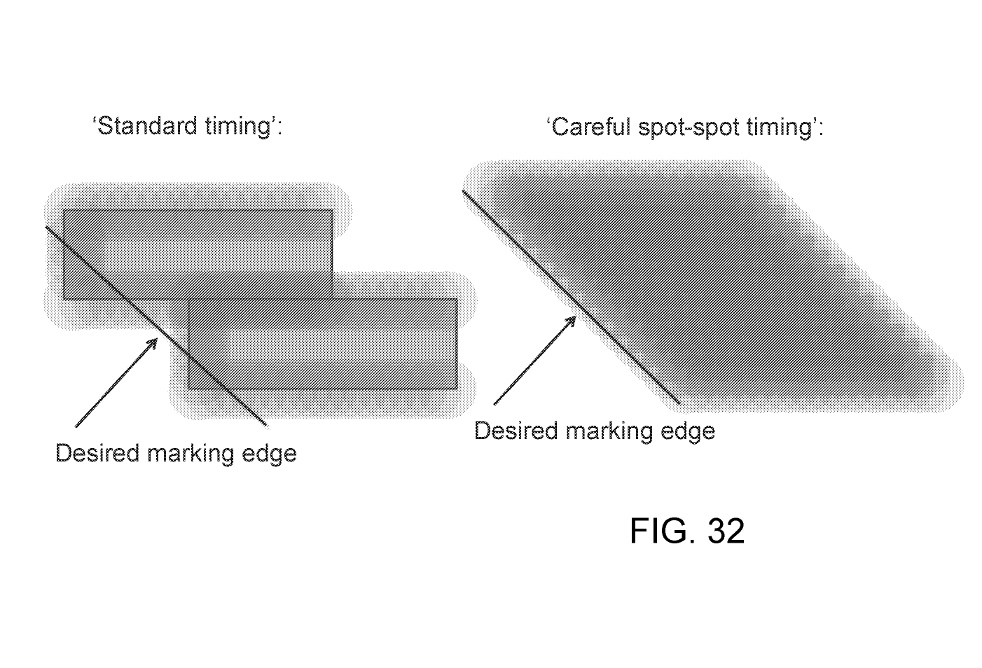

As previously noted, this enhanced timing coordination technique can be utilized with much larger brush heights h and simple or compound curves of any shape with a radius of curvature larger than the brush height (spot set height). In some embodiments, the radius of curvature is much larger than the brush height, such as greater than 10 times the brush height. Moreover, this technique can also be employed to produce sloped straight edges with askew edged spot sets having a different slope than the sloped straight edge. FIG. 32 shows comparative marks made by an exemplary spot set having 16 rows along a desired diagonal perimeter using simple and enhanced timing coordination, respectively.

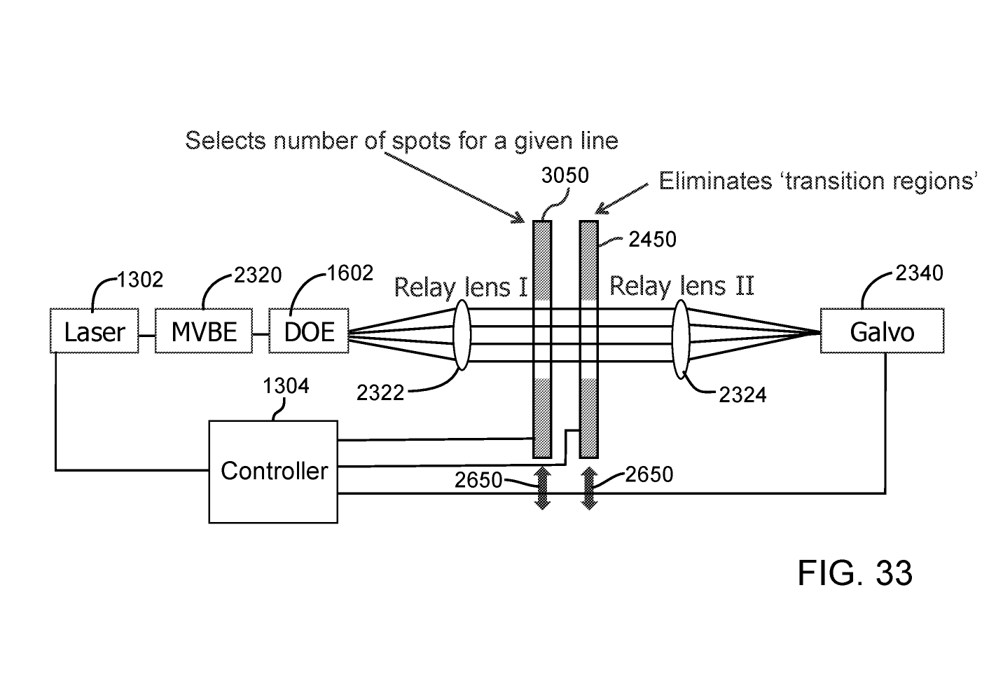

In some embodiments, greatly increasing the brush length L of a spot set can also create challenges for marks 200 having particular characteristics. For example, as more and more spots are added to the brush length L, the odds become increasingly more likely that a mark 200 may have a desired feature length (as part of the overall large pattern) that is shorter than the brush stroke length L. While switching to a single spot (‘mode change’) is possible, the switch may not be very efficient for particular circumstances. However, a second mobile aperture 3050 can be used, in close proximity of the first mobile aperture 2450, to act as a selection device as to how many spots in a spot set will be available for a given feature line. This way the first mobile aperture 2450 can still operate as previously described; however, the first mobile aperture 2450 would so for a reduced spot number and hence for a reduced brush length, enabling the use of more spots than just one (single spot ‘mode change’) for a shorter feature length. FIG. 33 is a schematic diagram of an laser system having multiple mobile apertures coordinated with beam positioner control for making large modifications with spot area resolution (or laser brush resolution) smaller than the area of the spot set. The system employed in FIG. 33 can be substantially similar to the system depicted in FIG. 26 with the addition of the second mobile aperture 3050, which can use the same controller 1304 or a separate or subcontroller not shown. Although the mobile aperture 3050 can have the same capabilities of constant or modulated motion as the mobile aperture 2450, the mobile aperture need only be positioned once per feature or line.

The foregoing is illustrative of embodiments of the invention and is not to be construed as limiting thereof. Although a few specific example embodiments have been described, those skilled in the art will readily appreciate that many modifications to the disclosed exemplary embodiments, as well as other embodiments, are possible without materially departing from the novel teachings and advantages of the invention.

Accordingly, all such modifications are intended to be included within the scope of the invention as defined in the claims. For example, skilled persons will appreciate that the subject matter of any sentence or paragraph can be combined with subject matter of some or all of the other sentences or paragraphs, except where such combinations are mutually exclusive. Moreover, any teaching with regard to any element applies to any corresponding element regardless of the associated reference numeral or the specific embodiment or example set forth, except where such teaching is mutually exclusive to the specific embodiment.

It will be obvious to those having skill in the art that many changes may be made to the details of the above-described embodiments without departing from the underlying principles of the invention. The scope of the present invention should, therefore, be determined by the following claims, with equivalents of the claims to be included therein.

1. A method for laser modification of a large area of an article, comprising:
directing a laser beam for propagation along an optical path;
propagating the laser beam through a beamlet generator to create a beamlet group of multiple distinct beamlets including three or more beamlets;
employing a beamlet selection device to distribute the beamlet group into first and second beamlet sets, wherein the first beamlet set includes a first number of beamlets, and wherein the beamlet selection device permits the first beamlet set to propagate along the optical path and prevents the second beamlet set from propagating along the optical path; and
coordinating operation of the beamlet selection device with operation of a beam-positioning system, wherein the beam-positioning system controls relative motion and relative position of a beam axis of the laser beam with respect to the article, and wherein the beamlet selection device changes the first number of beamlets in the first beamlet set in coordination with changes made to the relative motion or the relative position of the beam axis with respect to the article to impinge the article with variable spot sets that have numbers of spot areas on the article that correspond to the first number of beamlets.

2. The method of claim 1, wherein the laser beam is propagated through a beam-shaping device to provide the multiple distinct beamlets, wherein the beam positioning systems employs a fast-steering positioner, and wherein the beamlet selection device is positioned at an optical position along the optical path between the beam-shaping device and the fast-steering positioner.

3. The method of claim 2, wherein the beam-shaping device comprises a diffractive optical element, and wherein the fast-steering positioner comprises a galvanometer mirror.

4. The method of claim 1, wherein laser beam is propagated through a beam expander positioned along the optical path upstream of the beamlet selection device.

5. The method of claim 1, wherein the beamlet selection device is positioned between a pair of relay lenses along the optical path.

6. The method of claim 1, wherein the beamlet selection device comprises a fundamentally mechanical device.

7. The method of claim 6, wherein the beamlet selection device comprises a mobile aperture operable for movement transverse to the optical path.

8. The method of claim 1, wherein the beamlet selection device weighs less than or equal to 100 g.

9. The method of claim 1, wherein the beamlet selection device has a response speed of greater than or equal to 10 mm/s or a bandwidth between about 10 kHz and about 100 kHz.

10. The method of claim 1, wherein the beamlet selection device is moveable by a voice coil.

11. The method of claim 1, wherein the beamlet group includes four or more beamlets.

12. The method of claim 1, wherein the beamlets of the beamlet group produce respective spot areas on the article when the beamlets are permitted to propagate to the article, and wherein the entire spot set of spot areas has a group length or group height dimension greater than or equal to 10 microns.

13. The method of claim 1, wherein the beamlets of the beamlet group produce respective spot areas on the article when the beamlets are permitted to propagate to the article, and wherein a spot separation distance between two neighboring spot areas is in a range of 3 microns to 3 millimeters.

14. The method of claim 1, wherein the beamlets of the beamlet group produce respective spot areas on the article when the beamlets are permitted to propagate to the article, wherein the spot areas have a major spatial axis, and wherein a spot separation distance between two neighboring spot areas is greater than the major spatial axis and less than six times larger than the major spatial axis.

15. The method of claim 1, wherein the beamlets of the beamlet group produce respective spot areas on the article when the beamlets are permitted to propagate to the article, and wherein the beamlets impinge the article within 30 microseconds of each other or substantially simultaneously.

16. The method of claim 1, wherein the beamlet selection device occupies an optical position along the optical path, wherein the beamlets of the beamlet group produce respective spot areas on the article when the beamlets are permitted to propagate to the article, and wherein the spot areas become available to the article through the beamlet selection device at a spot availability rate that is a function of the beamlet separation at the optical position and the speed of relative motion between the article and the beam axis.

17. The method of claim 1, wherein the beamlet selection device occupies an optical position along the optical path, and wherein the beamlet selection device has a speed that is a function of beamlet separation at the optical position and a spot availability rate at which spot areas of respective beamlets become available to the article through the beamlet selection device.

18. The method of claim 17, wherein the speed of the beamlet selection device is a function of the beamlet separation at the optical position divided by the spot availability rate.

19. The method of claim 1, wherein the spot set includes multiple rows and multiple columns of spot areas, wherein the spot set has a perimeter with a shape similar to that of a parallelogram, wherein the relative motion includes a laser pass of the beam axis in a pass direction over a portion of the article, wherein the beamlet selection device blocks multiple beamlets during a first time period during the laser pass, wherein the beamlet selection device blocks fewer beamlets during a second time period than during the first time period, and wherein the beamlet selection device blocks fewer beamlets during a third time period than during the second time period.

20. The method of claim 19, wherein the first time period precedes the second time period, wherein the second time period precedes the third time period, wherein at least a first beamlet is permitted to propagate through the beamlet selection device during the first time period, wherein at least the first beamlet and a second beamlet are permitted to propagate through the beamlet selection device during the second time period, wherein at least the first and second beamlets and a third beamlet are permitted to propagate through the beamlet selection device during the third time period, wherein the first, second, and third beamlets form respective first, second, and third parallel line segments on or within the portion of the article during the laser pass, wherein the first, second, and third beamlets are each in a different row and a different column of the beamlet group, wherein the first, second, and third parallel line segments have respective first, second, and third initiation points that are sequentially addressed, and wherein the first, second, and third initiation points are collinear and form a trailing edge that is perpendicular to the pass direction.

21. The method of claim 19, wherein the third time period precedes the second time period, wherein the second time period precedes the first time period, wherein at least a first beamlet is permitted to propagate through the beamlet selection device during the first time period, wherein at least the first beamlet and a second beamlet are permitted to propagate through the beamlet selection device during the second time period, wherein at least the first and second beamlets and a third beamlet are permitted to propagate through the beamlet selection device during the third time period, wherein the first, second, and third beamlets form respective first, second, and third parallel line segments on or within the portion of the article during the laser pass, wherein the first, second, and third beamlets are each in a different row and a different column of the beamlet group, wherein the first, second, and third parallel line segments have respective first, second, and third termination points that are sequentially addressed, and wherein the first, second, and third termination points are collinear and form a leading edge that is perpendicular to the pass direction.

22. The method of claim 1, wherein the beamlet generator comprises a diffractive optical element, wherein the beamlet selection device comprises a mobile aperture, wherein the beam positioning system comprises a galvanometer mirror to affect the relative motion and relative position of the beam axis with respect to the article, wherein movement of the mobile aperture is coordinated with movement of the galvanometer mirror, and wherein the laser modification comprises a laser mark.

23. The method of claim 1, wherein the laser modification is made beneath a surface of the article without damaging the surface of the article.

24. A method for laser marking of a large area of an article, comprising:
directing a laser beam for propagation along an optical path;
propagating the laser beam through a diffractive optical element to create a beamlet group of multiple distinct beamlets including three or more beamlets;
employing a mobile aperture to distribute the beamlet group into first and second beamlet sets, wherein the first beamlet set includes a number of beamlets, and wherein the beamlet selection device permits the first beamlet set to propagate along the optical path and prevents the second beamlet set from propagating along the optical path; and
coordinating operation of the aperture with operation of a galvanometer mirror positioned along the optical path, wherein the galvanometer mirror affects relative motion and relative position of a beam axis of the laser beam with respect to the article, and wherein movement of the mobile aperture changes the number of beamlets in the first set in coordination with changes made to the relative motion or the relative position of the beam axis with respect to the article.

25. A laser system for making a large area laser modification of an article, comprising:
a laser operable for generating a laser beam for propagation along an optical path;
a beamlet generator operable for creating a beamlet group of multiple distinct beamlets including three or more beamlets;
a beamlet selection device operable for dividing the beamlet group into first and second beamlet sets, wherein the first beamlet set includes a number of beamlets, and wherein the beamlet selection device is operable to permit the first beamlet set to propagate along the optical path and operable to prevent the second beamlet set from propagating along the optical path;
a beam positioning system operable for causing relative motion of a beam axis of the laser beam with respect to the article to change of position of the beam axis with respect to the article; and
a controller operable for controlling the relative motion and the relative position of the beam axis with respect to the article and operable for causing the beamlet selection device to change the number of beamlets in the first set in coordination with changes made to the relative motion or the relative position of the beam axis with respect to the article.

26. A method for facilitating laser modification of a large area of an article, the large area having a desired modification edge with a predetermined modification edge profile, wherein the desired modification edge has a desired localized edge portion with a localized edge profile, comprising:
propagating a laser beam including a beamlet formation of multiple distinct laser beamlets including three or more laser beamlets simultaneously along an optical path having a beam axis that intersects the article, wherein the beamlet formation corresponds to a spot set of spot areas on the article and provides a one-to-one correspondence of the laser beamlets to the spot areas whenever the respective laser beamlets are permitted to propagate to the article, wherein the spot set has a spot set edge profile that is different from the localized edge profile for the desired modification edge;
employing a beam positioning system to direct a laser pass of the beam axis in a pass direction relative to desired locations on the article, wherein the pass direction is transverse to the desired localized edge portion of the desired modification edge;
employing a beamlet selection device during a first time period during the laser pass to block a first number of laser beamlets to prevent propagation of the first number of laser beamlets along the optical path downstream of the beamlet selection device during the first time period and to permit propagation of unblocked laser beamlets along the optical path downstream of the beamlet selection device during the first time period;
employing the beamlet selection device during a second time period during the laser pass to block a second number of laser beamlets to prevent propagation of the second number of laser beamlets along the optical path downstream of the beamlet selection device during the second time period and to permit propagation of unblocked laser beamlets along the optical path downstream of the beamlet selection device during the second time period, wherein the second number is different from the first number;
employing the beamlet selection device during a third time period during the laser pass to block a third number of laser beamlets to prevent propagation of the third number of laser beamlets along the optical path downstream of the beamlet selection device during the third time period and to permit propagation of unblocked laser beamlets along the optical path downstream of the beamlet selection device during the third time period, wherein the third number is different from the second number, wherein the first, second, and third numbers affect a propagation edge profile for the laser beam, wherein the propagation edge profile of the laser beam influences a modification edge made by the laser beam; and
coordinating operation of the beamlet selection device with operation of the beam positioning system so that the propagation edge profile of the laser beam differs from the spot set edge profile of the laser beam, so that the propagation edge profile of the laser beam resembles the localized edge profile of the desired localized edge portion of the desired modification edge, so the propagation edge profile of the laser beam is synchronized with the location of the desired localized edge portion of the desired modification edge of the large area.

27. A laser mark, comprising:
a major area having major length and major height dimensions and having laser brush strokes of a laser spot set that contains a plurality of laser spots to provide a spot-set length dimension, a spot-set height dimension, a spot-set area, and a spot-set edge having a slope at an angle between 0 and 180 degrees with respect to the spot-set length dimension or the spot-set height dimension; and
a plurality of contiguous minor areas adjacent to the major area that define a mark edge of the mark, wherein the mark edge has a curvilinear profile, wherein the laser brush strokes are continuous from the minor areas to the major area, and wherein some of the brush strokes in the minor areas contain brush stroke segments having fewer laser spots than in the laser spot set to provide the marked edge with a curvilinear edge profile at a brush stroke edge resolution that is higher than the spot-set length dimension or the spot-set height dimension.
